(19) United States
(12) Patent Application Publication
(10) Pub. No.: US 2024/0086493 A1
(43) Pub. Date: Mar. 14, 2024

(54) METHOD FOR DIAGNOSING A DATASET TO GENERATE SYNTHETIC DATA, AND A COMPUTING DEVICE AND SYSTEM FOR PERFORMING SUCH A METHOD

(71) Applicant: PEBBLOUS INC., Daejeon (KR)

(72) Inventors: Joo Haeng LEE, Sejong-si (KR); Jeong Won LEE, Daejeon (KR)

(73) Assignee: PEBBLOUS INC., Daejeon (KR)

(21) Appl. No.: 18/511,600

(22) Filed: Nov. 16, 2023

Related U.S. Application Data
(63) Continuation-in-part of application No. 18/129,711, filed on Mar. 31, 2023, now Pat. No. 11,868,435.
Application No. 18/129,711 is a continuation of application No. 17/898,109, filed on Aug. 29, 2022, now Pat. No. 11,748,447.

(30) Foreign Application Priority Data
Jun. 29, 2022 (KR) 10-2022-0079508
Jun. 29, 2022 (KR) 10-2022-0079509
Jun. 29, 2022 (KR) 10-2022-0079510
Jun. 30, 2023 (KR) 10-2023-0084884
Jun. 30, 2023 (KR) 10-2023-0084886
Jun. 30, 2023 (KR) 10-2023-0084888
Jun. 30, 2023 (KR) 10-2023-0084889

(51) Int. Cl. G06F 18/214; G06F 18/213; G06F 18/22; G06N 20/00

(52) U.S. Cl. CPC G06F 18/214; G06F 18/213; G06F 18/22; G06N 20/00

(57) ABSTRACT

According to an embodiments of the present disclosure, a computer-implemented method comprising: obtaining, by one or more processors, a first data set; identifying, by one or more processors, a first data point set by determining at least one feature of the first data set from at least one layer of a first trained model, wherein the first data point set corresponding to the first data set is associated with a first embedding space of a first dimension; obtaining, by one or more processors, a first diagnostic data corresponding to the first data set based on the first data point set by analyzing at least one property of the first data set; and generating, by one or more processors, a first set of synthetic data, wherein the generating the first set of synthetic data comprises: inputting a prompt data associated with the at least one property of the first data set into a second trained model; and obtaining the first set of synthetic data from at least one layer of the second trained model may be provided.

### CROSS-REFERENCE TO RELATED APPLICATION

This application claims priority to and the benefit of Korean Patent Application No. 2022-0079508, filed on Jun. 29, 2022, Korean Patent Application No. 2022-0079509, filed on Jun. 29, 2022, and Korean Patent Application No. 2022-0079510, filed on Jun. 29, 2022, Korean Patent Application No. 2023-0084884, filed on Jun. 30, 2023, Korean Patent Application No. 2023-0084886, filed on Jun. 30, 2023, Korean Patent Application No. 2023-0084888, filed on Jun. 30, 2023, Korean Patent Application No. 2023-0084889, filed on Jun. 30, 2023 the disclosure of which is incorporated herein by reference in its entirety.

### BACKGROUND

### 1. Field of the Invention

The present disclosure relates to a computing device that provides a comprehensive clinic solution for deep learning training data. More specifically, the present disclosure relates to a program in which a method of modifying data by accurately identifying essential characteristics of a data set used to train a deep learning model and generating high-quality synthetic data is stored, and a computing device for performing the method.

### 2. Discussion of Related Art

In recent years, deep learning-based artificial intelligence algorithms have been used in most technical fields. In particular, unstructured data without regularity is starting to be used in the deep learning field, and thus, the problem of increasing the amount of data used for training has emerged.

Industries have been proposing various solutions to solve the problem of the increase in data. In particular, as technologies for generating synthetic data are advanced, the synthetic data is being used to train deep learning models in various technical fields.

However, as the synthetic data is generated indiscriminately and artificial neural network-based deep learning models are advanced recently, the need to modify the quality of data rather than improving the quality of the learning model is increasing.

For this reason, it is important to accurately evaluate the quality of data for training deep learning models. However, there are clear limitations of a method of determining the quality of data available commercially as the method verifies only integrity of structured data. So, there is a need for a data solution that can be commonly applied to data used in various technical fields.

### SUMMARY OF THE INVENTION

The present disclosure is directed to providing a computing device for a data clinic and a data clinic method.

In addition, the present disclosure is directed to providing a method of generating various pieces of information on a data set through the computing device according to the present disclosure and displaying the information in various ways.

Objectives to be solved by the present invention are not limited to the above-described objectives, and objectives which are not described above will be clearly understood by those skilled in the art through the present specification and the accompanying drawings.

According to an embodiments of the present disclosure, a method comprising: at an electronic device with one or more processors, obtaining a data set; identifying, based on the data set, a first data point set on a first embedding space, wherein each data point included in the first data point set corresponds to each data included in the data set; identifying a modified first data point set on the first embedding space based on the first data point set by adjusting a property associated with a distribution of the first data point set, wherein the modified first data point set includes at least one modified data point which is not included in the first data point set; and providing a Modified Image of Data (MIOD) by representing the modified first data point set on an imaging space may be provided.

In addition, according to an embodiments of the present disclosure, a computing device (or electronic device) for obtaining a data set and providing information about the data set, comprising: a memory configured to store a plurality of instructions; and at least one processor; wherein the plurality of instructions stored in the memory included a first instruction for instructing an operation of confirming a point data (data point) set based on the data set, wherein the point data set is obtained by representing the data set as point data in a latent space, a second instruction for instructing an operation of confirming characteristics of a data set based on the point data set, and a data image based on the point data set—the data image represents the point data set in an imaging space and a third instruction instructing an operation of providing, wherein the at least one processor obtains a data set, and based on a trigger identified according to the data set, at least one of the plurality of instructions, wherein the computing device may selectively perform an operation indicated by the above instructions may be provided.

According to an embodiment of the present disclosure, a computing device for obtaining a data set and providing a diagnostic result for the data set, comprising: an output device; memory; and at least one processor operating based on at least one instruction stored in the memory, wherein the at least one processor obtains a data set and maps the data set to a latent space to configure the first manifold—in this case, the first manifold includes a point data set corresponding to the data set—; acquiring a data image by displaying at least some of the point data included in the point data set in an imaging space, wherein the computing device outputs, through the output device, the data image and a diagnostic report including additional information obtained by analyzing the data image may be provided.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram for describing an apparatus and system for performing a data clinic method according to various embodiments of the present disclosure;

FIG. 2 is a block diagram illustrating a computing device for performing a data clinic method and a model training method of a data clinic according to various embodiments of the present disclosure;

FIG. 3 is a diagram for describing various operating methods performed by a computing device for performing a data clinic method according to various embodiments of the present disclosure;

FIG. 4 is a diagram for describing a method of providing, by a computing device, an image of data according to various embodiments of the present disclosure;

FIG. 5 is a flowchart for describing a method of providing, by a computing device, an image of data according to various embodiments of the present disclosure;

FIG. 6 is a diagram illustrating an example of a method of training, by a computing device, a model for generating an imaging manifold according to various embodiments of the present disclosure;

FIG. 7 is a diagram for describing a data imaging process of a computing device according to various embodiments of the present disclosure;

FIG. 8 is a flowchart illustrating an example of generating, by a computing device, an image of data based on a data point set according to various embodiments of the present disclosure;

FIG. 9 is a flowchart diagram illustrating an example of a method of determining an optimal dimension of a manifold for data imaging;

FIG. 10 is a diagram illustrating a method of providing, by a computing device, a property of a data set according to various embodiments of the present disclosure;

FIG. 11 is a flowchart illustrating a method of identifying, by a computing device, a property of a data set based on data points included in a data point set according to various embodiments of the present disclosure;

FIG. 12 is a diagram illustrating an example of identifying, by a computing device, a property of a data set based on a data point set according to various embodiments of the present disclosure;

FIG. 13 is a flowchart illustrating a method of identifying, by a computing device, a property of a data set based on a data point set according to various embodiments of the present disclosure;

FIG. 14 is a diagram illustrating an example of identifying, by a computing device, a property of a data set based on a data point set according to various embodiments of the present disclosure;

FIG. 15 is a diagram for describing a method of obtaining, by a computing device, a property of a data set using a convolution algorithm according to various embodiments of the present disclosure;

FIG. 16 is a diagram for describing a method of modifying, by a computing device, a data set according to various embodiments of the present disclosure;

FIG. 17 is a diagram illustrating an example of generating, by a computing device, a modified data point set according to various embodiments of the present disclosure;

FIG. 18 is a diagram illustrating another example of generating, by a computing device, a modified data point set according to various embodiments of the present disclosure;

FIG. 19 is a diagram for describing a method of providing, by a computing device, a modified image of data by training a model for generating a modified manifold according to various embodiments of the present disclosure;

FIG. 20 is a diagram illustrating an example of training, by a computing device, a model for generating a modified manifold according to various embodiments of the present disclosure;

FIG. 21 is a flowchart for describing an example of a method of training, by a computing device, a model for generating a modified manifold according to various embodiments of the present disclosure;

FIG. 22 is a diagram illustrating a method of training, by a computing device, a model for generating a modified manifold by mining a hard negative pair according to various embodiments of the present disclosure;

FIG. 23 is a diagram illustrating an operation of providing, by a computing device, a modified data set including synthetic data based on a data set according to various embodiments of the present disclosure;

FIG. 24 is a diagram illustrating an example of an operation of providing, by a computing device, a modified data set including synthetic data based on a data set according to various embodiments of the present disclosure;

FIG. 25 is a diagram illustrating an operation of providing, by a computing device, a quality of the obtained data set according to various embodiments of the present disclosure;

FIG. 26 is a diagram illustrating an operation of providing, by a computing device, an achievable quality of the obtained data set according to various embodiments of the present disclosure;

FIG. 27 is a diagram illustrating information included in a diagnostic report provided by a computing device according to various embodiments of the present disclosure;

FIG. 28 is a diagram illustrating an example of information on an image of data provided by a computing device according to various embodiments of the present disclosure;

FIG. 29 is a diagram for describing an operation of providing, by a computing device, an image of data and a modified image of data of a data set according to various embodiments of the present disclosure;

FIG. 30 is a diagram illustrating algorithm performance models constituting a computing device according to various embodiments of the present disclosure;

FIG. 31 is a diagram illustrating a method of selectively performing, by at least one processor included in a computing device, an operation based on a data set according to various embodiments of the present disclosure;

FIG. 32 is a diagram illustrating various processes performed by at least one processor according to instructions stored in a memory of a computing device according to various embodiments of the present disclosure; and

FIG. 33 is a diagram illustrating an implementation example of a computing device according to various embodiments of the present disclosure.

FIG. 34 is a diagram illustrating various systems for providing data clinic services and artificial intelligence models and algorithms for building systems, according to various embodiments.

FIG. 35 is a diagram illustrating a data lens processing system and a data imaging system, according to various embodiments.

FIG. 36 is a flowchart illustrating a method that a computing device obtains a lens system based on a data set, according to various embodiments.

FIG. 37 is a flowchart illustrating an example of a lens processing algorithm performed by a computing device, according to various embodiments.

FIG. 38 is a diagram illustrating an example of a lens processing model built by a computing device to perform a lens processing algorithm, according to various embodiments.

FIG. 39 is a diagram illustrating an example of a neural network structure of a lens processing system included in a computing device, according to various embodiments.

FIG. 40 is a diagram illustrating a method that a computing device enhances a lens processing model using an auxiliary network, according to various embodiments.

FIG. 41 is a diagram illustrating a method for determining a property associated with a dimensionality for a computing device to optimize a parameter, according to various embodiments.

FIG. 42 is a flowchart illustrating a method for a computing device to acquire an image of data reflecting intrinsic property of a data set, according to various embodiments.

FIG. 43 is a diagram illustrating a method for a computing device to obtain an image of data set and determine a task performance capability, according to various embodiments.

FIG. 44 is a diagram illustrating experimental data for a correlation between an amount of training data and a learning efficiency of an artificial intelligence model.

FIG. 45 is a diagram illustrating a method by which a computing device removes at least a portion of a data set using a pre-trained artificial intelligence model, according to various embodiments.

FIG. 46 is a flowchart illustrating an example in which a computing device obtains a processed data set based on a data set, according to various embodiments.

FIG. 47 is a diagram illustrating an example of a computing device obtaining a processed data set based on a data set, according to various embodiments.

FIG. 48 is a flowchart illustrating another embodiment in which a computing device obtains a processed data set based on a data set, according to various embodiments.

FIG. 49 is a diagram illustrating another example in which a computing device obtains a processed data set based on a data set, according to various embodiments.

FIG. 50 is a flowchart illustrating another embodiment in which a computing device obtains a processed data set based on a data set, according to various embodiments.

FIG. 51 is a diagram illustrating another example in which a computing device obtains a processed data set based on a data set, according to various embodiments.

FIG. 52 is a flowchart illustrating another embodiment in which a computing device obtains a processed data set based on a data set, according to various embodiments.

FIG. 53 is a diagram illustrating another example in which a computing device obtains a processed data set based on a data set, according to various embodiments.

FIG. 54 is a flowchart illustrating another embodiment in which a computing device obtains a processed data set based on a data set, according to various embodiments.

FIG. 55 is a diagram illustrating another example in which a computing device obtains a processed data set based on a data set, according to various embodiments.

FIG. 56 is a diagram illustrating a method by which a computing device generates synthetic data using a generative imaging model, according to various embodiments.

FIG. 57 is a diagram illustrating a framework within a computing device for a generative imaging model, according to various embodiments.

FIG. 58 is a flowchart illustrating a method by which a computing device processes data using a generative imaging model, according to various embodiments.

FIG. 59 is a diagram illustrating an example of a computing device processing data using a generative imaging model, according to various embodiments.

FIG. 60 is a flowchart illustrating a method by which a computing device generates data by optimizing a generative imaging model, according to various embodiments.

FIG. 61 is a diagram illustrating an example in which a computing device generates data by optimizing a generative imaging model, according to various embodiments.

FIG. 62 is a diagram illustrating an example of a computing device improving the quality of a data set using at least one data processing model, according to various embodiments.

FIG. 63 is a diagram illustrating a pipeline through which a computing device inputs data into at least one data processing model based on properties of a data set, according to various embodiments.

FIG. 64 is a diagram illustrating a method by which a computing device generates synthetic data based on data diagnostic data, according to various embodiments.

FIG. 65 is a flowchart illustrating a method in which a computing device generates synthetic data using a pre-trained artificial intelligence model, according to various embodiments.

FIG. 66 is a flowchart illustrating an example of a method for a computing device to verify the suitability of a synthetic data set, according to various embodiments.

FIG. 67 is a flowchart illustrating another example of a method for a computing device to verify the suitability of a synthetic data set, according to various embodiments.

FIG. 68 is a diagram illustrating a method for a computing device to generate synthetic data by modifying an image of data based on language input, according to various embodiments.

FIG. 69 is a flowchart illustrating a method for a computing device to generate synthetic data by modifying an image of data based on language input, according to various embodiments.

FIG. 70 is a diagram illustrating a method for a computing device to generate synthetic data based on utterance data, according to various embodiments.

FIG. 71 is a flowchart illustrating a method for a computing device to generate synthetic data based on utterance data and provide comparison information, according to various embodiments.

FIG. 72 is a diagram illustrating a language-based generative model and a clinic model included in a computing device, according to various embodiments.

FIG. 73 is a diagram illustrating an example of a computing device using a data clinic model and a language-based model, according to various embodiments.

### DETAILED DESCRIPTION OF EXEMPLARY EMBODIMENTS

Hereinafter, specific embodiments of the present invention will be described in detail with reference to the accompanying drawings. However, the scope of the present invention is not limited to the suggested embodiments, and other embodiments which are included in retrograde inventions or in the scope of the present invention may be easily suggested by those skilled in the art by adding, modifying, and deleting other components in the same scope of the present invention, and this may also be within the scope of the present invention.

Embodiments described in this specification are intended to clearly explain the spirit of the invention to those skilled in the art. Therefore, the present invention is not limited by the embodiments, and the scope of the present invention should be interpreted as encompassing modifications and variations without departing from the spirit of the invention.

Terms used in this specification are selected from among general terms, which are currently widely used, in consideration of functions in the present invention and may have meanings varying depending on intentions of those skilled in the art, customs in the field of the art, the emergence of new technologies, or the like. If a specific term is used with a specific meaning, the meaning of the term will be described specifically. Accordingly, the terms used in this specification should not be defined as simple names of the components but should be defined on the basis of the actual meaning of the terms and the whole context throughout the present specification.

The accompanying drawings are to facilitate the explanation of the present invention, and the shape in the drawings may be exaggerated for the purpose of convenience of explanation, so the present invention should not be limited by the drawings.

When it is determined that detailed descriptions of well-known elements or functions related to the present invention may obscure the subject matter of the present invention, detailed descriptions thereof will be omitted herein as necessary. In addition, numbers (eg, first, second, etc.) used in the description process of the present specification are merely identification symbols for distinguishing one component from other components.

In addition, the suffix “part” for components used in the following description are given or mixed in consideration of only the ease of writing the specification, and do not have distinct meanings or roles by themselves.

Terms such as “first” and/or “second” may be used to describe various elements, but the elements should not be limited by the terms. The above terms are used only for the purpose of distinguishing one element from another element, for example, without departing from the scope of rights according to the concept of the present disclosure, a first element may be called a second element, and similarly the second component may also be referred to as the first component.

When a component is referred to as being “connected” to another component, it is understood that the other component may be directly connected to the other component, but other components may exist in between. On the other hand, when it is said that a certain element is “directly connected” to another element, it should be understood that the other element does not exist in the middle. Other expressions describing the relationship between elements, such as “between” and “immediately between” or “neighboring to” and “directly neighboring (adjacent) to”, etc., should be interpreted similarly.

In the drawings, each block of the flowchart diagrams and combinations of flowchart diagrams may be executed by computer program instructions. These computer program instructions may be embodied in a processor of a general-purpose computer, special-purpose computer, or other programmable data processing equipment, such that the instructions performed by the processor of the computer or other programmable data processing equipment are not described in the flowchart block(s). It creates a means to perform functions. These computer program instructions may also be stored in a computer-usable or computer-readable memory that may direct a computer or other programmable data processing equipment to implement a function in a particular manner, and thus the computer-usable or computer-readable memory. It may also be possible for the instructions stored in the flowchart block(s) to produce an article of manufacture containing instruction means for performing the function described in the flowchart block(s). The computer program instructions may also be mounted on a computer or other programmable data processing equipment, such that a series of operational steps are performed on the computer or other programmable data processing equipment to create a computer-executed process to create a computer or other programmable data processing equipment. It may also be possible for instructions to perform the processing equipment to provide steps for performing the functions described in the flowchart block(s).

Additionally, each block may represent a module, segment, or portion of code that includes one or more executable instructions for executing specified logical function(s). It should also be noted that in some alternative implementations it is also possible for the functions recited in the blocks to occur out of order. For example, two blocks shown one after another may in fact be performed substantially simultaneously, or it is possible that the blocks are sometimes performed in the reverse order according to the corresponding function.

As used in the present disclosure, the term ‘˜ unit’ refers to software or hardware components such as Field Programmable Gate Array (FPGA) or Application Specific Integrated Circuit (ASIC). ‘Unit’ performs specific roles but is not limited to software or hardware. ‘˜ Unit’ may be configured to reside in an addressable storage medium or may be configured to refresh one or more processors. Accordingly, according to some embodiments, ‘˜ unit’ refers to components such as software components, object-oriented software components, class components, and task components, and processes, functions, properties, and programs. Includes procedures, subroutines, segments of program code, drivers, firmware, microcode, circuitry, data, databases, data structures, tables, arrays, and variables. The functions provided in the components and ‘˜ units’ may be combined into a smaller number of components and ‘˜ units’ or further separated into additional components and ‘˜ units’. In addition, components and ‘˜ units’ may be implemented to play one or more CPUs in a device or secure multimedia card. Also, according to various embodiments of the present disclosure, ‘˜ unit’ may include one or more processors.

Hereinafter, the operating principle of the present disclosure will be described in detail with reference to the accompanying drawings. In the following description of the present disclosure, if it is determined that a detailed description of a related well-known function or configuration may unnecessarily obscure the subject matter of the present disclosure, the detailed description thereof will be omitted. In addition, the terms described below are terms defined in consideration of functions in the present disclosure, which may vary according to intentions or customs of users and operators. Therefore, the definition should be made based on the content throughout this specification.

According to an embodiments of the present disclosure, a method comprising: at an electronic device with one or more processors, obtaining a data set; identifying, based on the data set, a first data point set on a first embedding space, wherein each data point included in the first data point set corresponds to each data included in the data set; identifying a modified first data point set on the first embedding space based on the first data point set by adjusting a property associated with a distribution of the first data point set, wherein the modified first data point set includes at least one modified data point which is not included in the first data point set; and providing a Modified Image of Data (MIOD) by representing the modified first data point set on an imaging space may be provided.

Here, identifying the first data point set comprises: identifying a first manifold obtained by mapping the data set on the first embedding space based on a first predetermined criterion, wherein the first manifold is associated with a shape formed by the first data point set; and identifying the first data point set included in the first manifold.

Here, identifying the first data point set further comprises: obtaining a first reconstruction data set by reconstructing the first data point set, wherein a modality of the first reconstruction data set corresponds to the data set, and wherein the first predetermined criterion is set based on a similarity between the data set and the first construction data set.

Here, the method further comprising: identifying, based on the first data point set, a second data point set on a second embedding space, wherein the modified first data set is obtained by reconstructing the second data point set to the first embedding space.

Here, identifying the second data point set comprises: identifying a second manifold obtained by mapping the first data point set to the second embedding space according to a second predetermined criterion, wherein the second manifold is associated with a shape formed by the second data point set, and identifying the second data point set included in the second manifold, and wherein the second predetermined criterion is set based on a similarity between a plurality of data points included in the first data point set.

Here, the at least one modified data point is obtained by reconstructing at least one data point included in the second data point set to the first embedding space.

Here, identifying the modified first data point set comprises: clustering the first data point set into at least one group; and adjusting a distance between a first data point included in a first group of the at least one group and a second data point included in a second group of the at least one group on the first embedding space.

Here, the distance between the first data point and the second data point is adjusted so that the distance between the first data point and the second data point is greater than a distance between the first data point and a third data point included in the first group.

Here, the method further comprising: providing an Image of Data (IOD) by representing the first data point set on the imaging space.

Here, providing the IOD comprises: identifying a boundary region formed by the first data point set on the first embedding space; and obtaining the IOD by representing the first data point set on the imaging space so that at least one data point positioned outside the boundary region is deleted.

Here, the method further comprising: providing a comparison information representing a difference between the IOD and the MIOD.

Here, the imaging space comprises a space in which the IOD and the MIOD are displayed by at least one output device connected to the electronic device.

Here, the imaging space comprises a space in which the modified first data point set is visually identified.

Here, providing the MIOD comprises: representing the at least one modified data point visually different with another data points included in the modified first data point set.

Here, the data set comprises a first data of a first modality and a second data of a second modality.

Here, the method further comprising: obtaining a property of the data set based on the first data point set and a modified property of the data set based on the modified first data point set.

Here, the method further comprising: providing a modified data set by reconstructing the modified first data point set on an output domain, wherein the modified data set includes at least one synthetic data corresponding to the at least one modified data point.

According to an embodiments of the present disclosure, a system comprising: a non-transitory computer-readable storage medium; and one or more processors coupled to the non-transitory computer-readable storage medium, wherein the non-transitory computer-readable storage medium comprises program instructions that, when executed on the one or more processors, cause the system to perform operations comprising: obtaining a data set; identifying, based on the data set, a first data point set on a first embedding space, wherein each data point included in the first data point set corresponds to each data included in the data set; identifying a modified first data point set on the first embedding space based on the first data point set by adjusting a property associated with a distribution of the first data point set, wherein the modified first data point set includes at least one modified data point which is not included in the first data point set; and providing a Modified Image of Data (MIOD) by representing the modified first data point set on the imaging space may be provided.

According to an embodiments of the present disclosure, a non-transitory computer-readable storage medium, storing program instructions computer-executable on a computer to perform operations comprising: obtaining a data set; identifying, based on the data set, a first data point set on a first embedding space, wherein each data point included in the first data point set corresponds to each data included in the data set; identifying a modified first data point set on the first embedding space based on the first data point set by adjusting a property associated with a distribution of the first data point set, wherein the modified first data point set includes at least one modified data point which is not included in the first data point set; and providing a Modified Image of Data (MIOD) by representing the modified first data point set on the imaging space may be provided.

The present disclosure relates to a computing device (or an electronic device) and system that perform a data clinic method of evaluating the true quality of data set for training a deep learning model and providing improvements.

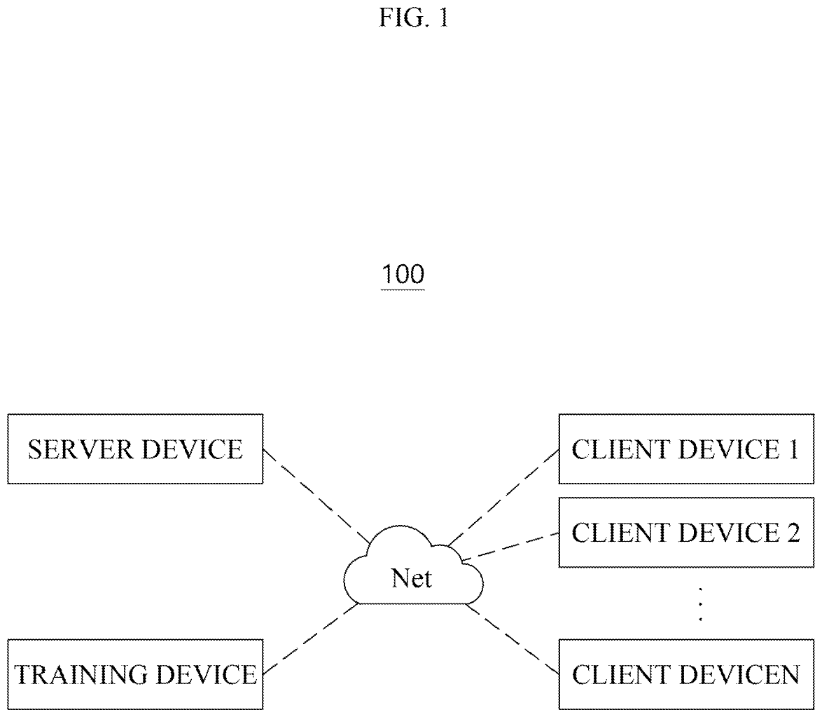

FIG. 1 is a diagram for describing an apparatus and system for performing a data clinic method according to various embodiments of the present disclosure.

The data clinic method of the present disclosure may be implemented on a communication network-based platform system 100. Specifically, a server device for collecting and processing data, a training device for training a learning model for various purposes, and a plurality of client devices may be connected to each other on a communication network to transmit or receive data.

For example, the server device may receive data from at least one of the plurality of client devices, and transmit the received data to the training device to train a specific learning model. In addition, the server device may generate modified data by processing the received data, and may transmit the modified data to the plurality of client devices.

In addition, for example, the plurality of client devices may access a server implemented by the server device via a communication network, and exchange data with other client devices or use a function implemented by the server through the server.

In addition, the server device, the plurality of client devices, and the training device may be implemented as one computing device. Specifically, according to an embodiment, a computing device that performs an operation of training a deep learning model, an operation of collecting and processing data, an operation of transmitting and receiving data, etc., may be provided.

In addition, the server device, the training device, and the plurality of client devices are implemented as one or more computing devices, and may include at least one processor (or controller).

Hereinafter, a computing device for providing a data clinic method is described in more detail.

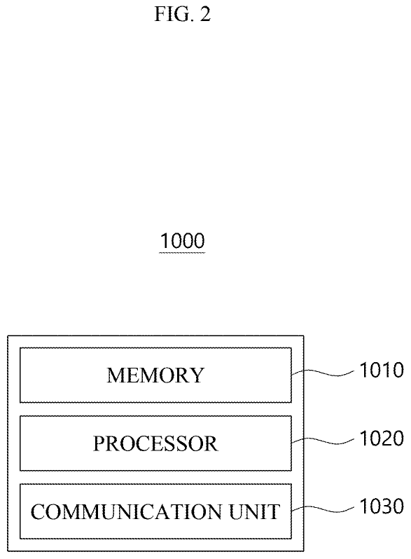

FIG. 2 is a block diagram illustrating a computing device for performing a data clinic method and a model training method for a data clinic according to various embodiments of the present disclosure.

Referring to FIG. 2, a computing device 1000 may include various components for providing a data clinic method. Specifically, the computing device 1000 may include a memory 1010 that stores data and various instructions to be transmitted to a processor, a processor 1020 that performs an operation based on the instructions received from the memory 1010, and a communication unit 1030 that allows the computing device 1000 to perform internal data communication or enables communication between the computing device 1000 and an external device.

In addition, optionally or alternatively, the computing device 1000 may further include an input device (not illustrated). In this case, the input device is a device from which an external user input is first received. For example, the computing device 1000 may further include at least one input device such as a keyboard and a mouse.

In addition, optionally or alternatively, the computing device 1000 may further include an output device (not illustrated). In this case, the output device is a device for externally displaying specific information from the processor 1020. For example, the computing device 1000 may further include at least one of a display, a virtual reality (VR) device, augmented reality (AR) glasses, an AR projector, a printing device, or the like.

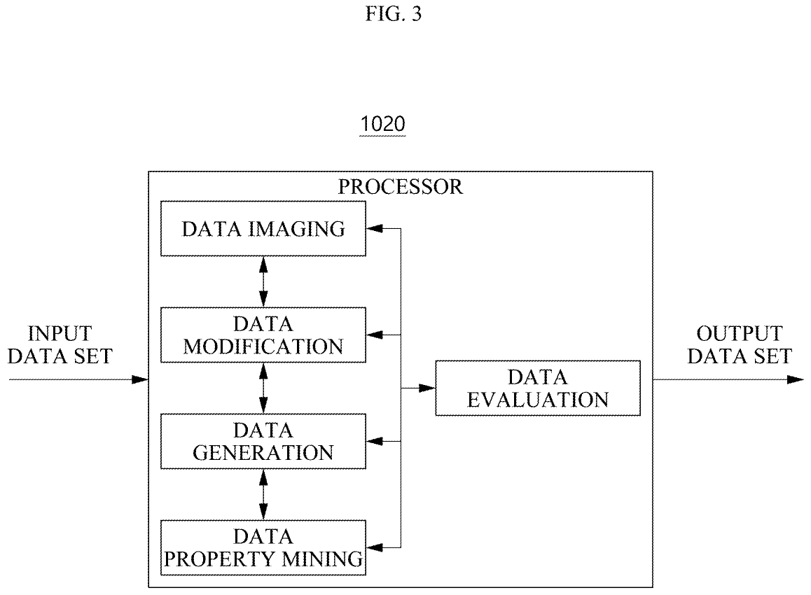

FIG. 3 is a diagram for describing various operating methods performed by a computing device for performing a data clinic method according to various embodiments of the present disclosure.

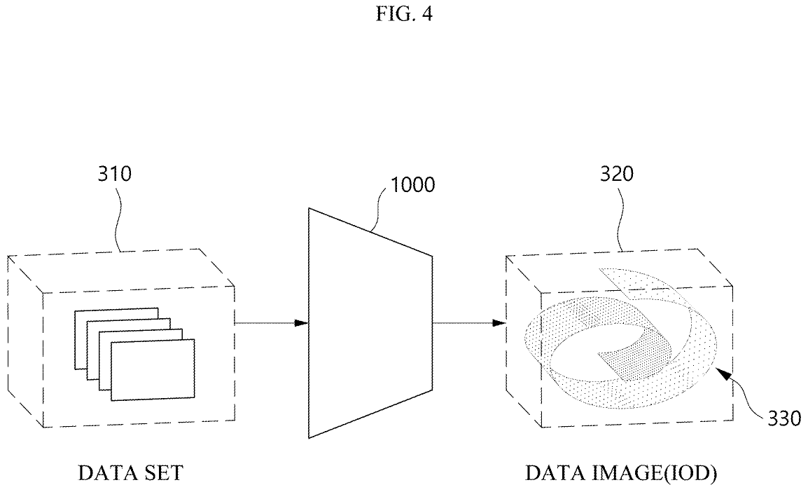

Referring to FIG. 3, at least one processor 1020 of a computing device for a data clinic may perform various operating methods to perform a data clinic method. In this case, various operating methods may be coded and stored in the memory of the computing device. Specifically, the at least one processor may process an input data set received based on various operating methods and output an output data set. In this case, details of data included in the input data set and the output data set will be described below (described with reference to FIGS. 4 to 33).

For example, a computing device according to various embodiments of the present disclosure may perform an operating method of data imaging, an operating method of data modification, an operating method of data generation, an operating method of data property mining, or an operating method of data evaluation, but is not limited thereto.

In addition, each of the above-described operating methods may be performed based on operation algorithms of at least one processor included in the computing device.

For example, the computing device according to various embodiments of the present disclosure may perform a data imaging algorithm, a data modification algorithm, a data generation algorithm, a data property mining algorithm, a data evaluation algorithm, or the like, but is not limited thereto.

In this case, since names of each operating method and algorithm are arbitrarily named according to output results for convenience of description, each operating method or algorithm is only defined based on the operations performed by the processor. The names of the operating method or algorithm itself do not limit the invention.

More specifically, the computing device according to various embodiments of the present disclosure may generate an image of an input data set by processing the input data set according to the data imaging algorithm.

In addition, the computing device according to various embodiments of the present disclosure may process the input data set according to the data modification algorithm to modify data, and may generate results of the modification.

In addition, the computing device according to various embodiments of the present disclosure may generate synthetic data by processing the input data set according to the data generation algorithm.

In addition, the computing device according to various embodiments of the present disclosure may process the input data set according to the data property mining algorithm to mine the property of the input data set.

In addition, the computing device according to various embodiments of the present disclosure may process the input data set according to the data evaluation algorithm to evaluate the quality of the input data set.

Details of each algorithm described above will be described below.

In addition, the computing device according to various embodiments of the present disclosure may perform the above-described various operating methods or algorithms in parallel, sequentially, or selectively. Specifically, the computing device may use the same input data in parallel as input values of different algorithms, continuously use a result value output according to a specific algorithm as an input value of another algorithm, or selectively perform some of the plurality of algorithms in a predetermined manner.

In addition, various operating methods or algorithms for the above-described data clinic may be performed on a deep learning model included in the computing device according to various embodiments of the present disclosure. Specifically, the computing device according to various embodiments of the present disclosure may include one deep learning model for performing various operating methods or algorithms described above, but is not limited thereto, and may include a plurality of deep learning models for performing each of the above-described operating methods or algorithms, and include one or more deep learning models for performing at least some of the above-described various operating methods or algorithms.

FIG. 4 is a diagram for describing a method of providing, by a computing device, an image of data according to various embodiments of the present disclosure.

Referring to FIG. 4, the computing device 1000 according to various embodiments of the present disclosure may receive a data set and provide an image of data IOD.

In this case, the data set may be M (M>0)-dimensional data. In other words, the data set may be a data set defined in an M-dimensional input space 310.

In addition, the data set may be a data set of a single modality. For example, the data set may be an image data set. In addition, the data set may be a text data set.

In addition, the present disclosure is not limited thereto, and the data set may be a set of data having different modalities. For example, the data set may be an image data set including annotation information. In addition, the data set may be a mixed data set of images and text.

The computing device 1000 according to various embodiments of the present disclosure may input and process, as an input data set, data of all modalities that may be used for deep learning training, such as a time series data set and a sensor data set, as well as the above-described image data and text data.

The image of data IOD provided by the computing device 1000 according to various embodiments of the present disclosure may be represented in an imaging space 320 by processing the input data set. Here, the image does not mean a 2D image, but is a representation that refers to a visual representation of data. Specifically, the imaging space 320 is a concept including all of a 2D space, a 3D space, and an N-dimensional virtual space, and refers to a space in which an image of data provided according to an embodiment is represented. For example, when the computing device processes the input data set and outputs the image of data in a PDF format, the computing device may output an output representing the image of data in a 2D or 3D imaging space, but is not limited thereto.

When the computing device 1000 according to various embodiments of the present disclosure includes an output device (not illustrated), the computing device may provide an image of data through the output device. For example, the computing device 1000 may provide an image of data by outputting the image of data through a display connected to the computing device 1000. In this case, the imaging space 320 may be a screen of the display. In addition, for example, the computing device 1000 may provide an image of data by outputting the image of data through a printing device connected to the computing device 1000. In this case, the imaging space 320 may be a piece of paper output by the printing device.

In addition, when the computing device 1000 according to various embodiments of the present disclosure communicates with an external device through a communication unit, the computing device 1000 may provide the image of data through the external device. In this case, the imaging space 320 may be a display screen of the external device. For example, when the computing device 1000 is a server device, the server device may provide an image of data by transmitting the image of data to at least one external device communicating with the server device through a network connected to the server device.

The computing device according to various embodiments of the present disclosure may provide an image of data including a data point (or point data) set 330 corresponding to the input data set. In this case, the data point set 330 may be a data set in which each piece of data included in the data set is visualized as a point. In this case, a shape, a color, or the like of the visualized point may be variously selected depending on the embodiment, and thus, the term “point” is not intended to limit the present disclosure.

In addition, the point may be expressed with various terms according to embodiments. For example, the point may be expressed with terms such as a vector or a feature appearing in an embedding space or a latent space, but is not limited thereto.

In order for the computing device according to various embodiments of the present disclosure to provide an image of data, as described above, it is necessary to identify a data point set corresponding to the input data set.

In this case, the computing device may obtain the data point set by identifying a manifold in which data included in the input data set is formed in an embedding space (or latent space) of a specific dimension. Here, the manifold may mean a virtual space of a specific dimension in which data is actually present in the dimension of the input space in which the input data set is defined. In addition, the manifold may mean any shape that data forms in a specific dimension. In other words, when the input data set received is mapped to a data point set on an embedding space of a specific dimension, the manifold may mean a region in which the data point set is identified or a shape formed by the data point set.

Hereinafter, a method of identifying, by a computing device, a data point set corresponding to an input data set and providing an image of data based on the identified data point set according to various embodiments of the present disclosure will be described in detail.

The computing device 1000 providing the image of data according to FIG. 4 may include a model for generating an imaging manifold (not illustrated) for identifying the data point set.

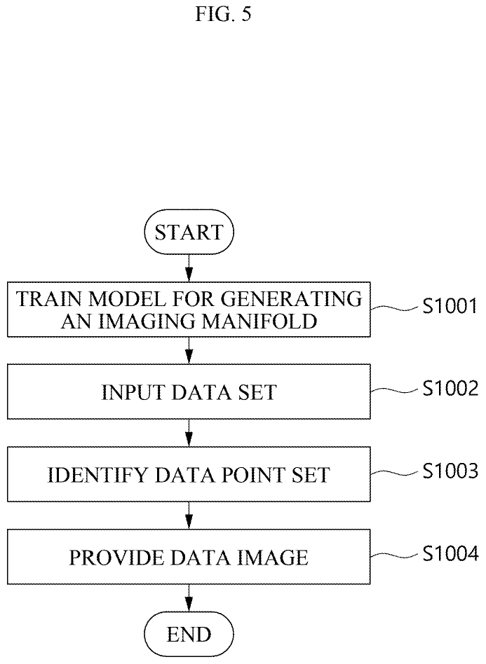

FIG. 5 is a flowchart for describing a method of providing, by a computing device, an image of data according to various embodiments of the present disclosure.

Referring to FIG. 5, the computing device may train a model for generating an imaging manifold for identifying a data point set included in an image of data (S1001). In this case, the model for generating an imaging manifold may be a deep learning model including an artificial neural network.

The computing device 1000 may train a model for generating an imaging manifold to build a manifold of a specific dimension in which an intrinsic property of a data set is preserved. Here, the intrinsic property of the data set means a property related to a distribution of data itself, regardless of a modality of data, a domain in which data is defined, a category of data, and the like. For example, the intrinsic property of the data set may include a distance between data points included in the data set. In this case, the distance between the data points may mean a Euclidean distance, but is not limited thereto, and may include all mathematical concepts commonly used as a distance between data points among those skilled in the art.

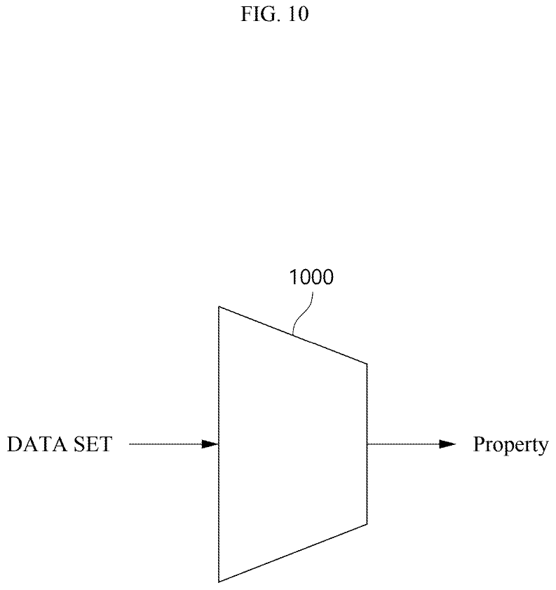

The property of data defined through the present disclosure will be described in more detail below (description with reference to FIGS. 10 to 15).

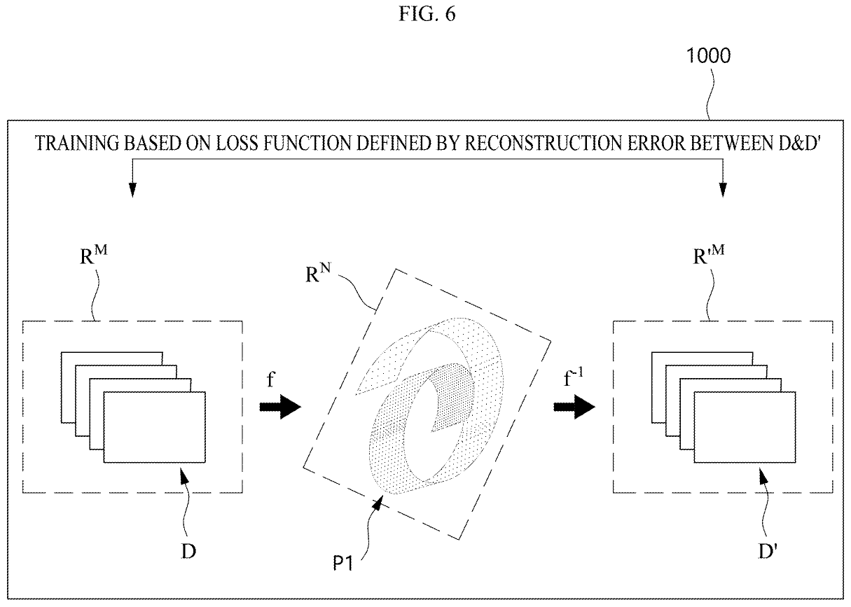

An example of a method of training, by a computing device, a model for generating an imaging manifold according to various embodiments of the present disclosure will be described with reference to FIG. 6.

FIG. 6 is a diagram illustrating an example of a method of training, by a computing device, a model for generating an imaging manifold according to various embodiments of the present disclosure.

Referring to FIG. 6, the computing device 1000 may train a model for generating an imaging manifold to find a manifold maintaining an intrinsic property of a training data set D based on the training data set D.

In addition, the computing device 1000 may obtain a first data point set P1 based on the training data set D. In this case, the training data set D may be an M-dimensional data set that may be defined in an M-dimensional input domain R^{M}.

In addition, the computing device may obtain the first data point set P1 by processing the training data set D according to a predetermined condition. Specifically, the computing device may obtain the first data point set P1 by mapping the training data set D to an N-dimensional first embedding space R^{N} based on a predetermined condition (e.g., a matrix stored in advance for mapping to an embedding space of a specific dimension) defined by a mapping function f. For example, the computing device may obtain the first data point set P1 by encoding the training data set D, but is not limited thereto.

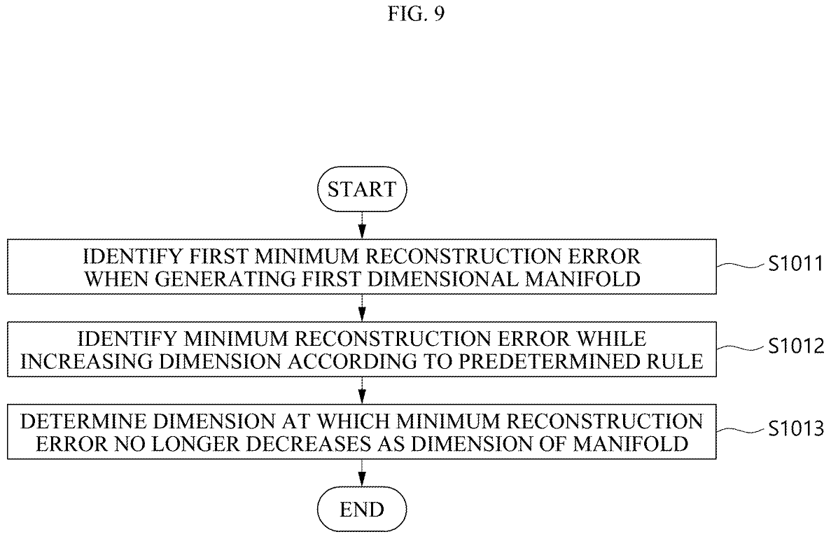

A method of determining an optimal dimension of a manifold in which the data point set is defined will be described in detail with reference to FIG. 9.

In addition, the computing device may obtain a reconstruction data set D′ based on the first data point set P1. In this case, the reconstruction data set D′ may be an M-dimensional data set that may be defined in the same M-dimensional space as the training data set D.

In addition, the computing device may obtain the reconstruction data set D′ by processing the first data point set P1 according to a predetermined condition. Specifically, the computing device may obtain the reconstruction data set D′ by reconstructing the first data point set P1 on an M-dimensional output domain R′^{M} based on a predetermined condition (e.g., an inverse matrix of a matrix stored in advance for mapping to an embedding space of a specific dimension) defined as an inverse function f⁻¹ of the mapping function f. In this case, the input domain and the output domain may be included in the same virtual space, but is not limited thereto.

In addition, the computing device may train a model for generating an imaging manifold based on the training data set D and the reconstruction data set D′. Specifically, the computing device may train the model for generating an imaging manifold based on a loss function defined based on a similarity between the training data set D and the reconstruction data set D′. For example, the computing device may train the model for generating an imaging manifold in a direction that minimizes a reconstruction error on how similarly the reconstruction data set D′ is reconstructed to the training data set D, but is not limited thereto.

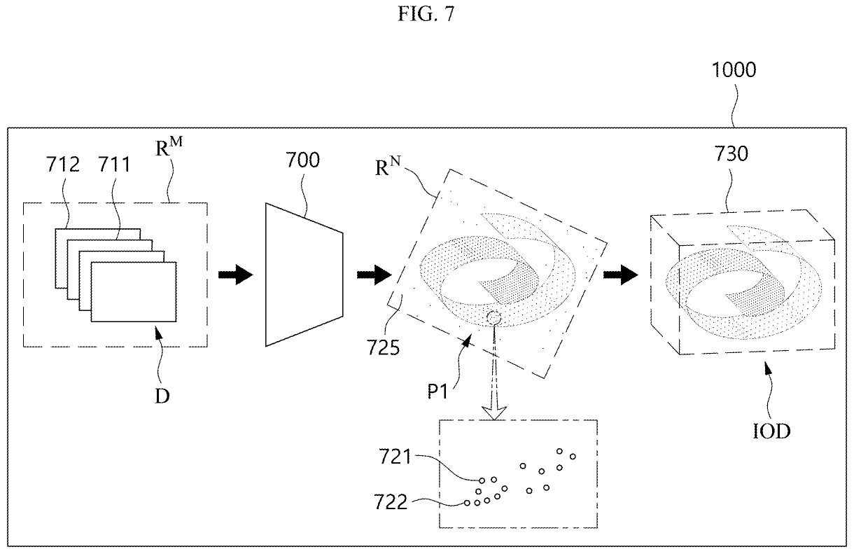

FIG. 7 is a diagram for describing a data imaging process of a computing device according to various embodiments of the present disclosure.

Referring back to FIG. 5, the computing device may input the data set to the trained model for generating an imaging manifold (S1002). In this case, the computing device may input a data set received from the outside to the trained model for generating an imaging manifold, or may receive a data set stored in the computing device. For example, the computing device may receive the data set from an external device connected through a communication network or call the data set stored in the memory of the computing device, but is not limited thereto.

For example, referring to FIG. 7, the computing device 1000 may input the data set D defined in the M-dimensional input domain R^{M} to the model for generating an imaging manifold 700.

In addition, referring back to FIG. 5, the computing device may identify a data point set corresponding to the data set by processing the input data set through the model for generating an imaging manifold (S1003).

For example, referring back to FIG. 7, since the model for generating an imaging manifold 700 may output the first data point set P1 defined in an N-dimensional first embedding space R^{N} based on the input data set D, the computing device 1000 may identify the first data point set P1. In this case, the first data point set P1 may form an N-dimensional first manifold.

In addition, the first data point set P1 output from the model for generating an imaging manifold 700 may reflect a relationship between data included in the data set D received by the model for generating an imaging manifold 700. More specifically, the model for generating an imaging manifold 700 may be trained to maintain the intrinsic properties such as the relevance or similarity between data included in the input data set as described with reference to FIG. 6. Accordingly, when the trained model for generating an imaging manifold 700 receives the data set D, the first data point set P1 representing a relationship between data included in the data set D by generating the N-dimensional manifold may be output. This is because the computing device has trained the model for generating an imaging manifold to minimize an error between the data set input to the model for generating an imaging manifold and the data set reconstructed from the model for generating an imaging manifold.

In addition, the first data point set P1 output from the model for generating an imaging manifold 700 may correspond to the input data set D. In this case, each point included in the first data point set P1 may correspond to each data point included in the data set D. For example, a first image data point 711 included in the data set D may correspond to a first data point 721 included in the data point set, and a second image data point 712 may correspond to a second data point 722.

In addition, a distance between points included in the first data point set P1 output from the model for generating an imaging manifold 700 may be determined based on the relationship between data included in the data set D input to the model for generating an imaging manifold 700. That is, the higher the relevance (or similarity) between the data included in the data set D, the closer the data may be positioned in the first embedding space.

In addition, the present invention is not limited thereto, and each point included in the data point set may correspond to two or more data points included in the data set. For example, the first image data point 711 and the second image data point 712 included in the data set may correspond to the first data point 721 included in the data point set.

In addition, the present invention is not limited thereto, and two or more points included in the data point set may correspond to two or more data points included in the data set. For example, the first image data point 711 and the second image data point 712 included in the data set may correspond to the first data point 721 and the second data point 722 included in the data point set.

In addition, the computing device 1000 may arbitrarily determine a visual shape of the first manifold in which the first data point set P1 is defined. Specifically, the computing device 1000 may obtain the first data point set P1 by mapping a plurality of data points in a manifold space having a predetermined shape so that the intrinsic property of the data set D is maintained. For example, the computing device 1000 may store in advance various templates (e.g., a spiral shape, etc.) for the shape of the first manifold, and may obtain the first data point set P1 based on at least one of various templates.

In addition, referring back to FIG. 5, the computing device may provide the identified data point set data image (S1004).

For example, referring back to FIG. 7, the computing device 1000 represents the first data point set P1 output from the model for generating an imaging manifold in an imaging domain (or imaging space 730) to obtain an image of data IOD. Specifically, the computing device 1000 may obtain the image of data IOD by mapping the first data point set P1 from the first embedding space to the imaging space.

In this case, the computing device 1000 may map the first data point set P1 according to a predetermined condition. Specifically, the computing device 1000 may obtain the image of data IOD by processing the first data point set P1 in a predetermined manner.

For example, the computing device 1000 may represent the first data point set P1 in the imaging space 730 so that the first data point set P1 is maintained as it is, but is not limited thereto.

In addition, for example, the computing device 1000 may generate the image of data so that noise data 725 included in the first data point set P1 is removed. In this case, the noise data 725 may be one or more data points positioned outside the manifold space formed by the first data point set P1 within the first data point set P1. In other words, the noise data 725 may be at least one outlier point with respect to the manifold space formed by the first data point set P1.

The above-described noise data may also be data corresponding to data included in the data set. The computing device may remove the noise data from an image of data to provide the image of data in order to provide a clearer image from a visualization point of view.

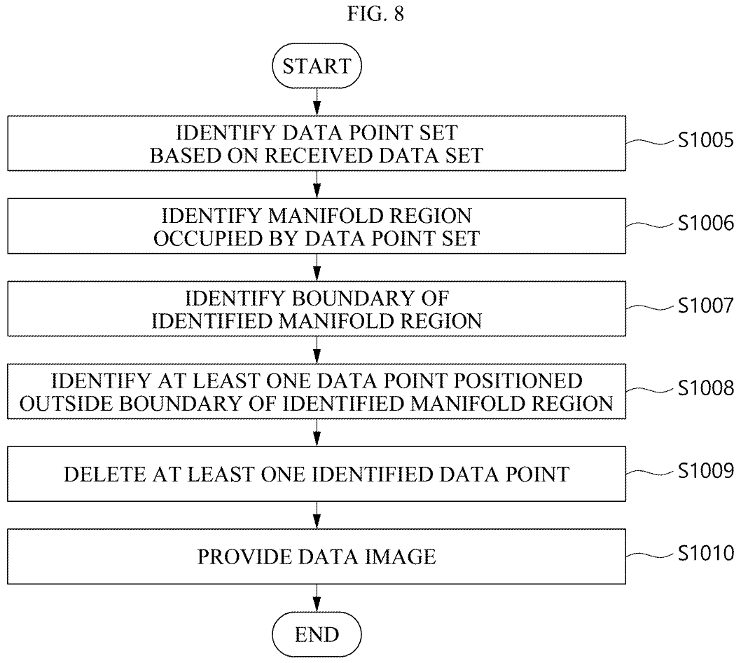

An example of providing, by the computing device, an image of data by removing noise data of a data point set will be described with reference to FIG. 8.

FIG. 8 is a flowchart illustrating an example of generating, by the computing device, an image of data based on a data point set according to various embodiments of the present disclosure.

Referring to FIG. 8, the computing device may identify the data point set based on received input data set (S1005). The technical features of operation S1005 have been described above, and thus, a description thereof will be omitted.

In addition, the computing device may identify a manifold region occupied by the data point set, in which the data point set is formed (S1006). In this case, the manifold region may mean a virtual region formed by the data point set in a latent space (or embedding space) in which the data point set is defined.

In addition, the computing device may identify a boundary of the identified manifold region (S1007). In this case, the boundary of the manifold region may mean the shape of the manifold region. Specifically, the computing device may determine a boundary of a manifold region connected to points positioned outside the region in which the data point set is positioned.

In addition, the computing device may identify one or more data points (at least one data point) positioned outside the boundary of the identified manifold region (S1008). Specifically, the computing device may determine one or more data points positioned outside the boundary of the identified manifold region as noise data (or outlier data).

In addition, the computing device may delete the one or more (at least one) identified data points (S1009). Specifically, the computing device may enhance the visual effect of the image of data by deleting at least one data point determined as the noise data.

In addition, the computing device may provide an image of data based on the data point set output according to operation S1009 (S1010).

To provide an image of data that better reveals the intrinsic properties of the data set, it is necessary to optimize the manifold formed by the data point set. Here, the optimization of the manifold may mean generating a manifold with a minimized reconstruction error through the training of the model for generating a manifold described with reference to FIG. 6, but is not limited thereto, and the manifold generated according to the training result may mean a process of optimizing based on another method.

Specifically, the computing device according to various embodiments may generate the represented manifold by optimizing the intrinsic property of the data set by processing the data set according to a predetermined method.

For example, the computing device according to various embodiments may generate a manifold of a data point set to minimize an amount of noise data. Specifically, the computing device may iterate the manifold generation process to reduce the amount of noise data. In this case, the computing device may iterate the process of generating a manifold until the noise data included in the manifold meets a predetermined criterion or less.

To provide an image of data that better reveals the intrinsic properties of the data set, it is necessary to determine the optimal dimension of the manifold formed by the data point set. This is because, when generating an image of data based on a low-dimensional manifold for efficiency of data processing, the actual structure of the data set may be distorted, and when generating an image of data based on a high-dimensional manifold for accuracy, the efficiency of data processing may decrease.

In order to solve the above-described problem, the computing device according to various embodiments of the present disclosure may determine an optimal dimension for data imaging based on a method of determining various manifold dimensions.

Hereinafter, an example of determining, by a computing device, an optimal manifold dimension for data imaging according to various embodiments of the present disclosure will be described.

FIG. 9 is a flowchart diagram illustrating an example of a method of determining an optimal dimension of a manifold for data imaging.

The computing device may determine an optimal manifold dimension for data imaging based on a minimum reconstruction error according to the dimension of the manifold generated by the model for generating an imaging manifold. In this case, the minimum reconstruction error may mean a reconstruction error value when the training of the model for generating an imaging manifold is completed.

More specifically, the computing device may generate a manifold while increasing a dimension, and may determine a lowest dimension having the minimum reconstruction error value corresponding to the generated manifold as an optimal dimension. As a specific example, as the dimension is increased according to a predetermined rule, the computing device may determine a dimension when the minimum reconstruction error no longer decreases as the optimal dimension of the manifold.

Referring to FIG. 9, the computing device may identify a first minimum reconstruction error when generating a first dimensional manifold (S1011). In this case, the first dimension may be an initial value set for the computing device to perform an algorithm for determining an optimal dimension. For example, when the above-described algorithm is performed, the computing device may initially generate a three-dimensional manifold, but is not limited thereto.

In addition, the computing device may identify the minimum reconstruction error while increasing the dimension according to the predetermined rule (S1012).

In this case, the predetermined rule may mean logic for increasing a dimension pre-stored in the computing device. For example, the computing device may identify the minimum reconstruction error while increasing the dimension of the manifold by a predetermined value (e.g., 1), but is not limited thereto, and identify the minimum reconstruction error while increasing the dimension of the manifold according to a predetermined sequence (e.g., an arithmetic sequence, an equidistant sequence, etc.).

In addition, the present disclosure is not limited thereto, and the predetermined rule may be determined based on the first minimum reconstruction error. More specifically, the computing device may determine an increase in dimension based on whether the first minimum reconstruction error calculated in operation S1011 is greater than or equal to a threshold value. For example, when the first minimum reconstruction error is less than or equal to the threshold value, the computing device may increase a dimension by a first increment to identify the minimum reconstruction error, and when the first minimum reconstruction error is greater than or equal to the threshold value, the computing device may identify the minimum reconstruction error by increasing a dimension by a second increment greater than the first increment.

In addition, the computing device may determine a dimension in which the minimum reconstruction error is no longer reduced as the dimension of the manifold (S1013). Specifically, the computing device may determine, as the dimension of the manifold, a dimension value when the minimum reconstruction error no longer decreases regardless of the increase in the dimension.

In addition, the present disclosure is not limited thereto, and the computing device may determine the dimension of the manifold based on the amount of change of the minimum reconstruction error. Specifically, the computing device may calculate the amount of change of the minimum reconstruction error according to the dimension, and determine the dimension of the manifold by identifying whether the amount of change of the minimum reconstruction error is less than or equal to the threshold value. For example, the computing device may determine, as a manifold to be generated, a dimension value when the amount of change of the minimum reconstruction error is less than or equal to the threshold value.

In addition, the present disclosure is not limited thereto, and the computing device may determine the dimension of the manifold based on an inflection point of the amount of change of the minimum reconstruction error. Specifically, the computing device may determine, as the dimension of the manifold, a dimension value when the amount of change of the minimum reconstruction error increases and then starts to decrease.

In addition, the computing device may store in advance a maximum dimension value in which the manifold is defined. Specifically, after the computing device identifies the minimum reconstruction error while increasing the dimension according to the predetermined rule, when the dimension value reaches the pre-stored maximum dimension value, the computing device may determine the pre-stored maximum dimension value as the dimension of the manifold. In this case, the maximum dimension value may be set in consideration of the processing capacity of the computing device. This is taken into account because a data processing load of the computing device increases when the dimension of the manifold increases.

In addition, the computing device according to various embodiments of the present disclosure may store a dimension value of a manifold suitable for data imaging according to the input data set. Specifically, the dimension value of the manifold determined according to the above-described method and a data set corresponding thereto may be pre-stored. In addition, the dimension value of an arbitrarily determined manifold and a data set corresponding thereto may be pre-stored. In addition, the computing device may store the relationship between the dimension value of the manifold and the input data set in the form of a database.

In addition, the computing device may determine the dimension of the manifold based on the database on the relationship between the dimension value of the manifold and the input data set. Specifically, when the data set is input, the computing device may identify a data set similar to the data set in a database, and select the dimension value of the manifold corresponding to the identified data set. For example, the computing device may identify a data set having a distribution similar to that of the input data set in the database to select a dimension value corresponding thereto, but is not limited thereto. In addition, for example, the computing device may identify a data set having a dimension similar to that of the input data set in the database to select a dimension value corresponding thereto, but is not limited thereto. In addition, for example, the computing device may identify a data set having a distance from the input data set which is less than or equal to a predetermined threshold value to select the dimension value corresponding thereto, but is not limited thereto.

FIG. 10 is a diagram illustrating a method of providing, by a computing device, a property of a data set according to various embodiments of the present disclosure.

Referring to FIG. 10, the computing device 1000 may obtain the property of the data set by processing the obtained data set.

In this case, the property of the data set may mean various pieces of information representing the data set. For example, the property of the data set may include, but is not limited to, the density, homogeneity, distribution, or the like of the data set. That is, the property of the data set may mean an intrinsic property such as the density of data that is not related to the task in which the data set is utilized, but is not limited thereto, and may in addition include task-dependent properties such as a percentage of hard-negative that is related to a task (e.g., classification) for which the data set is utilized.

In addition, the computing device may store an operation metric corresponding to each of the properties of the data set in a memory. More specifically, the computing device may store a metric for calculating the density of the data set, a metric for calculating the homogeneity of the data set, a metric for calculating the distribution of the data set, or the like, but is not limited thereto.

In addition, the computing device may obtain the property of the data set based on the stored calculation metric according to a data property mining algorithm constructed with an artificial neural network. Specifically, the property mining algorithm may be implemented as a feed-forward neural network.

For example, the computing device may include a separate neural network for calculating the properties of the data set, or may include a neural network including a layer for calculating the properties of the data set, but is limited thereto.

As an example, the computing device may include an artificial neural network for property mining designed to extract the properties of the data set when receiving the data set. In this case, the artificial neural network for extracting the property may be an artificial neural network that has been transfer-trained to calculate the property of data.

As another example, the computing device may obtain a property of a data set by constructing an artificial neural network in which a layer for data property mining is added to a model for generating an imaging manifold for providing an image of data based on the data set.

Specifically, the computing device may identify a data point set based on the above-described model for generating an imaging manifold based on the obtained data set, and obtain the property of the data set based on the identified data point set.

In this case, the computing device may obtain the property of the data set by processing each data point included in the data point set with a predetermined algorithm. In this case, the computing device may allocate a property value to each data point included in the data point set, and may obtain the property of the data set based on the property values.

In addition, the present disclosure is not limited thereto, and the computing device may obtain the property of the data set by processing the data point set with a predetermined algorithm.

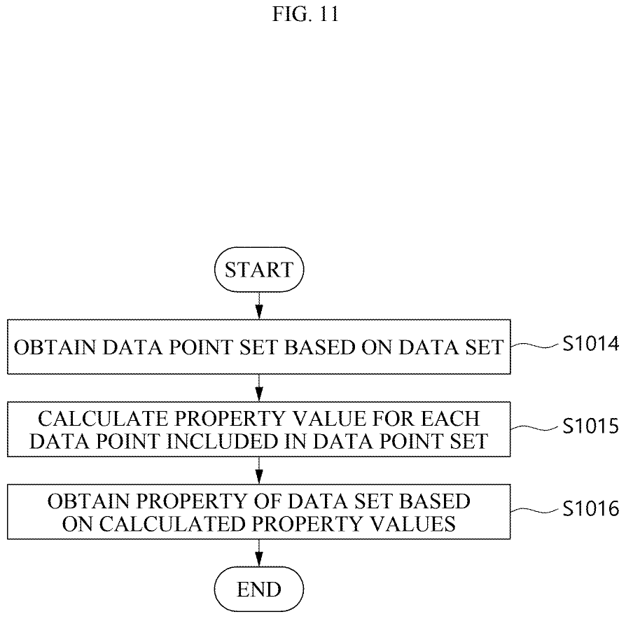

FIG. 11 is a flowchart illustrating a method of identifying, by a computing device, a property of a data set based on data points included in a data point set according to various embodiments of the present disclosure.

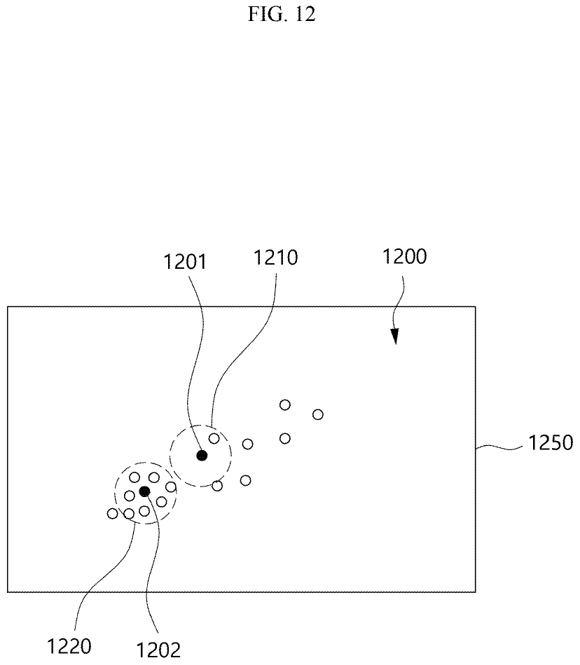

FIG. 12 is a diagram illustrating an example of identifying, by a computing device, a property of a data set based on a data point set according to various embodiments of the present disclosure. A latent space 1250 of FIG. 12 is illustrated as a two-dimensional space for convenience of description, but may actually be a three-dimensional or more manifold space.

Referring to FIG. 11, the computing device may obtain a data point set based on a data set (S1014). In this case, since all the above-described technical features (FIGS. 4 to 9) may be applied to a specific method of obtaining, by a computing device, a data point set, a description thereof will be omitted.

For example, referring to FIG. 12, the computing device may obtain a data point set 1200 defined in the latent space 1250 based on the obtained data set. In this case, the data point set 1200 may include a plurality of data points including a first data point 1201 and a second data point 1202.

In addition, the computing device may calculate a property value for each data point included in the data point set (S1015). In this case, the property value may mean a value that the computing device calculates for a data point in order to obtain the property of the data set. In addition, the property value may be calculated based on a distance between data points included in the data point set. For example, the property value may mean the number of data points present within a predetermined distance with respect to a specific data point, but is not limited thereto. In addition, for example, the property value may mean an average value of distances from a specific data point to the predetermined number of nearby data points, but is not limited thereto.

In addition, referring back to FIG. 12, the computing device may calculate a property value for each data point included in the data point set 1200 according to a predetermined method.

As an example, the computing device may calculate a property value based on the number of data points positioned in regions 1210 and 1220 within a predetermined distance with respect to the specific data point. For example, the computing device may determine the number of data points (e.g., 7) positioned in the first region 1210 within a predetermined distance with respect to the first data point 1201 as a property value of the first data point 1201. In addition, the computing device may determine the number of data points (e.g., 1) positioned in the second region 1220 within a predetermined distance with respect to the second data point 1202 as a property value of the second data point 1202.

As another example, the computing device may calculate a property value based on an average value of distances to the predetermined number of data points close to the specific data point. For example, the computing device may calculate an average distance value based on distance values from the first data point 1201 to K adjacent data points, and use the calculated average distance value as the property value of the first data point 1201, but is not limited thereto.

As another example, the computing device may determine a class classified for each data point included in the data point set 1200 as the property value of the data points. Specifically, when the data set obtained by the computing device includes annotation information, the computing device may determine classes of each data point included in the data point set 1200 obtained based on the data set. In this case, the computing device may obtain property values based on a k-nearest neighbors (k-NN) algorithm, but is not limited thereto.

In addition, referring back to FIG. 11, the computing device may obtain the property of the data set based on the calculated property values (S1016). Specifically, the computing device may obtain an intrinsic property or a task-dependent property of the data set based on the calculated property values. For example, the computing device may obtain the density, homogeneity, class distribution, or the like of a data set based on the property values of each data point, but is not limited thereto.

In addition, the computing device may obtain the property of the data set based on the distribution of the property values of each data point. Specifically, the computing device may obtain the property of the data set based on a statistical distribution such as an average, a deviation, or a variance of each property value of the data points, but is not limited thereto.

For example, referring back to FIG. 12, the computing device may determine an average of property values (for example, the number of data points included in a region within a predetermined distance) of each data point included in the data point set 1200 as the property of the data set.

In addition, for example, the computing device may determine a statistical distribution of classes of each data point included in the data point set 1200 as the property of the data set.

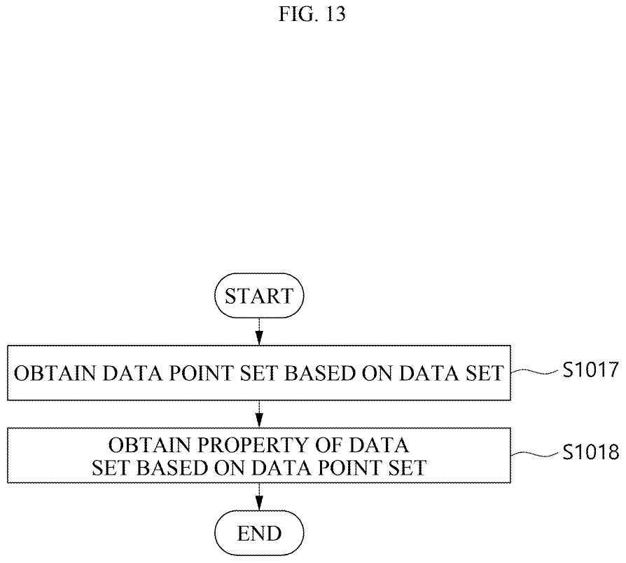

FIG. 13 is a flowchart illustrating a method of identifying, by a computing device, a property of a data set based on a data point set according to various embodiments of the present disclosure.

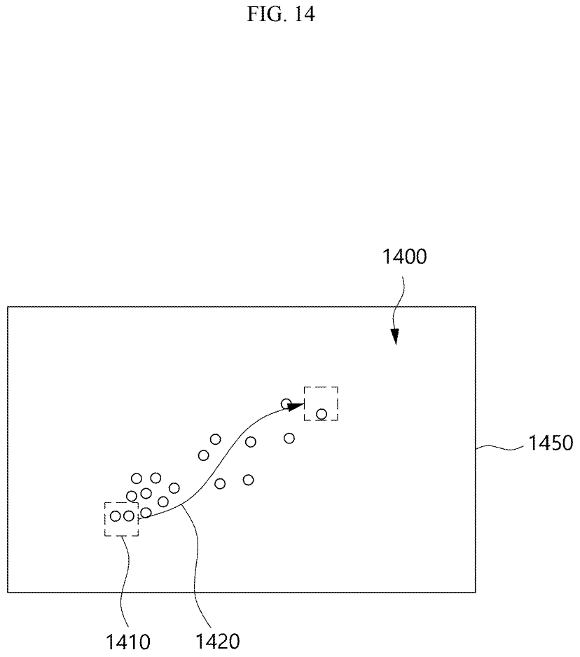

FIG. 14 is a diagram illustrating an example of identifying, by a computing device, a property of a data set based on a data point set according to various embodiments of the present disclosure. A latent space 1450 of FIG. 14 is illustrated as a two-dimensional space for convenience of description, but may actually be a three-dimensional or more manifold space.

Referring to FIG. 13, the computing device may obtain a data point set based on a data set (S1017). In this case, since all the above-described technical features (FIGS. 4 to 9) may be applied to a specific method of obtaining, by a computing device, a data point set, a description thereof will be omitted.

For example, referring to FIG. 14, the computing device may obtain a data point set 1400 defined in the latent space 1450 based on the obtained data set.

In addition, the computing device may obtain the property of the data set based on the data point set (S1018). In this case, the computing device may obtain the property of the data set by processing the data point set according to a predetermined algorithm.

For example, referring back to FIG. 14, the computing device may obtain the property of the data set by processing the data point set 1400 defined in the latent space 1450 according to a predetermined algorithm.

Specifically, the computing device may obtain the property of the data set by processing the data point set 1400 defined in the latent space 1450 based on a pre-stored filter 1410. In this case, the pre-stored filter 1410 may be a filter of a predetermined size (e.g., a 3*3 or 5*5 kernel).

In addition, the computing device may apply the pre-stored filter 1410 along a predetermined path 1420 in the latent space 1450.

In addition, the computing device may obtain the property of the data set by processing the data point set 1400 based on the pre-stored filter 1410 along the entire latent space 1450.

In addition, the computing device may process the data point set 1400 such that the number of data points at a position to which the pre-stored filter 1410 is applied in the data point set 1400 is counted.

For example, the computing device may obtain the property of the data set based on the number of data points included in a region to which the pre-stored filter 1410 is applied.

In addition, as the computing device moves the pre-stored filter 1410 along a predetermined path 1420, the property of the data set may be obtained based on the distribution of the number of data points included in the region to which the pre-stored filter 1410 is applied.

In addition, when the pre-stored filter 1410 is applied along the predetermined path 1420, the computing device may determine a movement range (or stride) of the pre-stored filter 1410. In this case, the movement range of the pre-stored filter 1410 may be predetermined, but is not limited thereto, and may be arbitrarily adjusted.

For example, the computing device may obtain the homogeneity of the data set based on the deviation or variance (statistical distribution) of the number of data points included in the region to which the pre-stored filter 1410 is applied. In this case, the homogeneity of the data set may appear as a specific result value based on a lookup table previously stored in the computing device, but is not limited thereto.

In addition, the computing device may pre-process the data point set 1400 to obtain the information on the positions where the data points are present. In this case, the computing device may apply the pre-stored filter 1410 only to a region corresponding to the positions where the data points are present in the latent space 1450.

In addition, the computing device may apply the pre-stored filter 1410 along the predetermined path 1420 defined in a region corresponding to the positions where the data points are present in the latent space 1450.

As a specific example, the computing device may obtain a feature map related to a property of a data set using a convolution algorithm based on a kernel.

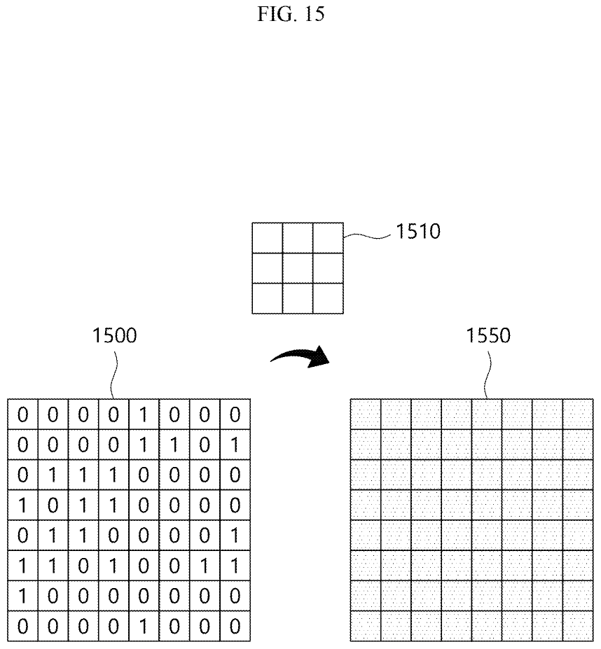

FIG. 15 is a diagram for describing a method of obtaining, by a computing device, a property of a data set using a convolution algorithm according to various embodiments of the present disclosure.

Referring to FIG. 15, the computing device may represent the above-described data point set (see reference numeral 1400 of FIG. 14) as a point image 1500 defined by a plurality of unique values. In this case, the plurality of unique values may be values allocated based on whether the data point is present at each position in the above-described latent space (see reference numeral 1450 in FIG. 14). For example, the point image 1500 may be identified by expressing a position where the data point is present as 1 and a position where the data point is not present as 0, but is not limited thereto.

In addition, a size (or dimension) of the point image 1500 may correspond to the size (or dimension) of the latent space 1450 described above. In FIG. 15, the point image 1500 is illustrated in a two-dimensional space for convenience of description, but in reality, may be a three-dimensional or higher image.

In addition, the computing device may process the point image 1500 by applying the pre-stored kernel 1510 to obtain a feature map 1550 related to a property of a data set.

Specifically, the computing device may calculate an output value by convolving the point image 1500 based on the pre-stored kernel 1510, and obtain a feature map 1550 based on the calculated output values.

In this case, the pre-stored kernel 1510 may be designed to determine the distribution of the data set. Specifically, the pre-stored kernel 1510 may be a kernel designed to output a feature map 1550 related to the distribution of the input point image 1500.

Accordingly, the feature map 1550 may be related to the property of the data set. For example, the feature map 1550 related to the property of the data set may be a feature map representing the distribution, density, or homogeneity of the data set.

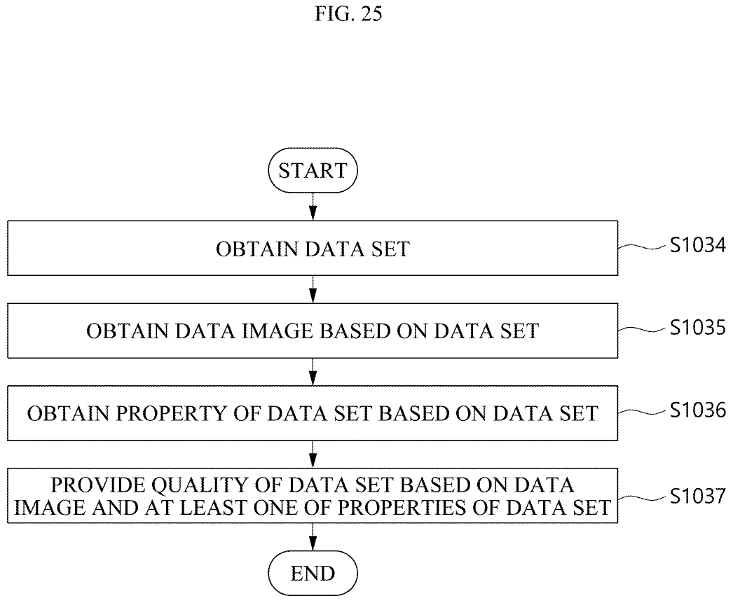

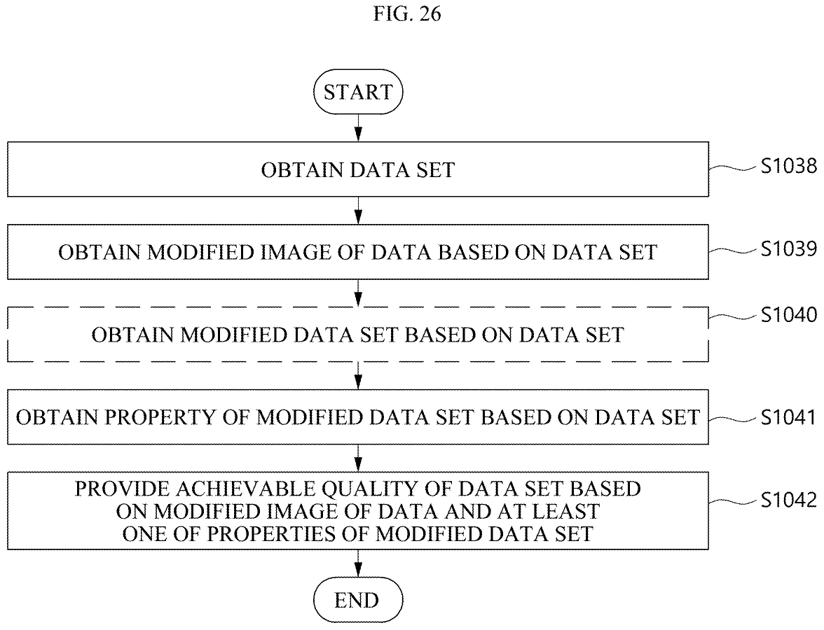

The computing device according to various embodiments of the present disclosure may obtain a data set and process the obtained data set to modify the data set. Here, the modification of the data set may mean providing a method of modifying the quality of data set, which will be described below (FIGS. 25 and 26), and specifically, may mean providing a method of modifying a data set into a form more suitable for deep learning model training. For example, the computing device may modify data by providing a method of making a distribution of a data set more uniform, but is not limited thereto.

For example, the computing device may modify the data set based on the property of the data set obtained by the above-described method.

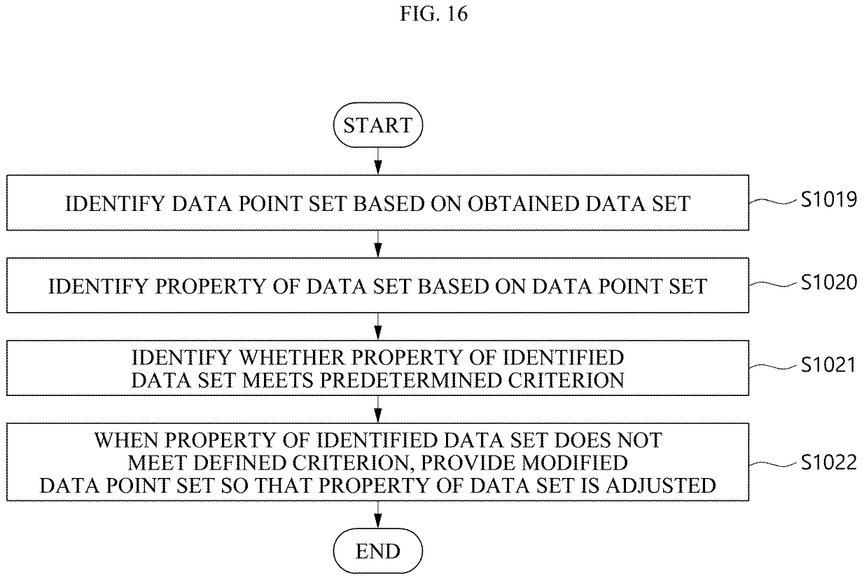

FIG. 16 is a diagram for describing a method of modifying, by a computing device, a data set according to various embodiments of the present disclosure.

Referring to FIG. 16, the computing device may identify the data point set based on the input data set (S1019). In this case, since all the above-described technical features (FIGS. 4 to 9) may be applied to a specific method of obtaining, by a computing device, a data set and identifying a data point set, a description thereof will be omitted.

In addition, the computing device may obtain the property of the data set based on the data point set (S1020). In this case, since all the above-described technical features (FIGS. 10 to 15) may be applied to a specific method of obtaining, by a computing device, a data point set, a description thereof will be omitted.

In addition, the computing device may identify whether the property of the identified data set meets a predetermined criterion (S1021). In this case, the predetermined criterion may be related to whether the data set needs to be modified. For example, the computing device may determine whether the distribution of the data set identified based on the data point set meets a predetermined criterion.

In addition, when the property of the identified data set does not meet the predetermined criterion, the computing device may provide the modified data point set so that the property of the data set is adjusted (S1022). For example, the computing device may adjust at least one data point included in the data point set, delete at least one data point, or add at least one data point to the data point set to provide the modified data point set, but is not limited thereto.

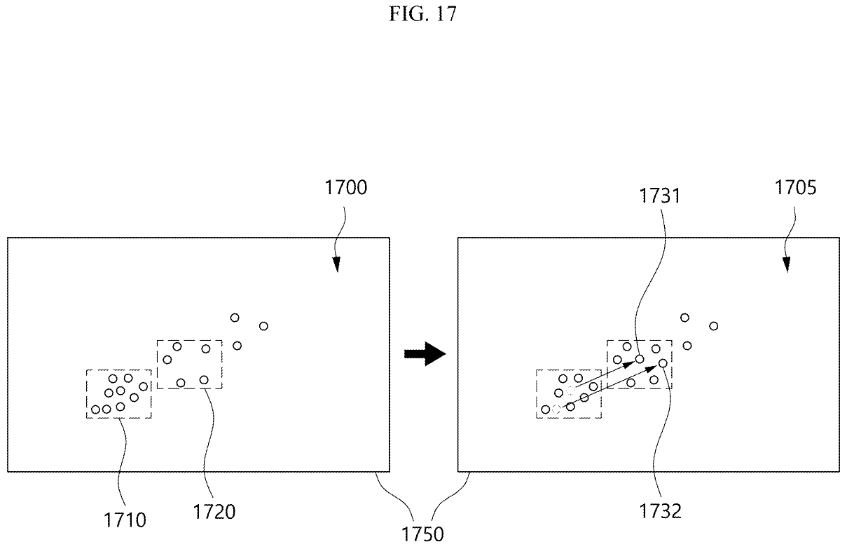

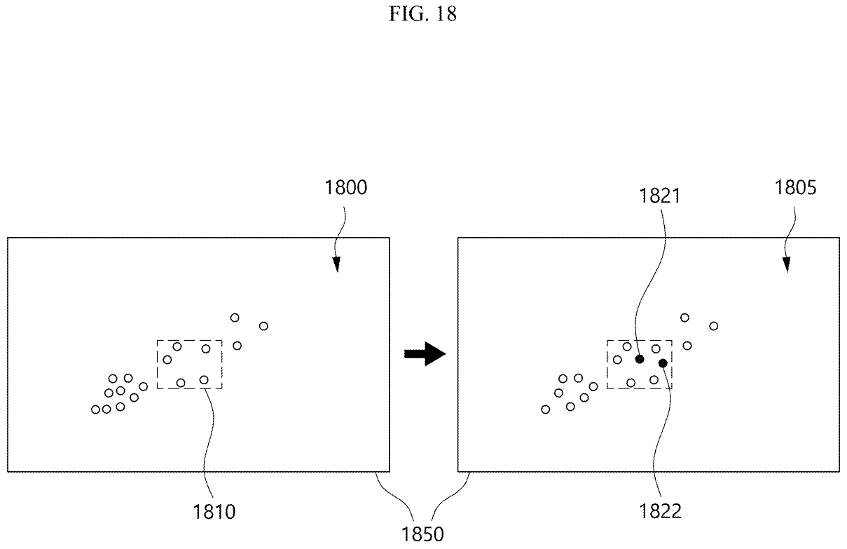

A specific example of providing, by the computing device, the modified data point set will be described in more detail with reference to FIGS. 17 and 18.

FIG. 17 is a diagram illustrating an example of generating, by a computing device, a modified data point set according to various embodiments of the present disclosure. A latent space 1750 of FIG. 17 is illustrated as a two-dimensional space for convenience of description, but may actually be a three-dimensional or more manifold space.

Referring to FIG. 17, the computing device may obtain a modified data point set 1705 by adjusting at least one data point included in the data point set 1700.

In this case, the computing device may determine whether the property of the data set identified based on the data point set 1700 meets a predetermined criterion. More specifically, the computing device may identify whether the property of the data set meets the predetermined criterion based on the data points included in two or more regions 1710 and 1720 in the latent space 1750 in which the data point set 1700 is defined. In this case, the sizes of the two or more regions 1710 and 1720 may both be the same, but are not limited thereto, and may be different from each other. In addition, the at least one region 1710 or 1720 may be arbitrarily selected, but is not limited thereto, and may be preset to a fixed position. In addition, the at least one region 1710 or 1720 may mean a region to which the filter or kernel of FIGS. 14 and 15 is applied.

For example, when the difference between the number of data points included in the first region 1710 in the latent space 1750 and the number of data points included in the second region 1720 in the latent space 1750 is greater than or equal to a predetermined criterion, the computing device may adjust at least one data point included in the data point set.

Specifically, when the difference between the number of data points included in the first region 1710 (e.g., 9) and the number of data points included in the second region 1720 (e.g., 5) is greater than or equal to a threshold value, the computing device may adjust at least one data point included in the data point set 1700 (e.g., a position in the latent space is adjusted).

In addition, for example, when the difference between the average value of the number of data points included in at least one region 1710 or 1720 in the latent space 1750 and the number of data points in a specific region is greater than or equal to a threshold value, the computing device may adjust at least one data point included in the data point set 1700.

In addition, the computing device may obtain the modified data point set 1705 by adjusting a position in the latent space 1750 of at least one data point included in the data point set 1700. For example, the computing device may obtain the modified data point set 1705 by adjusting a first data point 1731 and a second data point 1732 defined at positions in the first region 1710 to specific positions in the second region 1720.

In addition, the computing device may determine a position where the data point is to be adjusted in the latent space according to a predetermined criterion. More specifically, the computing device may determine positions where the first data point 1731 and the second data point 1732 are to be adjusted based on the distribution of the data point set 1700. For example, the computing device may determine positions where the first data point 1731 and the second data point 1732 are to be adjusted so that the points are uniformly positioned on the second region 1720. As a specific example, the computing device may move at least one of the first data point 1731 and the second data point 1732 to an intermediate position between at least two data points that are far apart from each other among the data points included in the second region 1720, but is not limited thereto.

In addition, the computing device may determine the number of data points to be adjusted in the data point set 1700 so that the distribution of the data point set 1700 is constant.

FIG. 18 is a diagram illustrating another example of generating, by a computing device, a modified data point set according to various embodiments of the present disclosure. A latent space 1850 of FIG. 18 is illustrated as a two-dimensional space for convenience of description, but may actually be a three-dimensional or more manifold space.

Referring to FIG. 18, the computing device may obtain a modified data point set 1805 by adding at least one data point to the data point set 1800.

In this case, all the technical features described in FIG. 17 may be applied to the predetermined criterion for the computing device to generate the modified data point set.

For example, the computing device may obtain the modified data point set 1805 by adding a data point to a third region 1810 in which the number of data points does not meet the predetermined criterion in the latent space 1850. Specifically, the computing device may obtain the modified data point set 1805 by adding a third data point 1821 and a fourth data point 1822 to arbitrary positions in the third region 1810.

In addition, the computing device may determine a position where the data point is to be added on the latent space according to the predetermined criterion. More specifically, the computing device may determine positions where the third data point 1821 and the fourth data point 1822 are to be added based on the distribution of the data point set 1800. For example, the computing device may determine positions where the third data point 1821 and the fourth data point 1822 are to be added so that the points are uniformly positioned on the third region 1810. As a specific example, the computing device may add at least one of the third data point 1821 and the fourth data point 1822 to an intermediate position between at least two data points that are far apart from each other among the data points included in the third region 1810, but is not limited thereto.

In addition, the computing device may determine the number of data points to be added in the data point set 1800 so that the distribution of the data point set 1800 is constant.

In addition, the present disclosure is not limited thereto, and the computing device may obtain the modified data point set by removing at least some of the data points included in the data point set. Specifically, the computing device may obtain a modified data point set by removing at least one data point determined in a predetermined manner among the data points included in the data point set based on the data set.

For example, the computing device may remove at least some of the data points included in a region where data is excessively concentrated in the data point set. Specifically, the computing device may select a region including a predetermined number or more of data points in a manifold region in which the data point set is defined, and remove at least one data point included in the selected region to obtain the modified data point set.

As described above, the computing device may add, adjust, or remove data points to correct the property of the data set determined based on the data point set (or manifold) in a direction suitable for training the deep learning model to modify the data set.

The computing device according to various embodiments of the present disclosure may perform the above-described data modification algorithm using the deep learning model. In the present specification, the deep learning model for performing the data modification algorithm is referred to as a “model for generating a modified manifold).”

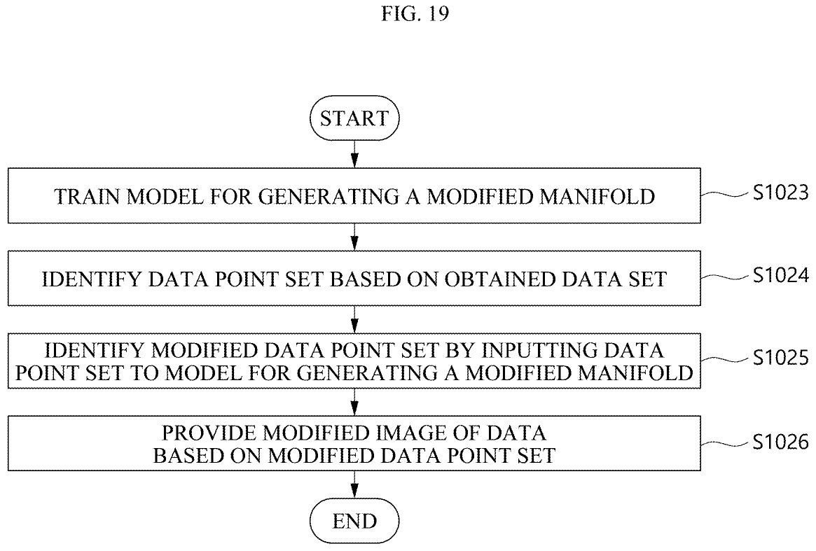

FIG. 19 is a diagram for describing a method of providing, by a computing device, a modified image of data by training a model for generating a modified manifold according to various embodiments of the present disclosure.

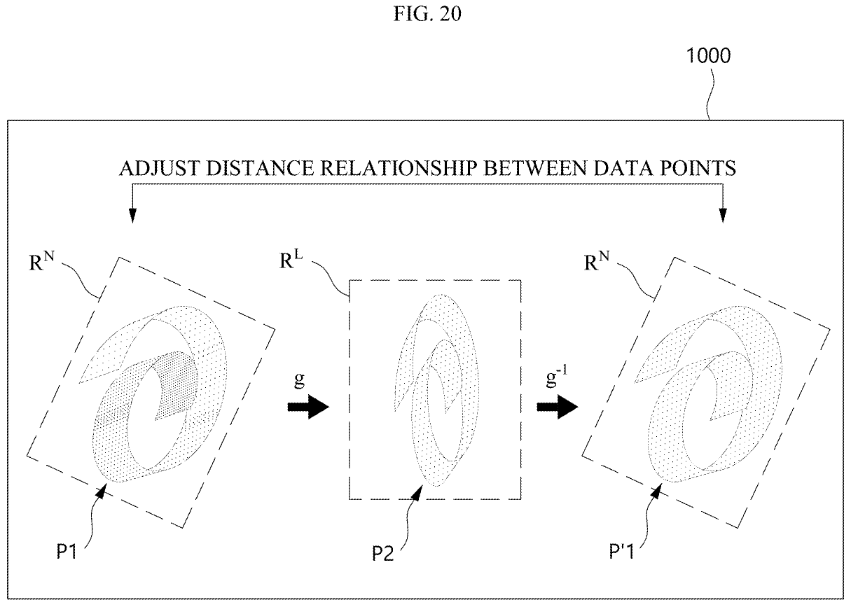

Referring to FIG. 19, the computing device may train a model for generating a modified manifold (S1023). A specific method of training a model for generating a modified manifold will be described in detail with reference to FIGS. 20 to 22.

In addition, the computing device may identify a data point set based on the obtained data set (S1024). In this case, since all the above-described technical features (FIGS. 4 to 9) may be applied to a specific method of obtaining, by a computing device, a data point set, a description thereof will be omitted.

In addition, the computing device may identify the modified data point set by inputting the data point set to the model for generating a modified manifold (S1025). Specifically, the computing device may obtain a modified data point set in which a distance relationship between data points included in the data point set is adjusted using the model for generating a modified manifold.

In addition, the computing device may provide a modified image of data based on the modified data point set (S1026). Since all the above-described technical features (FIGS. 4 to 9) may be applied to a specific method of providing, by the computing device, a modified image of data based on the modified data point set, a description thereof will be omitted.

FIG. 20 is a diagram illustrating an example of training, by a computing device, a model for generating a modified manifold according to various embodiments of the present disclosure.

The computing device 1000 may train a model for generating a modified manifold in order to provide a method of modifying the obtained data set into a form more suitable for the deep learning model.

Referring to FIG. 20, the computing device 1000 may identify the first data point set P1 defined in the N-dimensional first embedding space R^{N} based on the obtained data set. In this case, since all the above-described technical features (FIGS. 4 to 9) may be applied to a specific method of identifying the first data point set, a description thereof will be omitted. In this case, the first data point set P1 may be identified by defining an N-dimensional first manifold space.

In addition, the computing device 1000 may identify a second data point set P2 based on the first data point set P1. In this case, the second data point set P2 may be identified by defining an L-dimensional second manifold space. Specifically, the computing device 1000 may obtain the second data point set P2 by representing the first data point set P1 in an L-dimensional second embedding space R^{L}.

In addition, the computing device 1000 may obtain the second data point set P2 by processing the first data point set P1 according to a predetermined condition. Specifically, the computing device 1000 may obtain the second data point set P2 by mapping the first data point set P1 to the L-dimensional second embedding space R^{L} based on a predetermined condition (e.g., a matrix pre-stored for mapping to an embedding space of a specific dimension) defined by a mapping function g. For example, the computing device 1000 may obtain the second data point set P2 by encoding the first data point set P1, but is not limited thereto.

In addition, the computing device 1000 may obtain a modified first data point set P′1 based on the second data point set P2. In this case, the modified first data point set P′1 may be defined in the same N-dimensional first embedding space R^{N} as the first data point set P1.

In addition, the computing device 1000 may obtain the modified first data point set P′1 by processing the second data point set P2 according to a predetermined condition. Specifically, the computing device may obtain the modified first data point set P′1 by reconstructing the second data point set P2 on the N-dimensional first embedding space R^{N} based on a predetermined condition (e.g., an inverse matrix of a matrix pre-stored for mapping to an embedding space of a specific dimension) defined as an inverse function g⁻¹ of the mapping function g.

In addition, the computing device 1000 may obtain the modified first data point set P′1 so that a distance relationship between data points included in the first data point set P1 is adjusted. In other words, the computing device 1000 may train the model for generating a modified manifold so that the distance relationship between the data points included in the first data point set P1 is adjusted.

In addition, the computing device 1000 may adjust the distance relationship between the data points so that the distribution of the first data point set P1 is improved. More specifically, the computing device 1000 may adjust the distance relationship between the data points by moving data points positioned in a region with a high density of data points to a region with a low density of data points in the first data point set P1.

In addition, the computing device 1000 may train the model for generating a modified manifold based on a loss function defined based on distances of data points included in the first data point set P1. For example, the computing device 1000 may train the model for generating a modified manifold to extract at least a pair of data points whose distance relationship needs to be adjusted among the data points included in the first data point set P1. In addition, for example, the computing device 1000 may train the model for generating a modified manifold to add (or synthesize) data points to a region in which the distance relationship needs to be adjusted in the first data point set P1.

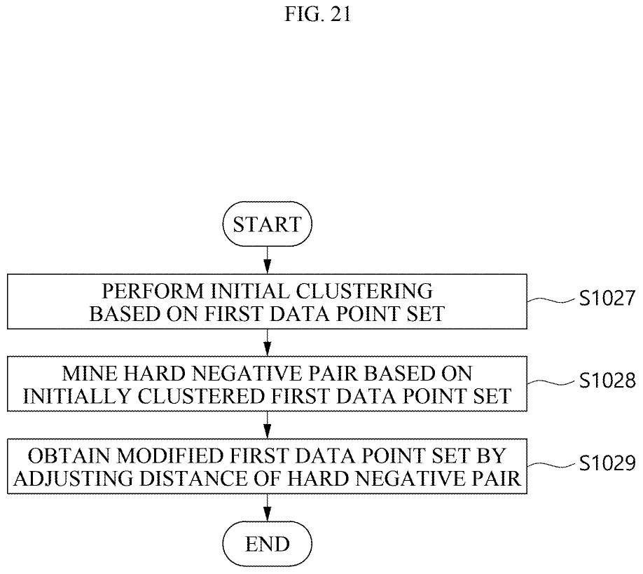

FIG. 21 is a flowchart for describing an example of a method of training, by a computing device, a model for generating a modified manifold according to various embodiments of the present disclosure.

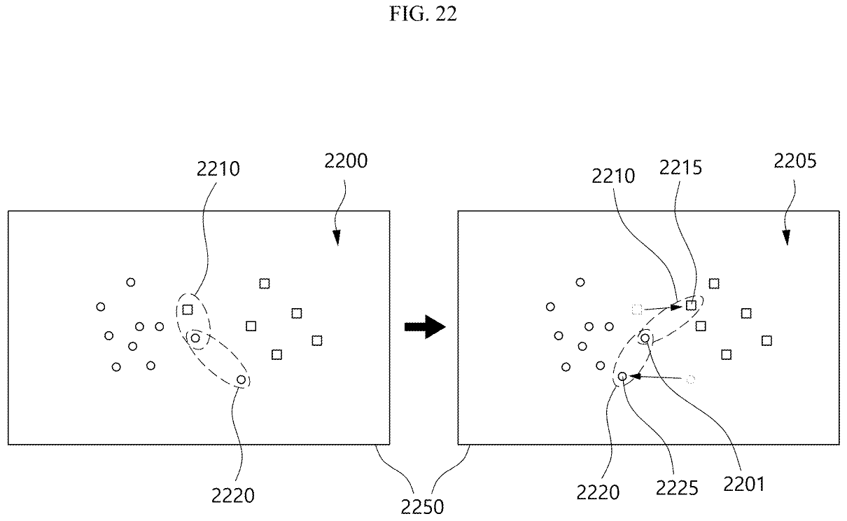

FIG. 22 is a diagram illustrating a method of training, by a computing device, a model for generating a modified manifold by mining a hard negative pair according to various embodiments of the present disclosure. A latent space 2250 of FIG. 22 is illustrated as a two-dimensional space for convenience of description, but may actually be a three-dimensional or more manifold space.

Referring to FIG. 21, the computing device may perform initial clustering based on the first data point set (S1027). In this case, the initial clustering means clustering a plurality of data points included in the first data point set into at least one group. Specifically, for the plurality of data points included in the first data point set, the computing device may cluster the plurality of data points into at least one group based on a similarity of data corresponding to the plurality of data points.

In addition, the computing device may perform initial clustering based on similarity information on the first data point set. In this case, in order to obtain the similarity information, the computing device may obtain the similarity information from the outside or generate the similarity information.

For example, the computing device may receive the similarity information on the first data point set from the outside. Specifically, the computing device may receive information on the similarity of two or more data points included in the first data point set from a user. That is, the user may input whether two or more data points in the first data point set identified by the computing device are similar. For example, the computing device may cluster the first data point set into at least one group based on annotation information on the data set received from the outside, but is not limited thereto.

As another example, the computing device may obtain the similarity information on the first data point set through unsupervised learning. Specifically, the computing device may cluster the first data point set into one or more groups by self-learning the similarity between the data points included in the first data point set. In addition, the similarity information on the first data point set may be identified based on property values of data points included in the first data point set. Specifically, the computing device may determine that the more similar the property values between the data points, the higher the similarity.

As a specific example, referring to FIG. 22, the computing device may perform initial clustering based on a first data point set 2200. Specifically, the computing device may cluster the first data point set 2200 into a first group including a first data point 2215 and a second group including a second data point 2225. In this case, the data points included in the same group may have similar characteristics (positive). In addition, the data points included in the first group and the data points included in the second group may have different characteristics (negative). For example, the data points included in the same group may be data on the latent space 2250 capable of deriving a similar result when performing a specific task, but is not limited thereto. In FIG. 22, the data points included in the first group are represented by a circular point and the data points included in the second group are represented by a square point, but this is only an exemplary representation, and the present disclosure is not intended to be limited to the representation in the drawings.

In the present disclosure, a pair of data points clustered in different groups is defined as a negative pair, and a pair of data points clustered in the same group is defined as a positive pair.

In addition, referring back to FIG. 21, the computing device may perform hard negative pair mining based on the initially clustered first data point set (S1028). Here, the hard negative pair means a negative pair that is difficult to distinguish from each other due to being close to each other among the above-described negative pairs.

Specifically, the computing device may mine the hard negative pair based on the distance relationship of the clustered first data point set.

For example, when there is a negative data point having a distance from a specific data point which is less than or equal to a threshold value among data points included in a group different from the specific data point, the computing device may determine the specific data point and the negative data point as a hard negative pair.

As another example, when a negative data point included in another group is positioned closer to the specific data point than a positive data point included in the same group, the computing device may determine the specific data point and the negative data point as a hard negative pair.

In addition, the computing device may mine a positive pair positioned far from each other in the latent space despite being in the same group.

For example, when there is a positive data point having a distance from a specific data point which is greater than or equal to a threshold value among data points included in the same group as the specific data point, the computing device may determine the specific data point and the positive data point as a positive pair.

As another example, when a negative data point included in another group is positioned closer to a specific data point than a positive data point included in the same group, the computing device may determine the specific data point and the positive data point as a positive pair.

As a specific example, referring back to FIG. 22, the computing device may mine the hard negative pair and the positive pair based on the similarity and distance relationship between the data points included in the first data point set 2200 defined in the latent space 2250.

Specifically, the computing device may identify the first data point 2215 that is included in a group different from a reference data point 2201 but satisfies the predetermined distance condition to mine the hard negative pair to determine the reference data point 2201 and the first data point 2215 as a hard negative pair 2210. In addition, the computing device may identify the second data point 2225 that is included in a group different from the reference data point 2201 but satisfies the predetermined distance condition to mine the positive pair, thereby determining the reference data point 2201 and the second data point 2225 as a positive pair 2220.

In addition, referring back to FIG. 21, the computing device may obtain a modified first data point set by adjusting the distance between the mined hard negative pairs (S1029). Specifically, the computing device may adjust the position in the latent space of at least one data point included in the first data point set so that the hard negative pair becomes an easy negative pair. In this case, the easy negative pair means a negative pair that is easy to distinguish from each other due to being far from each other among the above-described negative pairs.

In addition, the computing device may obtain the modified first data point set by adjusting a distance between the mined positive pairs. Specifically, the computing device may adjust a position in a latent space of at least one data point included in the first data point set so that the distance between the positive pairs is smaller than a predetermined distance.

As a specific example, referring back to FIG. 22, the computing device may adjust the position in the latent space 2250 of the first data point 2215 identified as the hard negative pair with respect to the reference data point 2201 to obtain the modified first data point set 2205.

In addition, the computing device may adjust the position in the latent space 2250 of the first data point 2215 identified as the positive pair with respect to the reference data point 2201 to obtain the modified first data point set 2205.

In addition, the present disclosure is not limited thereto, and operations S1028 and S1029 of FIG. 21 may be replaced with the following operation(s).

For example, the computing device may obtain the modified first data point set by adding at least one data point to the initially clustered first data point set. In this case, the computing device may adjust the distance relationship between the data points included in the first data point set by adding the at least one data point.

As a specific example, the computing device may determine a region of interest (ROI) that needs to adjust the distance relationship based on the initially clustered first data point set. In this case, the ROI may be a region including the above-described hard negative pair. In this case, the computing device may adjust a distance relationship between the ROI and data points positioned around the ROI by generating at least one data point in at least a portion of the ROI. For example, the computing device may generate at least one data point in the region between the hard negative pairs on the ROI including the hard negative pair to perform the adjustment so that the distance between the hard negative pairs increases.

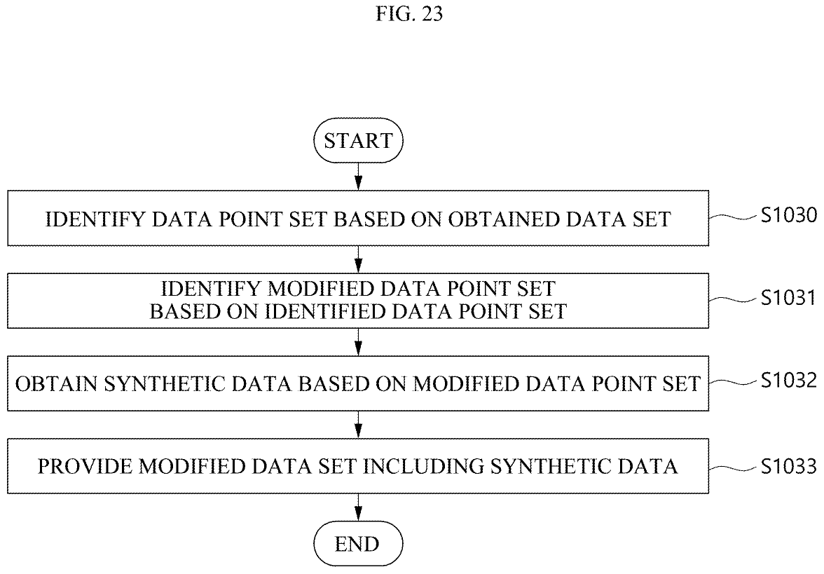

FIG. 23 is a diagram illustrating an operation of providing, by a computing device, a modified data set including synthetic data based on a data set according to various embodiments of the present disclosure.

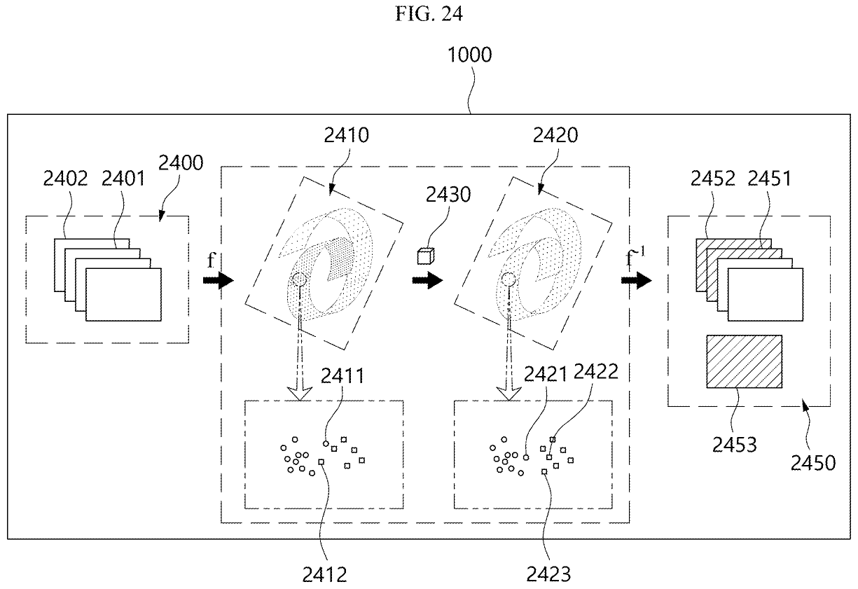

FIG. 24 is a diagram illustrating an example of an operation of providing, by a computing device, a modified data set including synthetic data based on a data set according to various embodiments of the present disclosure.

Referring to FIG. 23, the computing device may identify the data point set based on the obtained data set (S1030). In addition, the computing device may identify the modified data point set based on the identified data point set (S1031). In this case, since all the above-described technical features (FIGS. 16 to 22) may be applied to operations S1030 and S1031, a detailed description thereof will be omitted.

As a specific example, referring to FIG. 24, the computing device 1000 may identify a data point set 2410 based on the obtained data set 2400. In this case, the computing device 1000 may obtain the data point set 2410 by mapping the data set 2400 into a latent space based on a predetermined mapping function f. In this case, the data point set 2410 may include a first data point 2411 and a second data point 2412. For example, the first data point 2411 and the second data point 2412 may be data clustered into different groups, but is not limited thereto, and may be data that is not clustered or clustered into the same group.

In addition, the computing device 1000 may obtain a modified data point set 2420 based on the data point set 2410. In this case, the computing device may obtain the modified data point set 2420 by processing the data point set 2410 based on the pre-stored modification algorithm 2430. Specifically, the computing device 1000 may obtain the modified data point set 2420 by mapping the data point set 2410 to another latent space according to a predetermined condition and then reconstructing the data point set 2410 on the latent space again. In addition, the modified data point set 2420 may include a modified first data point 2421 and a modified second data point 2422. For example, the modified first data point 2421 may be obtained by adjusting a position in the latent space of the first data point 2411, and the modified second data point 2422 may be obtained by adjusting a position in the latent space of the second data point 2422. That is, the first data point 2411 may correspond to the modified first data point 2421, and the second data point 2412 may correspond to the modified second data point 2422. In addition, the modified data point set 2420 may further include third data point 2423. In this case, the third data point 2423 may be a data point that is not included in the data point set 2410. In other words, the computing device 1000 may generate an arbitrary third data point 2423 based on the modification algorithm 2430. That is, the data point set 2410 may not include a data point corresponding to the third data point 2423.

In addition, referring back to FIG. 23, the computing device may obtain synthetic data based on the modified data point set (S1032). In this case, the synthetic data may mean data arbitrarily generated by the computing device according to a predetermined algorithm. Specifically, the synthetic data is data having the same modality as the obtained data set, but may mean data not included in the data set. More specifically, the computing device may generate the synthetic data by processing the modified data point set based on a predetermined algorithm.

In addition, the computing device may provide the modified data set including the synthetic data (S1033). In this case, the modified data set may include at least one data point that is not included in the data set.

As a specific example, referring back to FIG. 24, the computing device 1000 may provide a modified data set 2450 based on the modified data point set 2420. In this case, the computing device 1000 may provide the modified data set 2450 including the at least one synthetic data point by generating at least one synthetic data point based on the modified data set 2450.

In addition, the computing device 1000 may reconstruct the modified data point set 2420 on an output domain using the inverse function f⁻¹ of a mapping function used to obtain the data point set 2410, thereby providing the modified data set 2450. In addition, the computing device 1000 may reconstruct the modified data point set 2420 on an output domain using the inverse function f⁻¹ of a mapping function used to obtain the data point set 2410, thereby providing the modified data set 2450.

In addition, each data point included in the modified data set 2450 may correspond to each data point included in the modified data point set 2420. For example, the computing device 1000 may obtain a first synthetic data point 2451 based on the modified first data point 2421, a second synthetic data based on the modified second data point 2422, and obtain a third synthetic data point 2453 based on the third data point 2423. That is, the first synthetic data point 2451 may correspond to the modified first data point 2421, the second synthetic data point 2452 may correspond to the modified second data point 2422, and the third synthetic data point 2453 may correspond to the third data point 2423.

In addition, the modified data set 2450 may include at least one data point that is not included in the data set 2400. In addition, the modified data set 2450 may not include at least one data point that is included in the data set 2400. In addition, the number of data points included in the modified data set 2450 may be greater than or equal to the number of data points included in the data set 2400.

As described above, the computing device may generate synthetic data in a neural rendering method based on data modification, but is not limited thereto.

The computing device according to various embodiments may generate synthetic data in a computer-graphics (CG)-based rendering method based on the data modification. Specifically, the computing device may generate synthetic data by generating CG parameters based on the generated modified data point set. More specifically, the computing device may generate synthetic data by obtaining a rendering parameter based on at least one data point included in the modified data point set. For example, the computing device may generate the synthetic data by implementing the inverse function f⁻¹ of the mapping function as a CG rendering model, but is not limited thereto.

FIG. 25 is a diagram illustrating an operation of providing, by a computing device, a quality of the obtained data set according to various embodiments of the present disclosure.

Referring to FIG. 25, the computing device may obtain a data set (S1034). In addition, the computing device may obtain an image of data based on the obtained data set (S1035). In this case, since all the above-described technical features (FIGS. 4 to 9) may be applied to operation S1035, a detailed description thereof will be omitted. In addition, the computing device may obtain the property of the data set based on the data point set (S1036). In this case, since all the above-described technical features (FIGS. 10 to 15) may be applied to operation S1036, a detailed description thereof will be omitted.

In addition, the computing device may provide a quality of a data set based on at least one of the image of data and a property of the data set (S1037). Specifically, the computing device may obtain at least one index based on at least one of the image of data and the property of the data set, and may provide the quality of the data set based on the at least one index. For example, the computing device may provide the quality of the data set based on an index including “appropriateness of distribution,” “suitability for training,” “similarity between data,” or “appropriateness of the number of data points” of the data set. In this case, the computing device may evaluate the at least one index with various grades, and may provide a final quality for the data set based on the scores assigned to each index.

For example, the computing device may evaluate the “appropriateness of distribution” based on the image of data or the property of the data set. In this case, the “appropriateness of distribution” may mean how uniformly the data set is distributed. More specifically, the computing device may evaluate the “appropriateness of the distribution” based on the uniformity of the data distribution appearing on the image of data or the density (or uniformity) of the data set included in the property of the data set. For example, when the distribution of data is uniform, the computing device may evaluate a grade of the “appropriateness of distribution” of the data set as “great,” but is not limited thereto.

As another example, the computing device may evaluate the “suitability for training” based on the image of data or the property of the data set. In this case, the “suitability for training” may mean how well the data set is suitable for training a specific deep learning model. More specifically, the computing device may evaluate the “suitability for training” based on the task-dependent property included in the property of the data set. For example, the computing device may evaluate whether the data set is suitable for training an image classification model by determining how uniformly the data set includes data corresponding to a class to be classified, but is not limited thereto.

As another example, the computing device may evaluate the “similarity between data” based on the image of data or the property of the data set. In this case, the “similarity between data” may mean how similar the data included in the data set is. More specifically, the computing device may evaluate the “similarity between data” based on the distance in the latent space between the data points included in the data set.

As another example, the computing device may evaluate the “appropriateness of the number of data points” based on the image of data or the property of the data set. More specifically, the computing device may evaluate whether the data set includes the appropriate number of data points for training a deep learning model.

FIG. 26 is a diagram illustrating an operation of providing, by a computing device, achievable quality of the obtained data set according to various embodiments of the present disclosure.

Referring to FIG. 26, the computing device may obtain a data set (S1038). In addition, the computing device may obtain the modified image of data based on the obtained data set (S1039). In this case, since all the above-described technical features (FIGS. 16 to 22) may be applied to operation S1039, a detailed description thereof will be omitted. In addition, optionally, the computing device may obtain the modified data set based on the data set (S1040). In this case, since all the above-described technical features (FIGS. 23 and 24) may be applied to operation S1040, a detailed description thereof will be omitted. In addition, the computing device may obtain the property of the modified data set based on the data set (S1041). In this case, since all the above-described technical features (FIGS. 10 to 15) may be applied to operation S1041, a detailed description thereof will be omitted. In addition, the computing device may provide the quality of the data set based on at least one of the image of data and a property of the data set (S1042). In this case, the method of providing the quality according to the above-described operation S1037 may be applied to the achievable quality of the data set provided by the computing device as it is when data is modified.

The computing device according to various embodiments of the present disclosure may provide a diagnostic report based on various pieces of information (e.g., an image of data, a property, a modified image of data, quality of a data set, etc.) related to the data set obtained by processing the data set. Specifically, the computing device may provide a comprehensive diagnostic result for the data set through the diagnostic report. In this case, the computing device may output the diagnostic report through an output device (e.g., a display) included in the computing device or an output device of a device capable of communicating with the computing device. For example, when the output device is a display, the computing device may output the diagnostic report on the display screen. In addition, for example, when the output device is a VR device, the computing device may output the diagnostic report to a virtual space transmitted by the VR device.

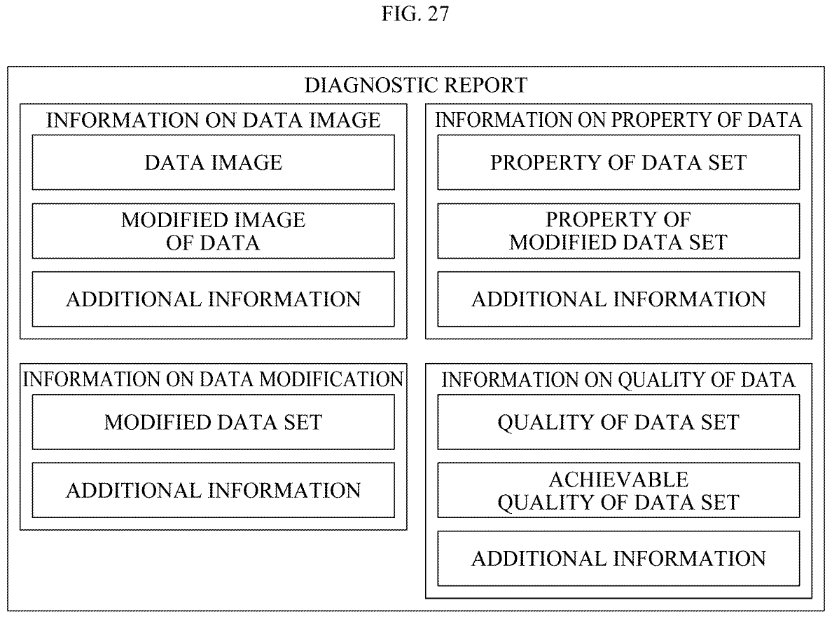

FIG. 27 is a diagram illustrating information included in a diagnostic report provided by a computing device according to various embodiments of the present disclosure.

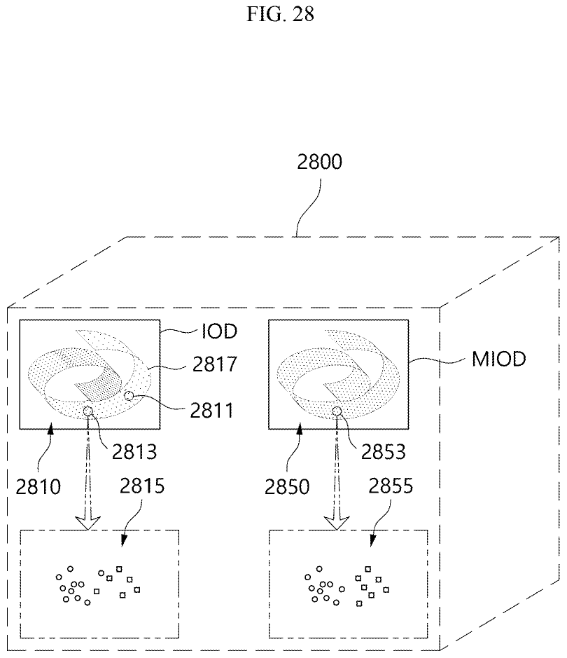

FIG. 28 is a diagram illustrating an example of information on an image of data provided by a computing device according to various embodiments of the present disclosure.

Referring to FIG. 27, the diagnostic report provided by the computing device may include various pieces of information on a data set. Specifically, the computing device may provide a diagnostic report including information on an image of data, information on a property of data, information on data modification, and information on a quality of data.

In this case, the information on the image of data may include an image of data for the data set and a modified image of data for the data set. In addition, the computing device may provide a diagnostic report further including additional information related to the image of data and the modified image of data.

As a specific example, referring to FIG. 28, the diagnostic report provided by the computing device may include information on an image of data including an image of data IOD or a modified image of data MIOD appearing in an imaging space 2800. In this case, the image of data IOD may include a data point set 2810 identified by finding a manifold in which the data point set is present. In this case, the computing device may provide the image of data IOD by removing noise of the data point set 2810 according to the description of FIG. 8. In addition, the modified image of data MIOD may include a modified data point set 2850 obtained by processing with the data point set modification algorithm. In this case, the computing device may provide the modified image of data MIOD by removing the noise of the modified data point set 2850 according to the description of FIG. 8.

In addition, the diagnostic report provided by the computing device may include additional information related to the image of data IOD or the modified image of data MIOD. More specifically, the computing device may process the data set to find a manifold in which the data set is present, thereby identifying the data point set and obtaining various pieces of additional information on the data set based on the data point set. In addition, the computing device may provide various pieces of additional information obtained as described above along with the image of data IOD or the modified image of data MIOD.

The computing device may provide marker information. In this case, the marker information may include a marker for a region specified according to a predetermined criterion in the image of data IOD or the modified image of data MIOD.

Specifically, the computing device may select a specific region satisfying the predetermined criterion from the image of data IOD or the modified image of data MIOD, and generate a marker in the region corresponding to the specific region. In this case, the computing device may select the specific region by identifying whether the property of the data set satisfies the predetermined criterion.

For example, the computing device may provide the marker information by generating a marker corresponding to a blank region in which there is no data in the image of data IOD or the modified image of data MIOD. As a specific example, the computing device may provide the marker information by generating a marker 2811 for the blank region of the data point set 2810 included in the image of data IOD.

As another example, the computing device may provide the marker information by generating a marker corresponding to a dense region in which data is concentrated in the image of data IOD or the modified image of data MIOD.

As another example, the computing device may provide the marker information by generating a marker corresponding to a unique region in which a distribution of data is unique in the image of data IOD or the modified image of data MIOD.

In this case, the computing device may determine a region in which a marker is to be generated in the data point set 2810 or the modified data point set 2850 based on a predetermined algorithm. For example, the computing device may obtain a feature map for locations where data points are present through a convolution operation based on a pre-stored kernel (see the description of FIG. 15), and a blank region, a dense region, or a unique region may be determined based on the feature map.

In addition, the computing device may provide the marker information by generating at least one marker based on an input received from the outside. Specifically, when the computing device receives a marker generation input for a specific region on the image of data IOD or modified image of data MIOD, the computing device may generate a marker in the specific region.

In addition, when the computing device receives an input for selecting at least one marker from the outside, the computing device may provide enlarged image information represented by enlarging a distribution of data points in a region corresponding to the at least one marker on the image of data IOD or the modified image of data MIOD. For example, when the computing device receives an input for selecting a first marker 2813 from a user, the computing device may provide a first enlarged image 2815 by enlarging a distribution of data points in the region corresponding to the first marker 2813, but is not limited thereto.

In addition, according to an embodiment, when the computing device receives an input for selecting at least one marker generated in the modified image of data MIOD from the outside, the computing device may provide not only enlarged image information represented by enlarging a distribution of data points in a region corresponding to the at least one marker on the modified image of data MIOD, but also enlarged image information represented by enlarging the distribution of data points in the same region as the region corresponding to the at least one marker on the image of data IOD. For example, when the computing device receives an input for selecting a second marker 2853 from the user, the computing device may provide a second enlarged image 2855 in which the distribution of data points in the region corresponding to the second marker 2853 is enlarged and a first enlarged image 2815 of the same region (for example, the region in which the first marker 2813 is displayed) as the region in the image of data IOD.

In addition, the computing device may provide manifold boundary information 2817 by displaying a manifold boundary of the image of data IOD or the modified image of data MIOD. Specifically, the computing device may provide the manifold boundary information 2817 by displaying a boundary region of a manifold in which the data point set 2810 identified based on the data set is formed.

In addition, the computing device may provide grouping information (not illustrated) to a manifold boundary of the image of data IOD or the modified image of data MIOD. Specifically, when the data points included in the data point set 2810 or the modified data point set 2850 are clustered into one or more groups, the computing device may add an indication representing the clustered data points to provide the grouping information.

In addition, the computing device may add a visual effect to the image of data IOD or the modified image of data MIOD. Specifically, in order to enhance the visual effect of the image of data IOD or the modified image of data MIOD, the computing device may represent data points included in the data point set 2810 or the modified data point set 2850 using a predetermined color or shape. For example, the computing device may represent the color of the data points included in the region in which data points are concentrated to represent the density of the data set differently from a color of other data points, but is not limited thereto. In addition, for example, the computing device may represent data points clustered into different groups using different shapes, but is not limited thereto.

In addition, the computing device may provide comparison information (not illustrated) representing a difference between the image of data IOD or the modified image of data MIOD. Specifically, the computing device may display a different part in the modified image of data MIOD compared to the existing image of data IOD by modifying the data set. For example, as the computing device generates a modified data point set 2850 based on the data point set 2810, the computing device may display a region in which the distribution of data points is changed on the modified data point set 2850 based on the data point set 2810, but is not limited thereto.

Referring back to FIG. 27, the computing device may provide a diagnostic report including information on a property of data. In this case, the information on the property of data may include, but is not limited to, the property of the obtained data set and the property of the modified data set, and may further include obtainable additional information based on the property of the data set and the property of the modified data set.

In addition, the computing device may provide a diagnostic report including information on data modification. In this case, the information on data modification may include, but is not limited to, a modified data set, and may further include obtainable additional information based on the modified data set. For example, the information on the data modification may include synthetic data generated based on the modified data points included in the modified data set. In addition, for example, the information on the data modification may include sample information obtained by extracting some of the synthetic data points.

In addition, the computing device may provide a diagnostic report including information on the quality of data. In this case, the information on the quality of data may include, but is not limited to, the quality of the obtained data set and the achievable quality of the data set, and may further include obtainable additional information based on the quality of the data set and the achievable quality of the data set.

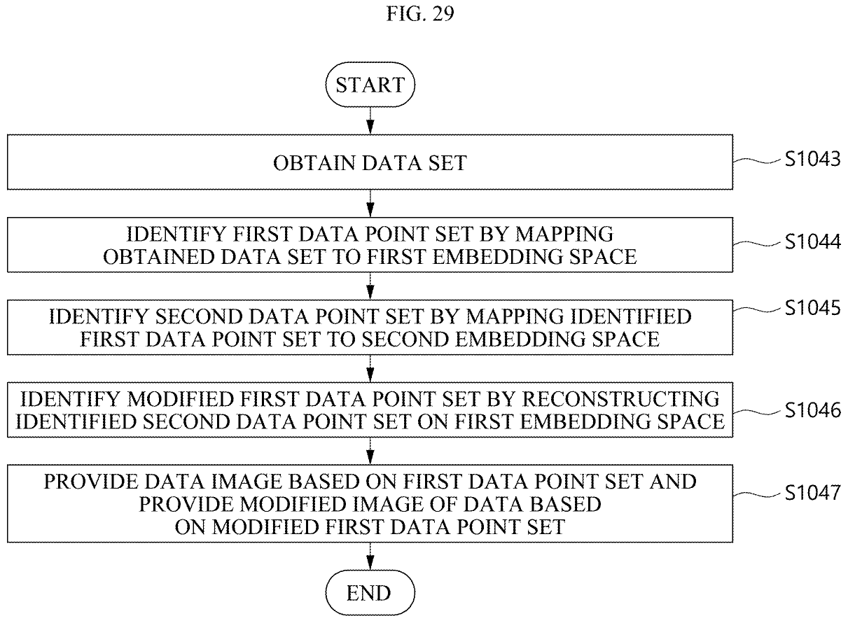

FIG. 29 is a diagram for describing an operation of providing, by a computing device, an image of data and a modified image of data of a data set according to various embodiments of the present disclosure.

Referring to FIG. 29, the computing device may obtain a data set (S1043). In addition, the computing device may identify a first data point set by mapping the obtained data set to a first embedding space (S1044). In this case, since all the above-described technical features (FIGS. 4 to 9) may be applied to operations S1043 and S1044, a detailed description thereof will be omitted.

In addition, the computing device may identify a second data point set by mapping the identified first data point set to a second embedding space (S1045). In addition, the computing device may identify the modified first data point set by reconstructing the identified second data point set on the first embedding space (S1046). In this case, since all the above-described technical features (FIGS. 16 to 22) may be applied to operations S1045 and S1046, a detailed description thereof will be omitted.

In addition, the computing device may provide an image of data based on the first data point set and provide a modified image of data based on the modified first data point set (S1047). In this case, since all the above-described technical features (FIGS. 4 to 9) may be applied to a specific method of providing, by a computing device, an image of data based on the first data point set, a detailed description thereof will be omitted. In addition, in operation S1047, the computing device may represent the modified image of data in the same imaging space as the image of data. In addition, the present disclosure is not limited thereto, and the computing device may represent the modified image of data in an imaging space different from that of the image of data.

Alternatively or additionally, the computing device may obtain the property of the data set based on the first data point set, and the modified property of the data set based on the modified first data point set. In this case, since all the above-described technical features (FIGS. 10 to 15) may be applied to a specific method of obtaining the property of the data set, a description thereof will be omitted.

Alternatively or additionally, the computing device may provide a modified data set including synthetic data by reconstructing the modified data point set on an output domain. In this case, since all the above-described technical features (FIGS. 23 and 24) may be applied to a specific method of providing the modified data set, a description thereof will be omitted.

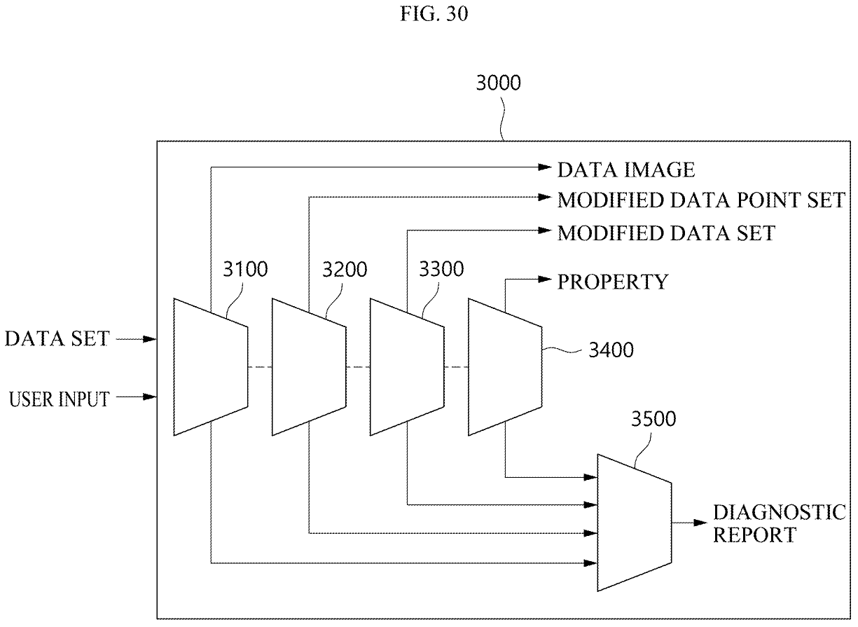

FIG. 30 is a diagram illustrating algorithm performance models constituting a computing device according to various embodiments of the present disclosure.

Referring to FIG. 30, a computing device 3000 may include a plurality of algorithm performance models having different purposes. Specifically, the computing device 3000 may include a plurality of algorithm performance models designed to output a specific output. For example, the computing device may include an imaging model 3100 designed to provide an image of data, a modified model 3200 designed to provide a modified data point set, a generation model 3300 designed to generate a modified data set including synthetic data, a property mining model 3400 designed to calculate a property of data, and a diagnostic model 3500 designed to provide a diagnostic report, but is not limited thereto. Of course, a plurality of algorithm performance models may be implemented as one integrated model.

In addition, the computing device may selectively output the output data by selectively inputting input data to at least some of the plurality of algorithm performance models. In this case, the computing device may make a determination based on which models to process the data set based on a user input which is input along with the data set. For example, when the computing device obtains a data set along with a user input for outputting an image of data, the computing device may output the image of data by inputting the data set into the imaging model 3100.

In addition, output data of a specific model among the plurality of algorithm models may be used as input data of another model. For example, when the computing device obtains a data set along with a user input to generate synthetic data, the computing device may obtain a modified data point set obtained by inputting the data set into the modified model 3200 and provide the modified data point set including the synthetic data by inputting the modified data point set to the generation model 3300.

In addition, when the computing device obtains a data set along with a user input to generate the modified image of data, the computing device may obtain modified data point set obtained by inputting the data set into the modified model 3200 and provide the modified image of data by inputting the modified data point set to the imaging model 3100.

In addition, for example, when the computing device obtains the data set along with the user input to generate the diagnostic report, the computing device may provide the diagnostic report by inputting an image of data obtained based on the data set, a modified image of data, a modified data point set, a property of a data set, and an modified property of the data set to the diagnostic model 3500.

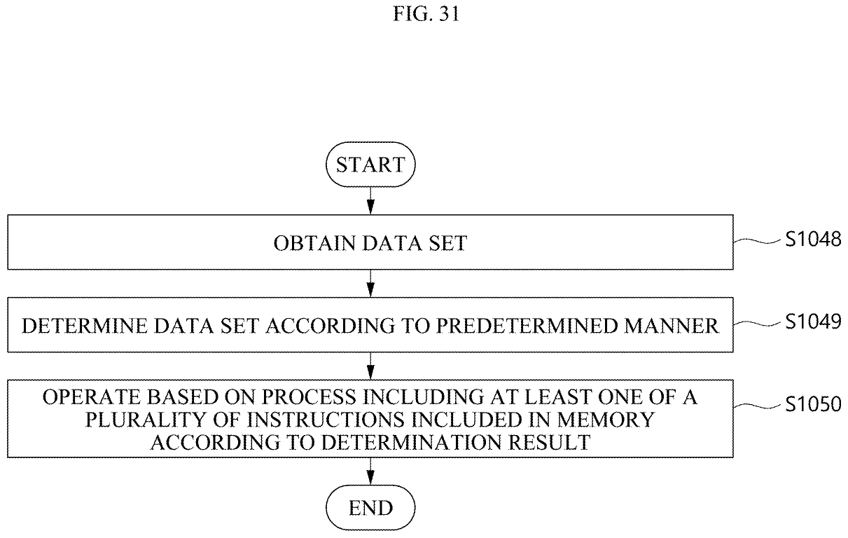

FIG. 31 is a diagram illustrating a method of selectively performing, by at least one processor included in a computing device, an operation based on a data set according to various embodiments of the present disclosure.

Referring to FIG. 31, the at least one processor may obtain a data set (S1048). In addition, at least one processor may determine the data set according to a predetermined method (S1049). For example, the at least one processor may determine the capacity, the application domain, the modality, the type, the number of modalities, or the like of the data set.

In addition, the at least one processor may determine the data set based on a pre-stored algorithm. In addition, at least one processor may determine the data set by searching for data similar to the obtained data set in a pre-stored database.

In addition, the at least one processor may perform an operation based on at least one of a plurality of instructions stored in the memory of the computing device according to the determination result (S1050).

Specifically, the at least one processor may perform a process indicated by at least one instruction determined based on an identified trigger as a result of determining the data set. In this case, the trigger may be an event that triggers the operation of the at least one processor, and the process performed by the at least one processor may be determined according to the type of the trigger. More specifically, the trigger may be an event instructing to provide specific output data, but is not limited thereto.

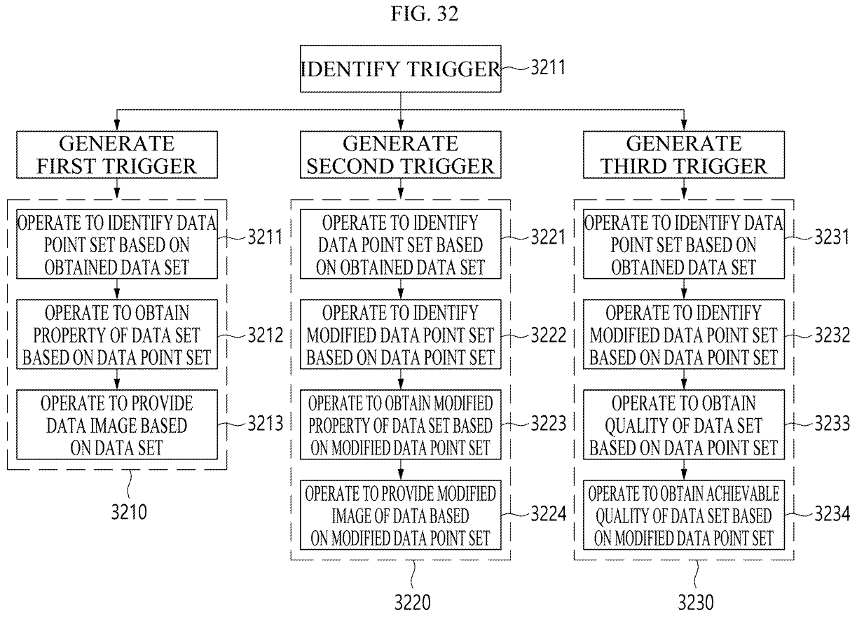

A specific example will be described with reference to FIG. 32.

FIG. 32 is a diagram illustrating various processes performed by at least one processor according to instructions stored in a memory of a computing device according to various embodiments of the present disclosure.

Referring to FIG. 32, when the trigger is identified, at least one processor of the computing device may operate based on one of a plurality of processes (data processing pipeline) according to the trigger.

Specifically, when a first trigger occurs, at least one processor may operate based on a first process 3210. In this case, the at least one processor may operate based on at least some of a plurality of instructions included in the first process 3210.

For example, when the first trigger instructs to provide an image of data, the at least one processor may operate based on an instruction 3211 instructing the at least one processor to perform an operation of identifying a data point set based on the obtained data set; and an instruction 3213 instructing the at least one processor to perform an operation of providing an image of data based on the data set. Of course, an operation may be further performed based on an instruction 3212 instructing the at least one processor to perform an operation of obtaining a property of a data set based on the data point set.

In addition, for example, when the first trigger instructs to provide a property of a data set, the at least one processor may operate based on the instruction 3211 instructing the at least one processor to perform an operation of identifying a data point set based on the data set obtained by the at least one processor and the instruction 3212 instructing the at least one processor to perform an operation of obtaining a property of a data set based on the data point set.

In addition, the computing device may pre-store the information on the first trigger connected to the first process 3210. Specifically, the first trigger may include a result of receiving a user input instructing to provide an image of data and determining a data set. In addition, the first trigger may occur immediately after the data set is input. In other words, the first trigger instructing to provide the image of data may be a basic trigger that occurs simultaneously with obtaining the data set, but is not limited thereto.

In addition, when a second trigger occurs, at least one processor may operate based on a second process 3220. In this case, the at least one processor may operate based on at least some of a plurality of instructions included in the second process 3220.

For example, when the second trigger instructs to provide the modified data point set, the at least one processor may operate based on an instruction 3221 instructing the at least one processor to perform an operation of identifying a data point set based on the data set obtained by the at least one processor and an instruction 3222 instructing the at least one processor to perform an operation of identifying a modified data point set based on the data point set.

In addition, for example, when the second trigger instructs to provide the modified property of the data set, the at least one processor may operate based on an instruction 3221 instructing the at least one processor to perform an operation of identifying the data point set based on the data set obtained by the at least one processor, an instruction 3222 instructing the at least one processor to perform an operation of identifying the modified data point set based on the data point set, and an instruction 3223 instructing the at least one processor to perform an operation of obtaining the modified property of the data set based on the modified data point set.

In addition, for example, when the second trigger instructs to provide the modified image of data of the data set, the at least one processor may operate based on the instruction 3221 instructing the at least one processor to perform an operation of identifying the data point set based on the data set obtained by the at least one processor, the instruction 3222 instructing the at least one processor to perform an operation of identifying the modified data point set based on the data point set, and an instruction 3224 instructing the at least one processor to perform an operation of providing the modified image of data based on the modified data point set.

In addition, the computing device may pre-store the information on the second trigger connected to the second process 3220. Specifically, the second trigger may include a result of receiving a user input instructing to provide the modified image of data and determining a data set.

In addition, when a third trigger occurs, at least one processor may operate based on a third process 3230. In this case, the at least one processor may operate based on at least some of a plurality of instructions included in the third process 3230.

For example, when the third trigger instructs to provide a quality of a data set, the at least one processor may operate based on an instruction 3231 instructing the at least one processor to perform an operation of identifying a data point set based on the data set obtained by the at least one processor and an instruction 3233 instructing the at least one processor to perform an operation of obtaining the quality of a data set based on the data point set.

In addition, for example, when the third trigger instructs to provide the achievable quality of the data set, the at least one processor may operate based on an instruction 3231 instructing the at least one processor to perform an operation of identifying the data point set based on the data set obtained by the at least one processor, an instruction 3232 instructing the at least one processor to perform an operation of identifying the modified data point set based on the data point set, and an instruction 3234 instructing the at least one processor to perform an operation of obtaining the achievable quality of the data set based on the modified data point set.

In addition, the computing device may pre-store the information on the third trigger connected to the third process 3230. Specifically, the third trigger may include a result of a determination on the data set and reception of a user input instructing to provide the achievable quality of the data set.

The selective operation of the at least one processor is not limited to the process illustrated in FIG. 32, and the operation of the processor may be selectively performed according to a trigger generated based on an output that can be output by the computing device according to various embodiments of the present disclosure. For example, when a fourth trigger (not illustrated) instructs to provide a diagnostic report, the at least one processor may operate based on at least one instruction instructing to obtain pieces of information necessary for generating the diagnostic report.

In addition, the computing device according to various embodiments may configure a preset database by databaseizing a plurality of processes configured with a plurality of instructions as described above. Specifically, the computing device may store the above-described method (e.g., data imaging, property mining, modification, evaluation, etc.), input data and output data accompanying the method, and furthermore, may store a method (for example, a dimension determination method, an optimized shape determination method, etc.) of generating a manifold accompanying the method, etc. to configure the preset database.

In addition, when the data set is input, the computing device may select at least one of a plurality of processes stored in the preset database and process the data set based on the selected process.

Also, the computing device may reconfigure the preset database. More specifically, the computing device may perform an iterative optimization process to generate a more optimized output, rather than generating a final output by processing the input data set according to the initially determined process, and thus, may reconfigure the preset database based on the optimized processes. For example, the computing device may reconfigure the preset database based on a machine learning method, but is not limited thereto.

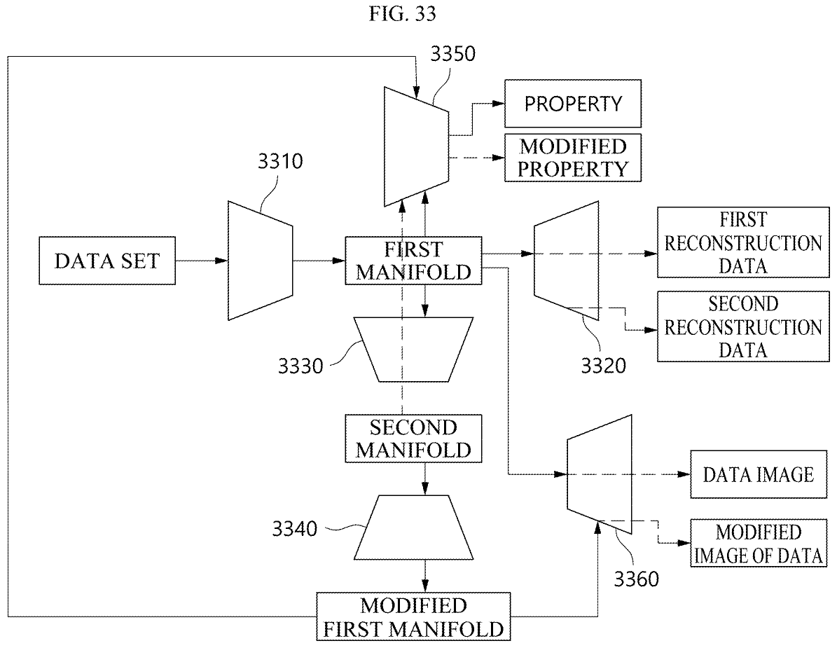

FIG. 33 is a diagram illustrating an implementation example of a computing device according to various embodiments of the present disclosure.

Referring to FIG. 33, the computing device may include various configurations for outputting various pieces of output data based on a data set defined on an input domain.

Specifically, the computing device may include a first converter 3310 designed to generate a first manifold based on the obtained data set. In this case, the first manifold may be defined on the first embedding space. In addition, the first converter 3310 may convert the data set into the first manifold based on a first predetermined function. In addition, the computing device may include a second converter 3330 designed to generate a second manifold based on the first manifold. In this case, the second manifold may be defined in a second embedding space having a different dimension from the first embedding space. In addition, the second converter 3330 may convert the first manifold into the second manifold based on a second predetermined function. For example, the first converter 3310 and the second converter 3330 may include an encoder, but is not limited thereto.

In addition, the computing device may include a first reconstructor 3320 designed to generate first reconstruction data based on the first manifold. In this case, the first reconstruction data may be defined on an output domain having the same dimension as the input domain. Also, the first reconstructor 3320 may reconstruct the first manifold to the first reconstruction data based on an inverse function of the first predetermined function. In addition, the computing device may include a second reconstructor 3340 designed to generate a modified first manifold based on the second manifold. In this case, the modified first manifold may be defined in a third embedding space having the same dimension as the first embedding space. Also, the second reconstructor 3340 may reconstruct the second manifold to the modified first manifold based on an inverse function of the second predetermined function.

In addition, the computing device may include a property miner 3350 designed to generate the property of the data set based on the first manifold and generate the modified property of the data set based on the second manifold or the modified first manifold. In this case, the property of the data set or the modified property of the data set may be provided in the form of a feature map. In addition, the property miner 3350 may be provided in the form of a feed-forward neural network.

Also, the computing device may include an imaging device 3360 designed to generate an image of data based on the first manifold and generate a modified image of data based on the modified first manifold. In this case, the image of data and the modified image of data may appear on a predetermined imaging space. Also, the imaging device 3360 may represent the first manifold and the modified first manifold as the image of data and the modified image of data, respectively, based on a predetermined data visualization algorithm.

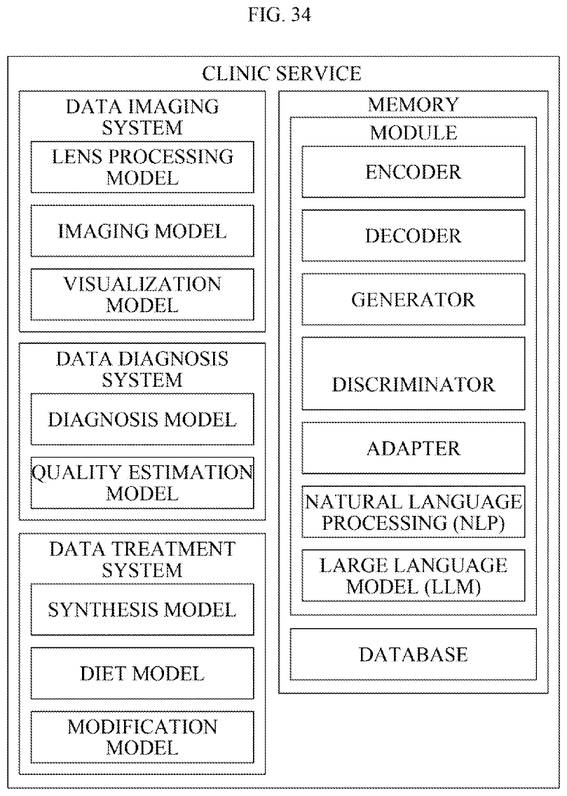

FIG. 34 is a diagram illustrating various systems for providing data clinic services and artificial intelligence models and algorithms for building systems, according to various embodiments. Here, the system may mean a system including at least one software configuration or a hardware configuration to perform a specific function.

The computing device according to the present disclosure may provide a data clinic service based on various artificial intelligence (ex. machine learning, deep learning etc.) frameworks performed by at least one processor and a memory electronically connected to at least one processor.

In this regard, there are various types of machine learning (artificial intelligence) frameworks that can be trained to perform a given task. The support vector machine, the decision tree, the neural network, and the like are merely some examples of machine learning frameworks used in various applications such as image processing and natural language processing. Some artificial intelligence frameworks such as neural networks use layers of nodes performing a specific operation.

In a neural network, nodes are connected to each other through one or more edges. The neural network may include an input layer, an output layer, and one or more hidden (intermediate) layers. The individual node may process each input according to a predefined function and provide an output to a subsequent layer or a previous layer in some cases. The input for a specific node may be multiplied by a weight corresponding to an edge between the input and the node. In addition, the node may have an individual bias value used to generate an output. Various learning procedures may be applied to learn the edge weight and/or the bias value (parameter).

The neural network structure may have several layers that perform different specific functions. For example, one or more node layers may collectively perform a specific operation such as a pooling operation, an encoding operation, or a convolution operation. In the present disclosure, the term “layer” may refer to a node group that shares input and output, such as exchanging with another layer of an external source or a network. The term “calculation” may refer to a function that can be performed at one or more node layers. The term “model structure” may refer to an overall architecture of a model layered including the number of layers, connectivity of the layers, and types of tasks performed by individual layers. The term “neural network structure” may refer to a model structure of a neural network. The term “trained model” and/or “tuned model” may refer to a model structure together with parameters for a trained or tuned model structure. For example, two models that are trained on different training data or a trained model may have different values for parameters while sharing the same model structure, such as when there is a basic probabilistic process in a training process.

“Transfer learning” is one extensive approach for training a model with trained data for each task that is limited for a specific task. In transfer learning, a model is first pretrained on a different task for which significant training data is available, and then the model can be tuned to a specific task using task-specific training data.

As used in this disclosure, the term “pre-training” refers to training a model on a set of pre-training data to adjust model parameters in a manner that allows subsequent tuning of those model parameters to tune the model for one or more specific tasks. In some cases, the pre-learning may include a self-supervised learning process with unlabeled training data, and the ‘self-supervised’ learning process includes learning in a structure of a pre-learning example when there is no explicit (e.g., manually provided) label. Subsequent modification of the model parameter obtained through the pre-learning is referred to as “tuning” herein. The tuning may be performed on one or more tasks using supervised learning in the explicitly labeled training data, and in some cases, a task different from the pre-learning may be used for the tuning.

Referring to FIG. 34, a computing device according to the present disclosure may include a data clinic system configured with various (artificial intelligence) models to provide a clinic service.

For example, the computing device may comprise, but is not limited to, a data imaging system, a data diagnosis system, a data treatment system, and the like.

Here, the data imaging system may include, but is not limited to, a lens processing model for determining optimal dimensions for representing properties of the data, an imaging model for obtaining an image of the data that reflects intrinsic properties of the data, or a visualization model for visually representing data.

The data diagnosis system may include, but is not limited to, a diagnosis model for diagnosing at least one property of data, a quality estimation model for evaluating quality of data, and the like.

The data treatment system may include, but is not limited to, a synthesis model (or a generative model) for generating targeted synthetic data, a diet model for removing at least a portion of data, a modification model for adjusting properties of at least a portion of data, and the like.

The names of the various systems (“data imaging system”, “data diagnosis system”, or “data treatment system”) that comprise the Clinic Service and the names of the various models (“lens processing model”, “imaging model”, “visualization model”, diagnosis model”, “quality estimation model”, “synthesis model”, “diet model”, or “modification model”) that comprise each system are not intended to limit the function of the systems or models as terms themselves.

Various models (ex. neural network) included in the computing device may be configured by a plurality of modules stored in a memory. In the present disclosure, a module may be used as a term indicating a configuration of a functional unit constituting a machine learning model. For example, the module may include, but is not limited to, an encoder, a decoder, a generator, a discriminator, an adapter, a natural language processing module, a large language model (LLM), and the like.

The computing device may store the plurality of modules described above and may construct a artificial intelligence framework based on at least a portion of the plurality of modules to obtain an artificial intelligence model for data clinic. For example, a data lens included in the data imaging system may be implemented as a artificial intelligence model including at least one encoder or at least one adapter, but is not limited thereto.

In addition, the computing device may obtain a database for storing various data obtained based on the data clinic system.

[Improving quality of Imaging—Data Lens Processing]

In order to obtain a high-quality image of data, a data lens (or an imaging device, an imaging manifold generation model, an encoder, and the like) designed to preserve intrinsic properties (or characteristics) of data is required. For example, the computing device may determine an optimal dimension of an embedding space for maintaining a distribution of an input data set and may obtain an image of data by representing (e.g., projection, mapping, dimension reduction, and the like) the data set based on the corresponding dimension.

Therefore, a data lens processing (or designing) method for improving quality of data imaging is proposed below.

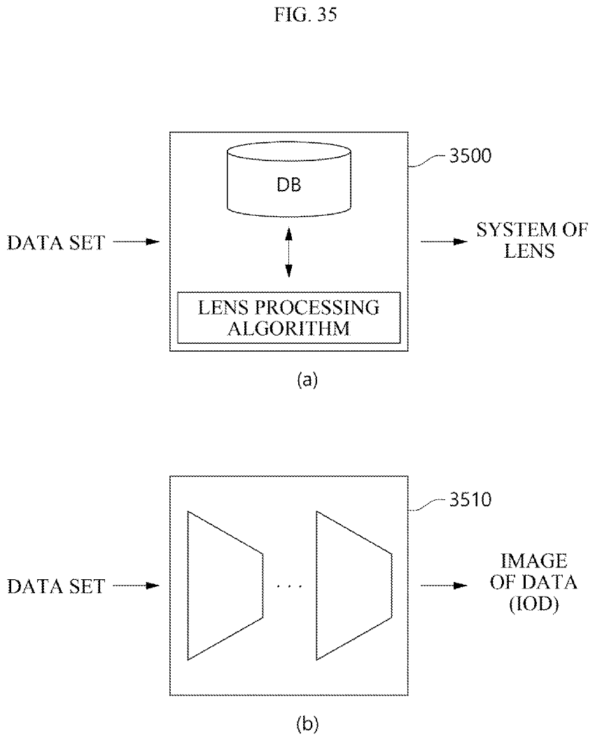

FIG. 35 is a diagram illustrating a data lens processing system and a data imaging system, according to various embodiments.

Referring to FIG. 35(a), the computing device may obtain a data lens system based on the data set. In this case, the data lens system may be a term indicating at least one configuration for mapping the data set to a specific embedding space. For example, the data lens system may include at least one encoder for mapping the data set to an embedding space (or latent space) of a specific dimension and/or at least one adapter for adjusting a parameter. In addition, for example, the data lens system may include a neural network layer including at least one node for identifying a latent variable or a latent feature vector corresponding to the data set.

The computing device 3500 may determine a data lens system for processing the data set to preserve intrinsic properties of the data set based on the data set.

For example, the computing device may obtain a lens system corresponding to the data set based on the database. Specifically, the computing device may retrieve a lens system corresponding to the data set from a database based on properties (or characteristics) of the input data set.

As another example, the computing device may obtain a lens system corresponding to the data set based on a lens processing algorithm. Specifically, the computing device may calculate an optimal dimensionality of preserving the intrinsic properties of the input data set.

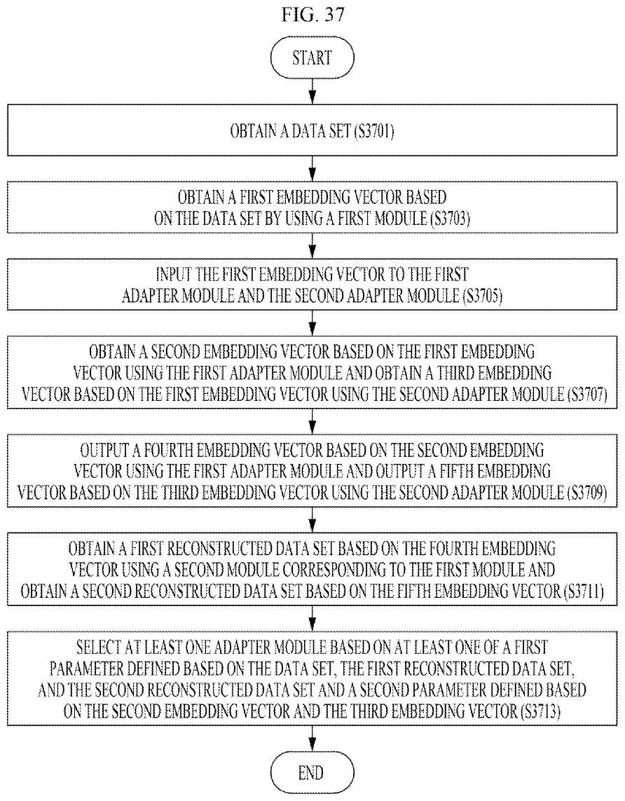

Details of the lens processing algorithm will be described with reference to FIG. 37.

Referring to FIG. 35(b), the computing device may process a dataset based on data imaging system 3510 including the determined data lens system to obtain an image of data (IOD). In this case, the imaging system 3510 may include a lens system configured with at least one module (e.g., an encoder, an adapter, or the like).

In this case, the computing device may obtain an image of data indicating the intrinsic properties of the data set by using the imaging system 3510.

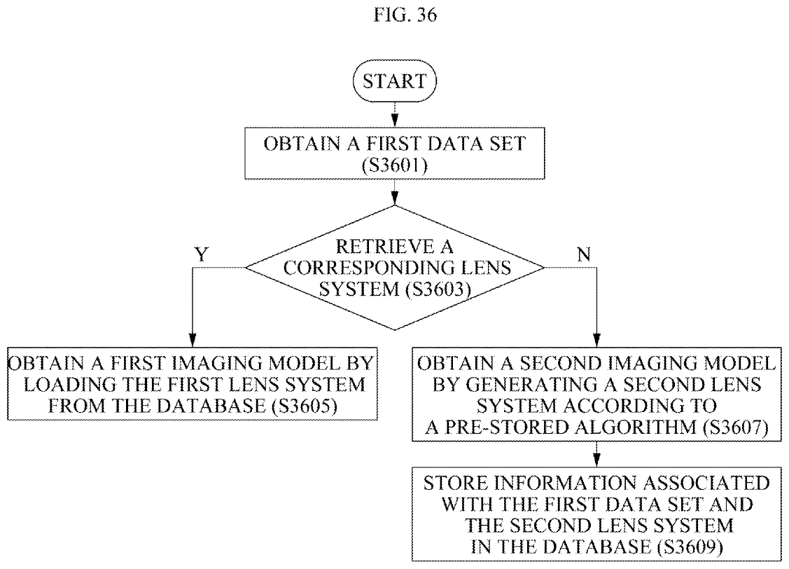

FIG. 36 is a flowchart illustrating a method that a computing device obtains a lens system based on a data set, according to various embodiments.

Referring to FIG. 36, the computing device may obtain a first data set S3601. In this case, the first data set may include a training data set for training an artificial intelligence model but is not limited thereto.

In addition, the computing device may retrieve a lens system corresponding to the first data set based on a database S3603.

If a lens system corresponding to the first dataset is found, the computing device may obtain a first imaging model by loading the first lens system from the database S3605.

If a lens system corresponding to the first data set is not found, the computing device may obtain a second imaging model by generating a second lens system according to a pre-stored algorithm S3607.

In addition, in this case, the computing device may store information associated with the first data set and the second lens system in the database S3609.

Accordingly, when a second data set similar to the first data set is input, the computing device may construct a second imaging model for obtaining an image of data reflecting the intrinsic properties of the second data set based on the second lens system pre-stored in the database.

The computing device according to an embodiment of the disclosure may include a lens processing algorithm for determining a lens property most suitable for imaging the data set and a lens processing model in which the algorithm is implemented.

For example, a computing device may design a data lens system by selecting at least one of a plurality of encoders, each based on a different dimensionality, to determine the optimal dimensionality to represent a data set.

FIG. 37 is a flowchart illustrating an example of a lens processing algorithm performed by a computing device, according to various embodiments.

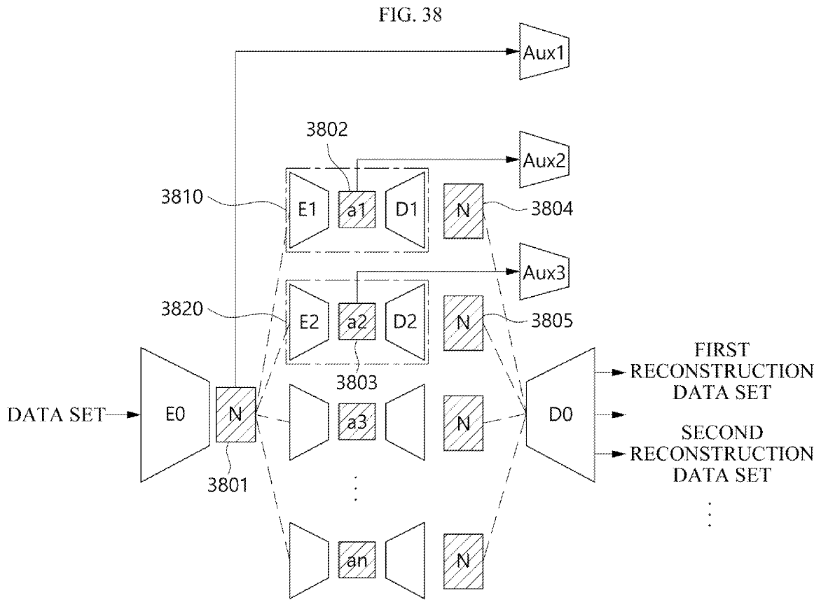

FIG. 38 is a diagram illustrating an example of a lens processing model built by a computing device to perform a lens processing algorithm, according to various embodiments.

Referring to FIG. 37, the computing device may obtain a data set S3701.

In addition, the computing device may obtain a first embedding vector based on the data set by using a first module S3703. In this case, the first module may be an encoder (or a plurality of encoders). In addition, the first embedding vector may include a data point set appearing in an embedding space of a specific dimension. Alternatively, the first embedding vector may include set of instances of a specific dimension. For example, the first embedding vector may be a feature vector of 512 dimensions but is not limited thereto.

For example, referring to FIG. 38, the computing device may input the obtained data set to the first encoder E0. In addition, the first encoder E0 may be implemented to output the first embedding vector 3801 based on the input data set. In this case, the first embedding vector 3801 may have an N dimension (e.g., 512). The first encoder E0 may include a plurality of neural network layers implemented to reduce dimensionality of the data set into N-dimensional embedding.

Referring back to FIG. 37, the computing device may input the first embedding vector to the first adapter module and the second adapter module (S3705). In this case, the adapter module may be a configuration for adjusting a parameter of the encoder. Specifically, the computing device may adjust a parameter of the artificial intelligence model by being implemented to connect the adapter module to the encoder.

In addition, in this case, the first adapter module and the second adapter module may be connected in parallel. Specifically, the computing device (or the lens processing model included in the computing device) may be implemented such that data output from the first module is input to the first adapter module and the second adapter module, respectively.

In addition, the computing device (or the lens processing model) may be implemented to include three or more adapter modules. Specifically, the computing device (or the lens processing model) may be implemented such that data output from the first module is input to three or more adapter modules, respectively.

For example, referring to FIG. 38, the computing device may input the first embedding vector 3801 to the set of adapter modules including the first adapter module 3810 and the second adapter module 3820, respectively. In this case, the adapter module may be implemented to include at least one encoding layer and at least one decoding layer. Specifically, the first adapter module 3810 may include the first encoding layer E1 and the first decoding layer D1 corresponding to the first encoding layer, but is not limited thereto.

Referring back to FIG. 37, the computing device may obtain a second embedding vector based on the first embedding vector using the first adapter module and obtain a third embedding vector based on the first embedding vector using the second adapter module (S3707). In this case, the computing device may be implemented to simultaneously perform operations by the first adapter module and operations by the second adapter module. The computing device may be implemented to perform parallel operations based on the same input to a plurality of adapter modules.

For example, referring to FIG. 38, the first adapter module 3810 may process the first embedding vector 3801 using the first encoding layer E1 to identify the second embedding vector 3802. In this case, the second embedding vector 3802 may be implemented to be output to a hidden layer of the first adapter module 3801. In addition, the second adapter module 3820 may process the first embedding vector 3801 using the second encoding layer E2 to identify the third embedding vector 3803. In this case, the third embedding vector 3803 may be implemented to be output to a hidden layer of the second adapter module 3801.

In addition, the second embedding vector 3802 and the third embedding vector 3803 may have different dimensions. For example, the second embedding vector 3802 may have an a1 dimension and the third embedding vector 3803 may have an a2 dimension, and in this case, a1 may be smaller than a2. In addition, the dimension N of the first embedding vector 3801 may be greater than the dimension a1 of the second embedding vector 3802 and the dimension a2 of the third embedding vector 3803.

The computing device may configure the plurality of adapter modules so that the dimensions of the output embedding vector are gradually increased. The computing device may process a data lens for imaging a data set by selecting at least one of the plurality of adapter modules outputting the embedding vectors of different dimensions.

Referring back to FIG. 37, the computing device may output a fourth embedding vector based on the second embedding vector using the first adapter module and output a fifth embedding vector based on the third embedding vector using the second adapter module (S3709). Specifically, the computing device may obtain the fourth embedding vector by reconstructing the second embedding vector using the first adapter module and obtain the fifth embedding vector by reconstructing the third embedding vector using the second adapter module.

For example, referring to FIG. 38, the first adapter module 3810 may identify the fourth embedding vector 3804 based on the second embedding vector 3802 using the first decoding layer D1. In this case, the fourth embedding vector 3804 may be implemented to be output to an output layer of the first adapter module 2810. In addition, the second adapter module 3820 may identify the fifth embedding vector 3805 based on the third embedding vector 3803 using the second decoding layer D2. In this case, the fifth embedding vector 3805 may be implemented to be output to an output layer of the second adapter module 3820.

In addition, in this case, the fourth embedding vector 3804 and the fifth embedding vector may have the same dimension. In addition, the fourth embedding vector, the fifth embedding vector, and the first embedding vector may have the same dimension N. This is because the adapter module is configured to include an encoding layer and a decoding layer paired with the encoding layer.

Referring back to FIG. 37, the computing device may obtain a first reconstructed data set based on the fourth embedding vector using a second module corresponding to the first module and obtain a second reconstructed data set based on the fifth embedding vector (S3711). In this case, the second module may be a decoder (or a plurality of decoders). Alternatively, the second module may be a generator. And the reconstructed data set may be generated to have similar characteristics to the input dataset.

For example, referring to FIG. 38, the computing device may input the fourth embedding vector 3804 and the fifth embedding vector 3805 to the first decoder D0 corresponding to the first encoder E0. In this case, the first decoder D0 may be implemented to output the first reconstructed data set based on the fourth embedding vector 3804 and output the second reconstructed data set based on the fifth embedding vector 3805.

Referring back to FIG. 37, the computing device may select at least one adapter module based on at least one of a first parameter defined based on the data set, the first reconstructed data set, and the second reconstructed data set and a second parameter defined based on the second embedding vector and the third embedding vector (S3713).

Specifically, the computing device may select the at least one adapter module based on parameters defined based on at least one of a distribution of embedding vectors and a similarity between data and may build an imaging model based on the selected adapter module.

For example, the computing device may determine a property (characteristic) associated with at least one dimensionality that optimizes the at least one parameter and may select an adapter module corresponding to the determined property (characteristic).

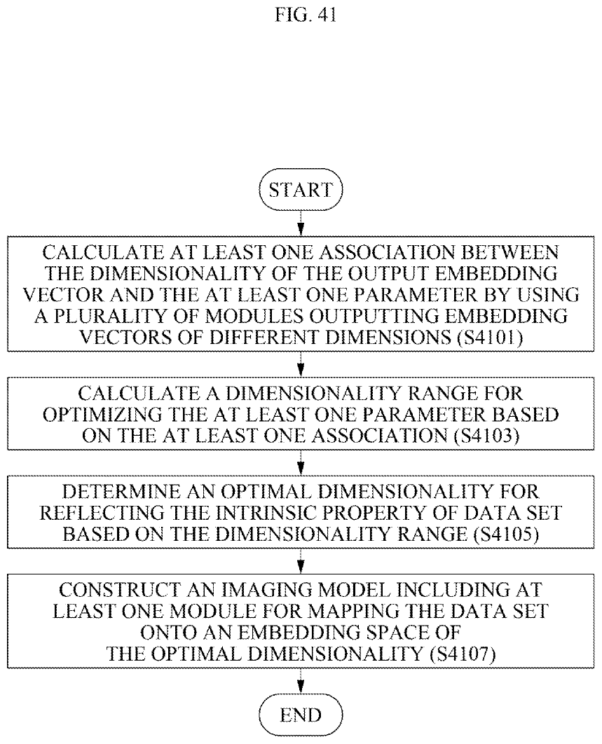

A specific method of optimizing the dimension of an image of data by the computing device will be described with reference to FIG. 41.

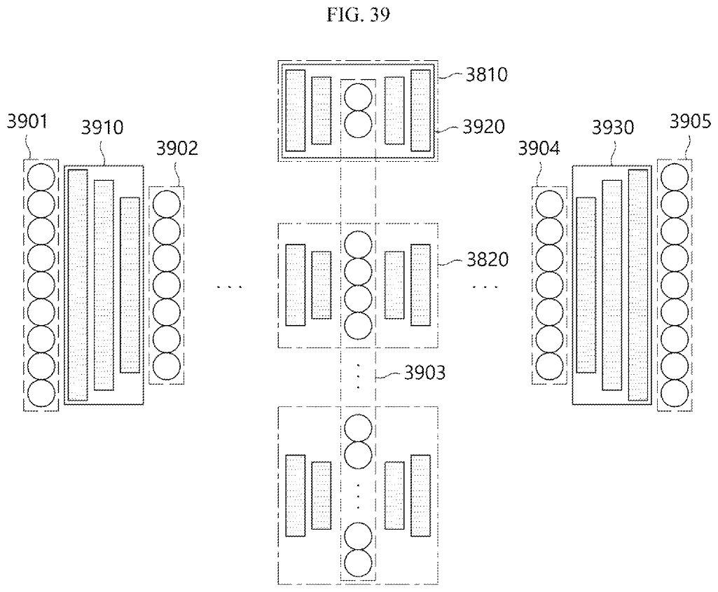

FIG. 39 is a diagram illustrating an example of a neural network structure of a lens processing system included in a computing device, according to various embodiments.

Referring to FIG. 39, the lens processing model included in the computing device may include an artificial neural network structured in a plurality of layers.

The computing device may include at least one neural network for obtaining a data image. Specifically, the computing device may include a sub-imaging neural network 3910 for outputting a sub image of data based on the input data, and at least one main imaging neural network 3920 for outputting a main image of data based on the sub image of data.

For example, the computing device may obtain a first data point set defined in an embedding space of N dimensions based on the input data set using the sub-imaging neural network 3910. Also, for example, the computing device may obtain a main image of data (or a second data point set) defined in an embedding space of M dimension (herein, M>N) based on the N-dimensional sub image of data (or the first data point set) using the main imaging neural network 3920. In this case, the main imaging neural network 3920 may include an encoding neural network, a latent space, and a decoding neural network. The main imaging neural network 3920 may output, through the decoding neural network, a reconstructed image of data having characteristics similar to a sub image of data.

In this case, the computing device may build a lens system based on at least one of the plurality of main imaging neural networks. For example, the computing device may be implemented to obtain a lens system including the main imaging neural network based on the algorithm described in FIG. 37.

In addition, the computing device may include a reconstruction neural network 3930 paired with the sub-imaging neural network 3910. The reconstructed neural network 3930 may output a reconstructed data set based on the reconstructed image of data.

In addition, the lens processing model may include a plurality of layers.

Specifically, the lens processing model may be configured as a neural network model including a plurality of layers including a plurality of nodes. For example, the lens processing model may include an input layer 3901 through which a data set is input, a first latent (hidden) layer 3902 for identifying a sub image of data, a second latent layer 3903 for identifying a main image of data, a third latent layer 3904 for identifying data obtained by reconstructing the main image of data in N dimensions, and an output layer 3905 for outputting the reconstructed data.

In this case, the first latent layer 3903 may be implemented as an input layer of the main imaging neural network 3920, but is not limited thereto. The second latent layer 3903 may be implemented as a hidden layer of the main imaging neural network 3920, but is not limited thereto. Also, the third latent layer 3903 may be implemented as an output layer of the main imaging neural network 3920, but is not limited thereto.

In order to determine the main imaging neural network among a plurality of main imaging neural network candidates, the dimension of the embedding space that best reflects the intrinsic properties (characteristics) of the input data set must be determined. The contents thereof will be described in detail with reference to FIG. 41.

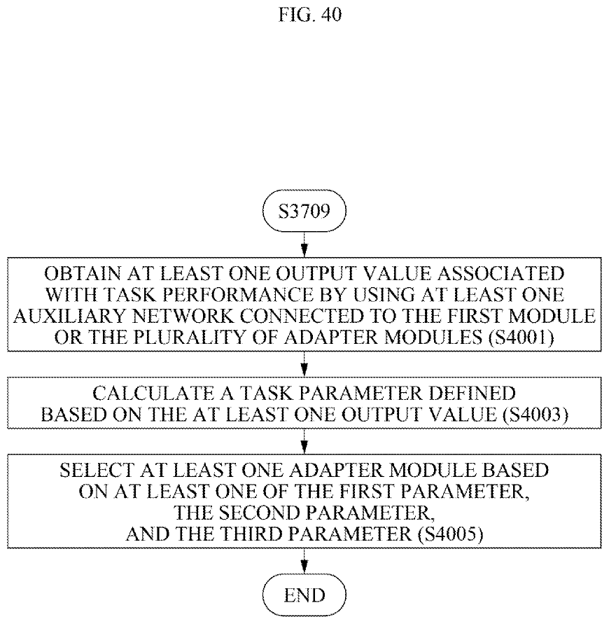

FIG. 40 is a diagram illustrating a method that a computing device enhances a lens processing model using an auxiliary network, according to various embodiments.

Referring to FIG. 40, after the operation S3709 of FIG. 37, the computing device may obtain at least one output value associated with task performance by using at least one auxiliary network connected to the first module or the plurality of adapter modules (S4001). In this case, the auxiliary network may be an artificial intelligence model for performing a task using an input data set. For example, the auxiliary network may be a classification model including a Fully Connected layer (FC) and a Softmax layer but is not limited thereto.

Further, the computing device may calculate a task parameter defined based on the at least one output value (S4003). In addition, the computing device may select at least one adapter module based on at least one of the first parameter, the second parameter, and the third parameter (S4005).

For example, referring to FIG. 38, the computing device may include a first auxiliary network Aux1 connected to a latent layer of the first module EO in which the first embedding vector 3801 represents.

In this case, the computing device may input the first embedding vector 3801 to the first auxiliary network Aux1 to perform a task (e.g., classification) to obtain an output value indicating a result of performing the task.

In this case, the computing device may calculate a task parameter for optimizing the output value. For example, the computing device may optimize the output value by minimizing (or maximizing) a task parameter indicating a task performance capability of the first auxiliary network Aux1.

In this case, the computing device may select at least one adapter module based on at least one of a first parameter defined based on the data set, the first reconstructed data set, and the second reconstructed data set, a second parameter defined based on the second embedding vector and the third embedding vector, or a task parameter.

As another example, referring to FIG. 38, the computing device may include a plurality of auxiliary networks connected to each of the plurality of adapter modules. Specifically, the computing device may include, but is not limited to, a second auxiliary network Aux2 connected to the latent layer of the first adapter module El where the second embedding vector 3802 represents and a third auxiliary network Aux3 connected to the latent layer of the second adapter module E2 where the third embedding vector 3803 represents.

In this case, the computing device may input the second embedding vector 3802 to the second auxiliary network Aux2 to perform a task, thereby obtaining a first output value indicating a result of performing the task. In addition, the computing device may input the third embedding vector 3803 to the third auxiliary network Aux3 to perform a task, thereby obtaining a second output value indicating a result of performing the task.

In this case, the computing device may calculate a task parameter for optimizing the plurality of output values (the first output value and the second output value). Specifically, the computing device may define a task parameter based on the sum of the plurality of output values.

In this case, the computing device may select at least one adapter module based on at least one of a first parameter defined based on the data set, the first reconstructed data set, and the second reconstructed data set, a second parameter defined based on the second embedding vector and the third embedding vector, or a task parameter.

According to an embodiment of the present disclosure, the computing device may build an imaging model to train parameters for task performance capability of the input learning data set and may obtain a task-based image of data through the built imaging model.

The computing device according to an embodiment of the present disclosure may calculate an optimal dimension reflecting an intrinsic property (characteristic) of the data set based on the association between the at least one parameter and the dimensionality in which an image of data is defined.

FIG. 41 is a diagram illustrating a method for determining a property associated with a dimensionality for a computing device to optimize a parameter, according to various embodiments.

Referring to FIG. 41, the computing device may calculate at least one association between the dimensionality of the output embedding vector and the at least one parameter by using a plurality of modules outputting embedding vectors of different dimensions (S4101). For example, the computing device may calculate at least one of a first association of a similarity parameter (e.g., mean squared error or reconstruction error) according to the dimension, a second association of a distribution parameter (e.g., KL divergence) according to the dimension, or a third association relationship of a task parameter (e.g., binary cross-entropy or categorical cross-entropy) according to the dimension.

In addition, the computing device may calculate a dimensionality range for optimizing the at least one parameter based on the at least one association (S4103).

In addition, the computing device may determine an optimal dimensionality for reflecting the intrinsic property (characteristic) of data set based on the dimensionality range (S4105).

In addition, the computing device may build an imaging model including at least one module for mapping the data set onto an embedding space of the optimal dimensionality (S4107).

The computing device according to an embodiment of the present disclosure may significantly reduce a time for determining the optimal dimensionality to indicate the data set by implementing the above-described parallel calculation algorithm, and may increase a learning efficiency of an artificial intelligence model including a plurality of modules. Accordingly, the calculation cost of at least one processor included in the computing device may be reduced.

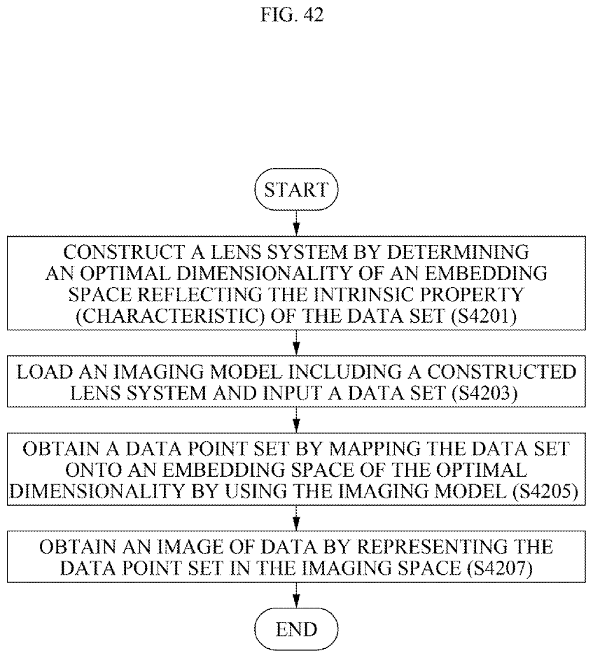

FIG. 42 is a flowchart illustrating a method for a computing device to acquire an image of data reflecting intrinsic property of a data set, according to various embodiments.

Referring to FIG. 42, the computing device may build (or construct) a lens system by determining an optimal dimensionality of an embedding space reflecting the intrinsic property (characteristic) of the data set (S4201). The detailed algorithm for building the lens system by the computing device has been described above, and thus will be omitted.

In addition, the computing device may load an imaging model including a constructed lens system and input a data set (S4203).

In addition, the computing device may obtain a data point set by mapping the data set onto an embedding space of the optimal dimensionality by using the imaging model (S4205). In this case, the data point set may form a manifold indicating the data set, and may include a plurality of data points (or instances) corresponding to each piece of data included in the data set.

In addition, the computing device may obtain an image of data by representing the data point set in the imaging space (S4207). In this case, the image of data may be the same as the data point set, but is not limited thereto. For example, the computing device may acquire the image of data by visualizing the data point set onto the imaging space by using a visualization model. As a specific example, the computing device may obtain a image of data by visualizing the N-dimensional data point set in a three-dimensional space, but is not limited thereto.

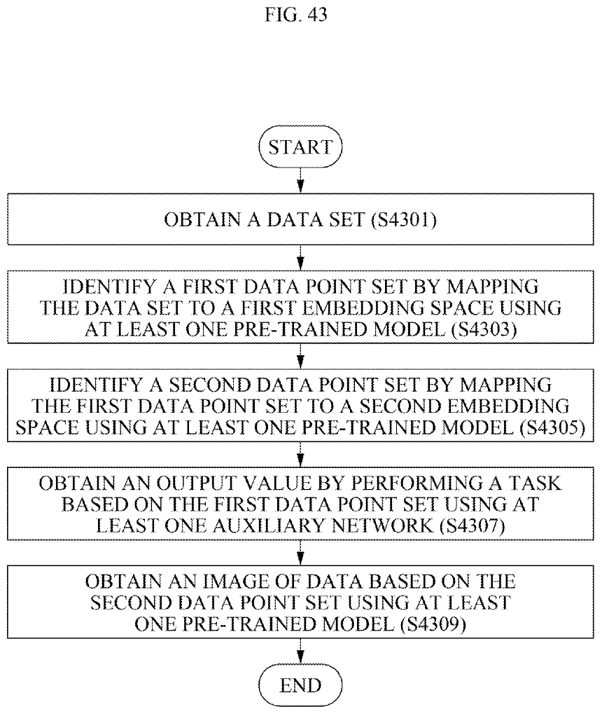

FIG. 43 is a diagram illustrating a method for a computing device to obtain an image of data set and determine a task performance capability, according to various embodiments.

Referring to FIG. 43, the computing device may obtain a data set (S4301).

In addition, the computing device may identify a first data point set by mapping the data set to a first embedding space using at least one pre-trained model (S4303). In this case, the first embedding space may be a feature map of a predetermined N-dimensional (e.g., 512).

In addition, the computing device may identify a second data point set by mapping the first data point set to a second embedding space using at least one pre-trained model (S4305). In this case, the computing device may determine an optimal dimensionality corresponding to the input data set, and may identify a second data point set by mapping the first data point set to a second embedding space defined by the optimal dimensionality.

In addition, the computing device may obtain an output value by performing a task based on the first data point set using at least one auxiliary network (S4307).

In this case, the computing device may evaluate the task performance capability of the data set based on the first data point set. Specifically, the computing device may load an auxiliary network reflecting a task of an artificial intelligence model to be trained by the data set, and evaluate the task performance capability by inputting the first data point set or the data set to the loaded auxiliary network.

In addition, the computing device may obtain an image of data based on the second data point set using at least one pre-trained model (S4309).

[Improving a Quality of Dataset—Data Diet]

In order to optimize a framework of the artificial intelligence model and derive a result value with high accuracy, a quality of learning (training) data is very important.

The quality of training data is a concept including both quantitative quality and qualitative quality, as described above. Specifically, for successful learning of the artificial intelligence model, it is necessary to (i) secure a sufficient amount of learning data to train the artificial intelligence model, (ii) secure learning data having high quality intrinsic characteristics (e.g., distribution without bias), and (iii) secure learning data having characteristics (e.g., task-dependent property) appropriate for a learning purpose (e.g., a task of the artificial intelligence model).

In order to obtain the high quality learning data, the computing device according to an embodiment of the present disclosure may synthesize or modify (or adjust) data in a direction that improves the intrinsic properties (characteristics) of the data set and properties dependent on the task.

In addition, the computing device according to the present disclosure may improve the overall quality of the data set by removing at least some pieces of data from the data set.

In general, a down-sampling or under-sampling technique of data is used to solve a problem of imbalance of data. However, according to the existing under-sampling method, data is removed without considering characteristics of the training data set, and thus there is a problem of adversely affecting learning of the AI model.

The computing device according to the present disclosure may improve the learning efficiency of the artificial intelligence model trained by appropriately removing at least some data from the data set.

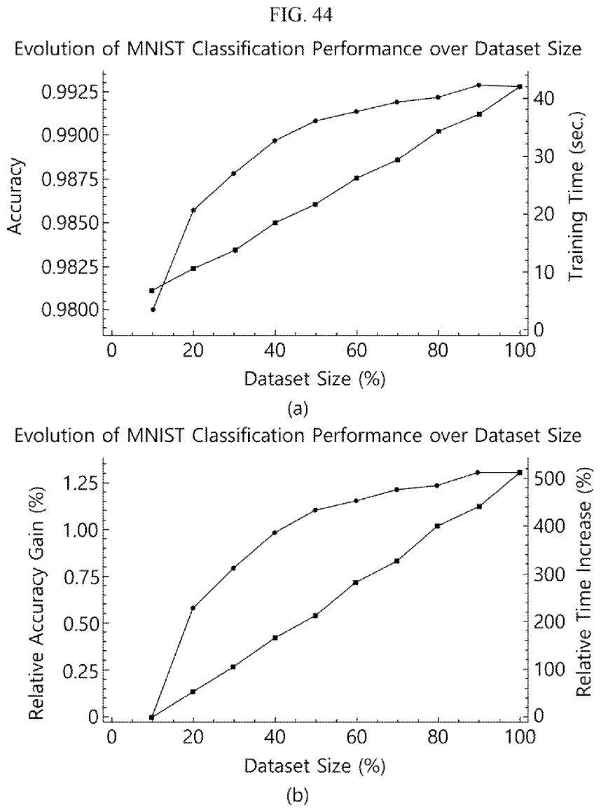

FIG. 44 is a diagram illustrating experimental data for a correlation between an amount of training data and a learning efficiency of an artificial intelligence model.

Referring to FIGS. 44 (a) and 44 (b), it can be seen that even if the size of the learning data set is reduced to a certain level, the accuracy according to learning is maintained at a high level, and the time taken for learning is dramatically reduced. Specifically, even if the amount of data is reduced from 100% to 10%, it can be seen that the classification accuracy (upper graph of the two graphs shown in FIGS. 44 (a) and 44 (b)) is slowly reduced from 0.9925 to 0.9800 to 1% or less, while the learning time is reduced from 40 seconds to 5 seconds to 85% or more.

In addition to solving the problem of imbalance of learning data, the present disclosure proposes a “data diet” (or “data decimation”) method for improving the quality of a data set by dramatically reducing the time and cost taken for learning while maintaining the learning efficiency.

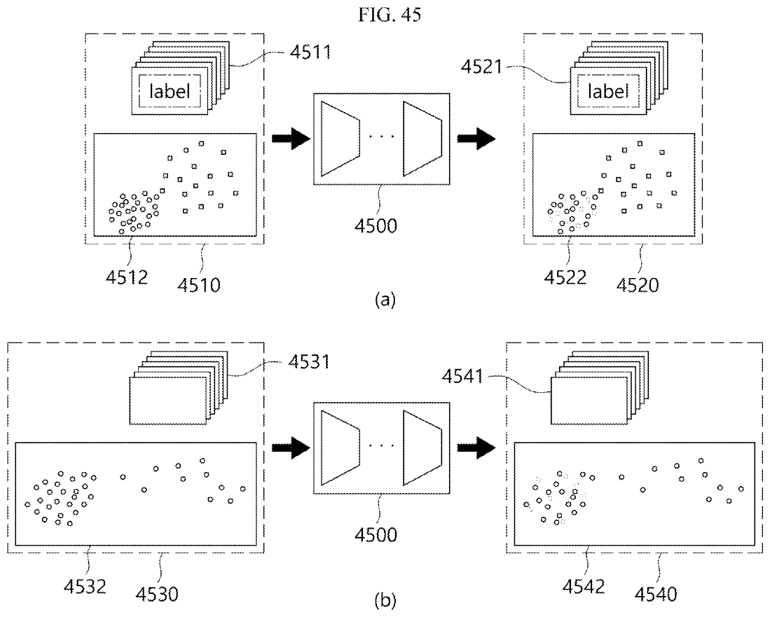

FIG. 45 is a diagram illustrating a method by which a computing device removes at least a portion of a data set using a pre-trained artificial intelligence model, according to various embodiments.

Referring to FIG. 45, the computing device may sample and remove at least some pieces of data among data included in the data set according to a predetermined method by using the pre-trained artificial intelligence model 4500.

For example, referring to FIG. 45(a), the computing device may input first input data 4510 to the artificial intelligence model 4500, and the artificial intelligence model 4500 may obtain first output data 4520 by removing at least a portion of data included in the first input data 4510.

In this case, the first input data 4510 may include a first data set 4511 and/or a first data point set 4512 (or a first image of data) corresponding to the first data set 4511. Here, the first data point set 4512 may be data obtained by mapping the first data set 4511 to a specific embedding space.

In addition, the first output data 4520 may include a first processed data set 4521 and/or a first processed data point set 4522 (or a first processed data image).

Specifically, the computing device may obtain the first processed data set 4521 by removing at least a portion of data included in the first data set 4511. Alternatively, the computing device may obtain the first processed data point set 4522 by removing at least a portion of data points included in the first data point set 4512 and obtain the first processed data set 4521 based on the first processed data point set 4522.

Similarly, referring to FIG. 45(b), the computing device may obtain the second processed data set 4541 by removing at least a portion of data included in the second data set 4531. Alternatively, the computing device may obtain the second processed data point set 4542 by removing at least a portion of data points included in the second data point set 4532 and obtain the second processed data set 4541 based on the second processed data point set 4542.

Referring to FIG. 45, the input data sets 4511 and 4531 may be data with annotation or label, or may be data without annotation or label. For example, the first data set 4511 may be data including label data, and the second data set 4531 may be data not including label data.

In this case, the computing device may perform a data diet process by reflecting annotation information (e.g., a class) according to the label. Details thereof will be described below.

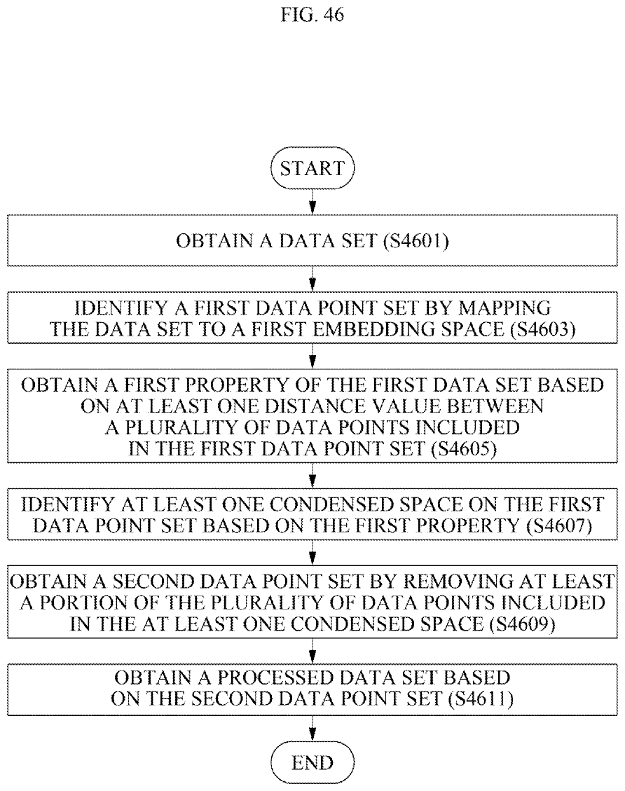

FIG. 46 is a flowchart illustrating an example in which a computing device obtains a processed data set based on a data set, according to various embodiments.

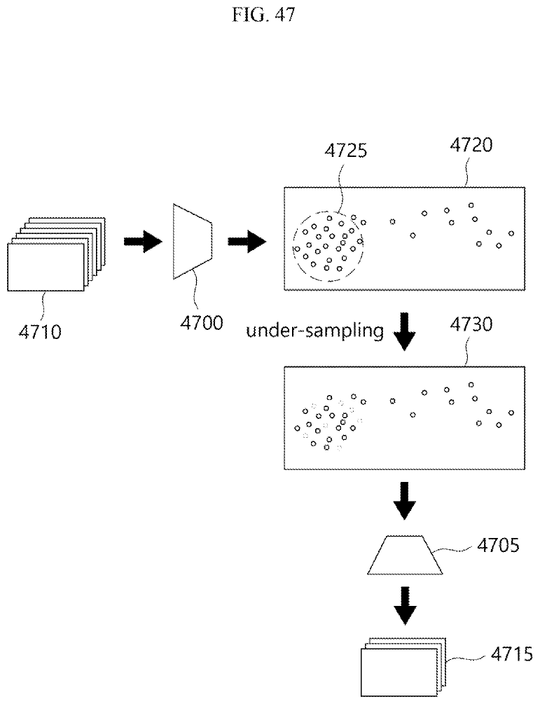

FIG. 47 is a diagram illustrating an example of a computing device obtaining a processed data set based on a data set, according to various embodiments.

Referring to FIG. 46, the computing device may obtain a data set (S4601). In addition, the computing device may identify a first data point set by mapping the data set to a first embedding space (S4603).

For example, referring to FIG. 47, the computing device may acquire a first data point set 4720 by mapping a first data set 4710 to a first embedding space using a first pre-trained model 4700. In this case, the first embedding space may be a N(N−1)-dimensional latent space identified from an output layer or a hidden layer of the first pre-trained model 4700. In the drawings, the first embedding space is represented as a two-dimensional space, but this is for illustrative purposes only, and it may actually be a four-dimensional or higher-dimensional space. In addition, the first pre-trained model 4700 may include at least one module (e.g., an encoder) for data imaging to indicate the data in the first embedding space, and in this case, the first data point set 4720 may be an image of data corresponding to the data set, but is not limited thereto.

Referring back to FIG. 46, the computing device may obtain a first property of the first data set based on at least one distance value between a plurality of data points included in the first data point set (S4605). In this case, the first property may include an intrinsic characteristic of the data set. For example, the first characteristic may include a density, a distribution, a bias, a similarity, or a uniformity of the data set, but is not limited thereto. In addition, the at least one distance value between the data points may include a Euclidean distance between the data points in the first embedding space, but is not limited thereto.

In addition, the computing device may identify at least one condensed space on the first data point set based on the first property (S4607). In the present disclosure, the condensed space is a concept defined arbitrarily for convenience of description and is not intended to be limited to the term “space”. Specifically, the “condensed space” may mean a specific space in which the data points are densely packed in the embedding space. Alternatively, the “condensed space” may mean at least one data point (or latent space including the at least one data point) having a density satisfying a predetermined condition in the embedding space. Alternatively, the “condensed space” may mean at least one data point corresponding to at least one feature value in a predetermined range or a latent space corresponding to the at least one data point in the embedding space.

In this case, the computing device may identify the condensed space based on the predetermined condition.

Specifically, the computing device may identify the condensed space based on at least one data point having a density of data equal to or greater than a threshold value. In this case, the computing device may identify the condensed space based on the magnitude of the absolute density of the data. Alternatively, the computing device may identify the condensed space based on at least one data point having a deviation of the density of the data equal to or greater than a threshold value. In this case, the computing device may identify the condensed space by comparing the relative density of the data.

Further, the computing device may identify the condensed space by identifying at least a portion of the space where the data is biased in the first embedding space, but is not limited thereto.

Further, the computing device may identify the condensed space by identifying at least a portion of the space causing an imbalance of the data in the first embedding space, but is not limited thereto.

For example, referring to FIG. 47, the computing device may identify at least one condensed space 4725 based on the first data point set 4720. In this case, the at least one condensed space 4725 may include a plurality of data points having a close distance. That is, the at least one condensed space 4725 may include a plurality of data points corresponding to a plurality piece of data similar to each other.

Referring back to FIG. 46, the computing device may obtain a second data point set by removing at least a portion of the plurality of data points included in the at least one condensed space (S4609). For example, the computing device may randomly sample at least a portion of the plurality of data points included in the at least one condensed space and obtain the second data point set by removing the sampled data points, but is not limited thereto.

In addition, the computing device may obtain a processed data set based on the second data point set (S4611). Specifically, the computing device may obtain the processed data set by reconstructing the second data point set.

For example, referring to FIG. 47, the computing device may obtain the second data point set 4730 by removing at least one data point included in the condensed space 4725 of the first data point set 4720. In this case, the computing device may remove at least one data point such that a geometry (e.g., a manifold) formed by the first data point set 4720 is maintained. Accordingly, the geometry of the second data point set 4730 may correspond to the geometry of the first data point set 4720.

In addition, the computing device may obtain the first processed data set 4715 based on the second data point set 4730 by using the second pre-trained model 4705. In this case, the second pre-trained model 4705 is a model paired with the first pre-trained model 4700 and may include at least one module (e.g., a decoder) for reconstructing data defined in the first embedding space to an output domain.

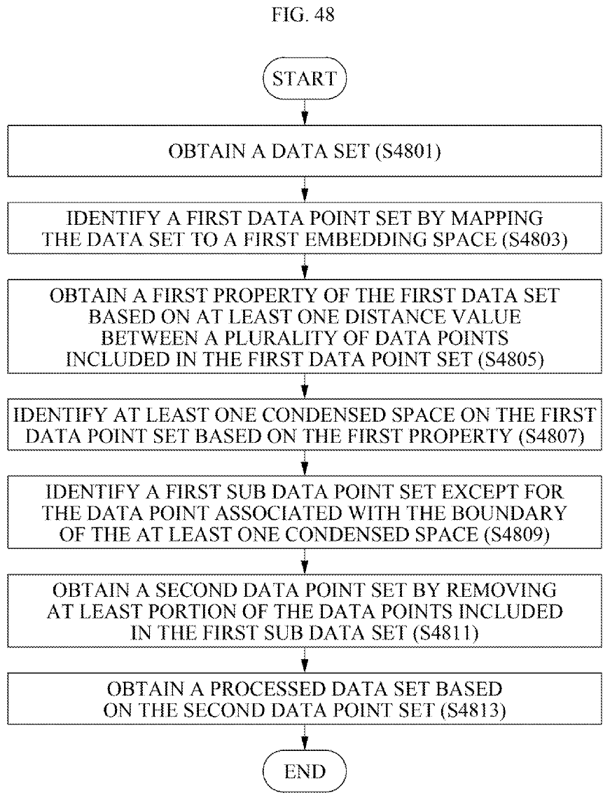

FIG. 48 is a flowchart illustrating another embodiment in which a computing device obtains a processed data set based on a data set, according to various embodiments.

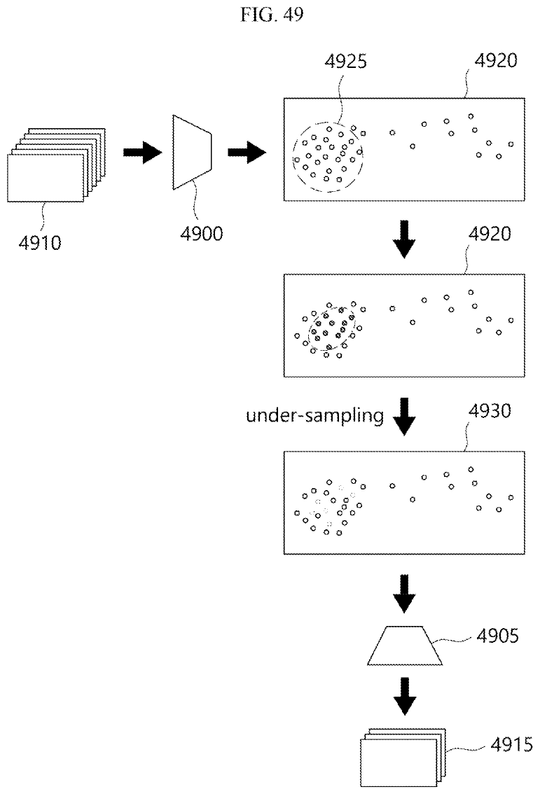

FIG. 49 is a diagram illustrating another example in which a computing device obtains a processed data set based on a data set, according to various embodiments.

Referring to FIG. 48, the computing device may obtain a data set (S4801). In addition, the computing device may identify the first data point set by mapping the data set to the first embedding space (S4803). The computing device may obtain a first property of the first data set based on at least one distance value between the plurality of data points included in the first data point set (S4805). In addition, the computing device may identify at least one condensed space on the first data point set based on the first property (S4807). The operations of steps S4801 to S4807 were described in the detailed description of FIG. 46 and will be omitted.

For example, referring to FIG. 49, the computing device may obtain the first data point set 4920 by mapping the first data set 4910 to the first embedding space using the first pre-trained model 4900. The computing device may identify at least one condensed space 4925 based on the first data point set 4920.

Referring back to FIG. 48, the computing device may identify a first sub data point set except for the data point associated with the boundary of the at least one condensed space (S4809). In this case, the data point associated with the boundary of the condensed space may include at least one data point defining the condensed space. Alternatively, the data point associated with the boundary of the condensed space may include at least one data point positioned within a predetermined distance from the boundary of the condensed space. In this case, the computing device may set a range of at least one feature (or embedding vector) defining the boundary of the condensed space.

For example, referring to FIG. 49, the computing device may identify the first sub data point set 4921 except for the data point associated with the boundary of the condensed space 4925 of the first data point set.

Referring back to FIG. 48, the computing device may obtain a second data point set by removing at least portion of the data points included in the first sub data set (S4811). In addition, the computing device may obtain a processed data set based on the second data point set (S4813).

For example, referring to FIG. 49, the computing device may obtain the second data point set 4930 by removing at least portion of the data points included in the first sub data point set 4921. In addition, the computing device may obtain the first processed data set 4915 based on the second data point set 4930 using the second pre-trained model 4905.

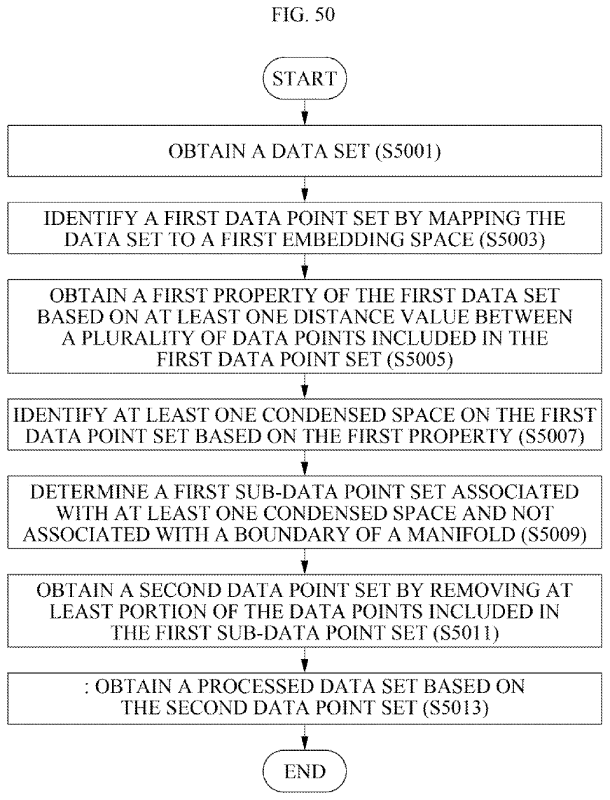

FIG. 50 is a flowchart illustrating another embodiment in which a computing device obtains a processed data set based on a data set, according to various embodiments.

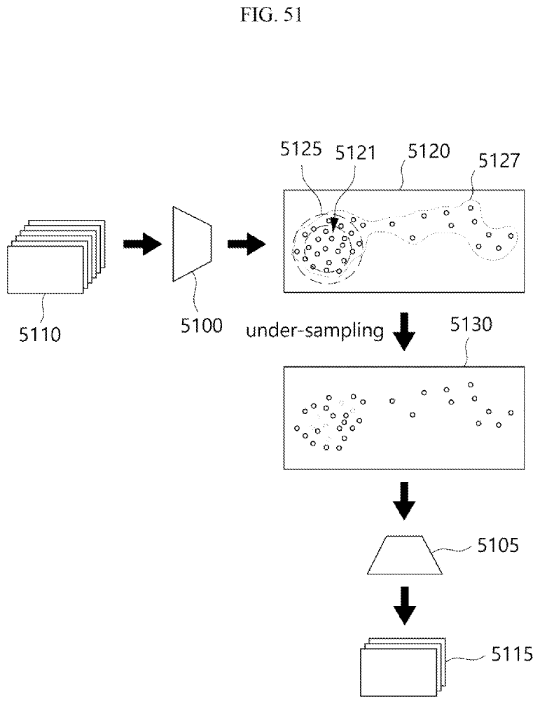

FIG. 51 is a diagram illustrating another example in which a computing device obtains a processed data set based on a data set, according to various embodiments.

Referring to FIG. 50, the computing device may obtain a data set (S5001). In addition, the computing device may identify the first data point set by mapping the data set to the first embedding space (S5003). The computing device may obtain a first property of the first data set based on at least one distance value between a plurality of data points included in the first data point set (S5005). In addition, the computing device may identify at least one condensed space on the first data point set based on the first property (S5007). The operations of steps S4801 to S4807 were described in the detailed description of FIG. 46 and will be omitted.

For example, referring to FIG. 51, the computing device may obtain the first data point set 5120 by mapping the first data set 5110 to the first embedding space using the first pre-trained model 5100. The computing device may identify at least one condensing space 5125 based on the first data point set 5120.

Referring back to FIG. 50, the computing device may determine a first sub-data point set associated with at least one condensed space and not associated with a boundary of a manifold (S5009). In this case, the manifold may mean a geometric shape (or a boundary of a shape) formed by the first data point set in the first embedding space.

Specifically, the computing device may determine a first sub-data point set included in at least one condensed space and not including at least one data point defining a shape of the first data point set.

For example, referring to FIG. 51, the computing device may identify a manifold 5127 of the first data point set 5120. Here, the computing device may identify the manifold 5127 based on at least one geometric characteristic identified by connecting a plurality of data points which determine a shape of the first data point set 5120.

In this case, the computing device may determine the first sub-data point set 5121 based on at least one data point associated with at least one condensed space 5125 and not associated with a boundary of the manifold 5127. In this case, the first sub-data point set 5121 may be included in the at least one condensed space 5125.

Referring back to FIG. 50, the computing device may obtain a second data point set by removing at least portion of the data points included in the first sub-data point set (S5011). In addition, the computing device may obtain a processed data set based on the second data point set (S5013).

For example, referring to FIG. 51, the computing device may obtain the second data point set 5130 by removing at least some of the data points included in the first sub-data point set 5121. In addition, the computing device may obtain the first processed data set 5115 based on the second data point set 5130 by using the second pre-trained model 5105.

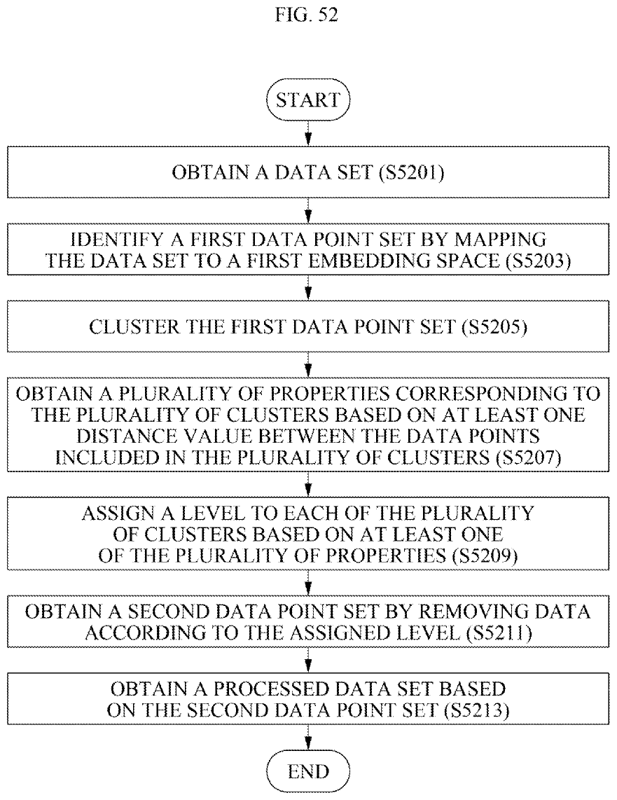

FIG. 52 is a flowchart illustrating another embodiment in which a computing device obtains a processed data set based on a data set, according to various embodiments.

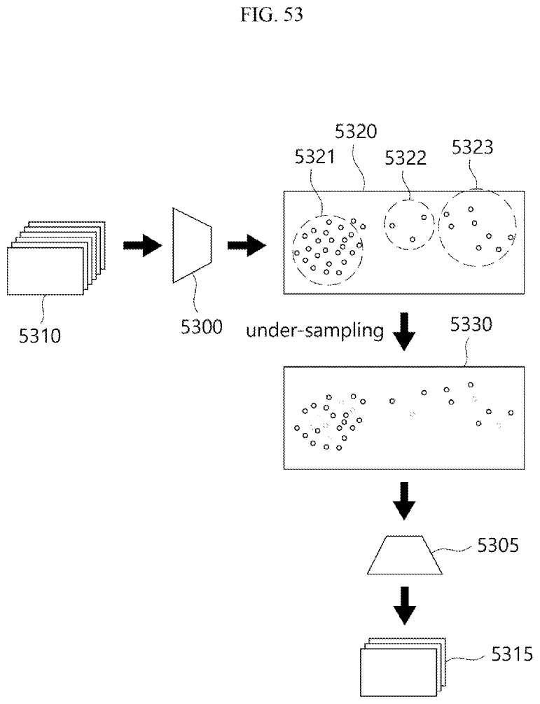

FIG. 53 is a diagram illustrating another example in which a computing device obtains a processed data set based on a data set, according to various embodiments.

Referring to FIG. 52, the computing device may obtain a data set (55201). In addition, the computing device may identify a first data point set by mapping the data set to a first embedding space (S5203). For example, referring to FIG. 53, the computing device may obtain the first data point set 5320 by mapping the first data set 5310 to the first embedding space by using the first pre-trained model 5300.

Referring back to FIG. 52, the computing device may cluster the first data point set (S5205). Specifically, the computing device may cluster the first data point set based on a pre-stored clustering algorithm (e.g., unsupervised learning-based clustering, etc.). Accordingly, the computing device may identify the first data point set by dividing the first data point set into a plurality of clusters.

For example, referring to FIG. 53, the computing device may identify a first cluster 5321 and a second cluster 5322 and a third cluster 5323 by clustering the first data point set 5320. In this case, a plurality of data points included in each cluster may exhibit similar characteristics. More specifically, the computing device may cluster the plurality of data points included in the first data point set 5320 into a plurality of clusters by clustering the plurality of data points based on similarity of characteristics.

Referring back to FIG. 52, the computing device may obtain a plurality of properties corresponding to the plurality of clusters based on at least one distance value between the data points included in the plurality of clusters (S5207). Specifically, the computing device may obtain a characteristic corresponding to a cluster based on an intrinsic property (characteristic) of the data points associated with each cluster. For example, the computing device may obtain a number of data points included in the cluster, an average distance between the data points included in the cluster, a radius of the cluster, a density of the cluster, and the like, but is not limited thereto.

In addition, the computing device may assign a level to each of the plurality of clusters based on at least one of the plurality of properties (S5209). Here, the level is a concept for assigning differentiation in a data processing process and may be a concept corresponding to a weight in a data processing algorithm. Specifically, the computing device may set the level depending on at least one characteristic of the plurality of clusters. For example, the computing device may be configured to assign a high level to a cluster having a high density (e.g., a number of data points compared to a radius of the cluster).

For example, referring to FIG. 53, the computing device may identify at least one property (characteristic) of the plurality of clusters 5321, 5322, and 5323. In addition, the computing device may assign a first level to the first cluster 5321, a second level to the second cluster 5322, and a third level to the third cluster 5323 based on the characteristic corresponding to the plurality of clusters. For example, when the density of the first cluster 5321 is higher than the density of the third cluster 5323 and the density of the third cluster 5323 is higher than the density of the second cluster 5322, the first level may be higher than the third level and the third level may be higher than the second level.

Referring back to FIG. 52, the computing device may obtain a second data point set by removing data according to the assigned level (S5211). Specifically, the computing device may be configured to remove more data points for a cluster allocated to have a high level.

For example, referring to FIG. 53, the computing device may obtain the second data point set 5330 by removing data points according to a level assigned to each of the plurality of clusters 5321, 5322, and 5323.

In addition, the computing device may perform clustering by obtaining a first property (e.g., a density) based on a distance between data points based on the first data point set 5320 and identifying at least two condensed spaces based on the first property. For example, the computing device may identify the first cluster 5321, the second cluster 5322, and the third cluster 5323 by identifying a first condensed space, a second condensing space, and a third condensing space having a first property greater than or equal to a threshold value.

Referring back to FIG. 52, the computing device may obtain a processed data set based on the second data point set (S5213). For example, referring to FIG. 53, the computing device may obtain the first processed data set 5315 based on the second data point set 5330 by using the second pre-learned model 5305.

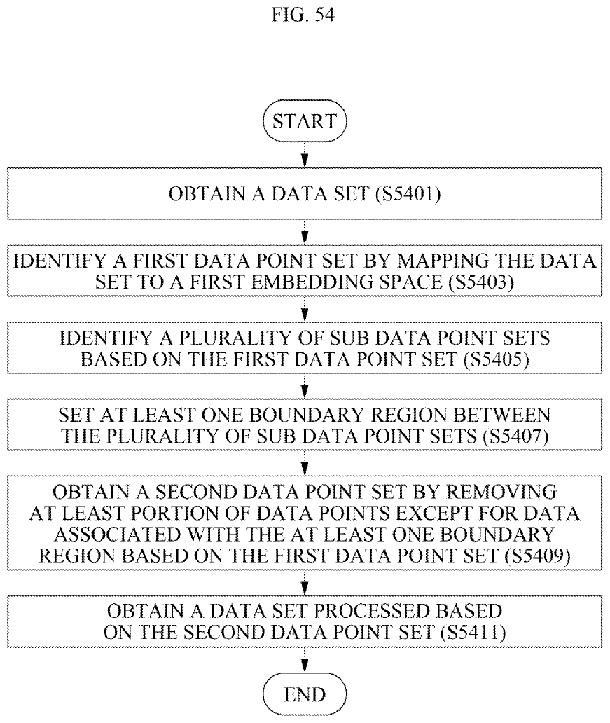

FIG. 54 is a flowchart illustrating another embodiment in which a computing device obtains a processed data set based on a data set, according to various embodiments.

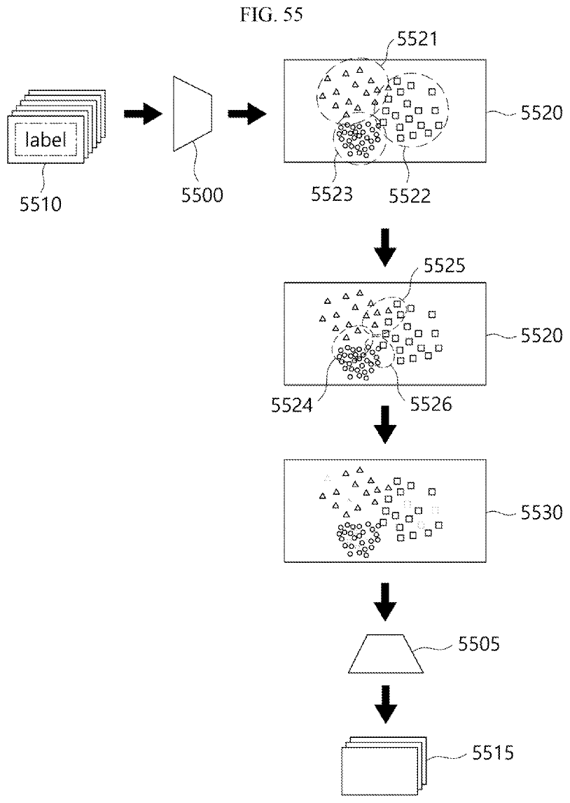

FIG. 55 is a diagram illustrating another example in which a computing device obtains a processed data set based on a data set, according to various embodiments.

Referring to FIG. 54, the computing device may obtain a data set (S5401). In addition, the computing device may identify a first data point set by mapping the data set to a first embedding space (S5403). For example, referring to FIG. 55, the computing device may obtain a first data point set 5520 by mapping the first data set 5510 to a first embedding space using a first pre-trained model 5500.

In this case, the data set 5510 may include labeled data. Specifically, the data set 5510 input to the first pre-trained model 5500 may include learning (target) data and correct answer data (e.g., annotation information) corresponding to the learning (target) data.

Referring back to FIG. 54, the computing device may identify a plurality of sub data point sets based on the first data point set (S5405). Specifically, the computing device may divide the first data point set into a plurality of sub data point sets based on the labeled data included in the data set. For example, referring to FIG. 55, the computing device may identify a first sub data point set 55210, a second sub data point set 5522, and a third sub data point set 5523 based on the first data point set 5520. In this case, the plurality of sub data point sets may indicate different classes.

Referring back to FIG. 54, the computing device may set at least one boundary region between the plurality of sub data point sets (S5407). More specifically, the computing device may identify at least one boundary for distinguishing the plurality of sub data points in the first embedding space. For example, referring to FIG. 55, the computing device may set at least one boundary region by identifying at least one data point included in the boundary between the plurality of sub data point sets. As a specific example, the computing device may identify a first boundary region 5524 between the first sub data point set 5521 and the third sub data point set 5523, a second boundary region 5525 between the first sub data point set 5521 and the second sub data point set 5522, and a third boundary region 5526 between the second sub data point set 5522 and the third sub data point set 5523, but is not limited thereto.

Referring back to FIG. 54, the computing device may obtain a second data point set by removing at least portion of data points except for data associated with the at least one boundary region based on the first data point set (S5409). In addition, the computing device may obtain a data set processed based on the second data point set (S5411). For example, referring to FIG. 55, the computing device may obtain a second data point set 5530 by removing at least one data point except data points included in at least one boundary region 5524, 5525, and 5526 among the plurality of data points included in the first data point set 5520. In addition, the computing device may obtain a first processed data set 515 based on the second data point set 5530 using a second pre-trained model 5505.

According to the above-described data diet algorithm, the computing device according to various embodiments of the disclosure may selectively remove unnecessary data from the data set, thereby improving a learning efficiency (e.g., a learning time consumed, a learning cost consumed, and the like) of the artificial intelligence model.

[Improving a Quality of Data Generation—Generation with Imaging]

The computing device may generate synthetic (virtual) data using at least one pre-trained generative model. For example, the computing device may generate synthetic data using generative models such as a generating adversarial network (GAN), diffusion model, or a Variational Autoencoder (VAE).

In order to increase the completion of the artificial intelligence model, it is necessary to generate synthetic data having a high quality similar to the actual data while being difficult to acquire from the actual data. Various deep learning-based generative models (e.g., GAN or VAE) currently used have drawbacks in terms of data generation quality or predictability of the generated data.

For example, a GAN model has an advantage in that data similar to the actual data can be generated, but noise, feature, or instance, and the like cannot be adjusted, thereby reducing predictability of the generated data. Due to this, it is difficult to estimate the actual distribution of data generated by the GAN model, and synthetic data having an unclear relationship with the actual data is generated.

In addition, for example, a VAE model may identify data points (e.g., feature, instance, or latent variable) in an embedding space, thereby ensuring predictability of data to be generated. However, since the VAE model is learned based on a reconstruction of data through a decoder and a distribution of a feature map in the embedding space, quality of data to be generated is not guaranteed.

The computing device according to an embodiment of the disclosure may generate synthetic data having high quality and generate synthetic data using the above-described generative models and a “Generative Imaging Model” to be described below, in order to improve the quality of existing learning data.

In the present specification, the generative imaging model means an artificial intelligence model including at least one processing module (e.g., an encoder, a decoder, a generator, a discriminator, and the like), and the term is not intended to limit the invention to the term itself.

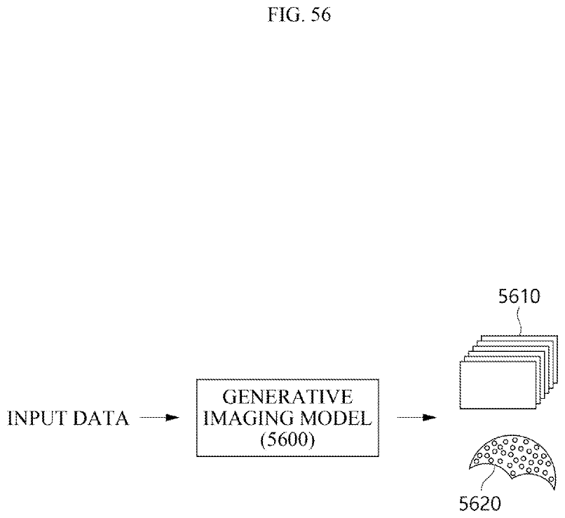

FIG. 56 is a diagram illustrating a method by which a computing device generates synthetic data using a generative imaging model, according to various embodiments.

Referring to FIG. 56, the computing device may obtain synthetic data 5610 and an image of data 5620 corresponding to the synthetic data based on input data using the generative imaging model 5600. In this case, the input data may include at least one feature (e.g., noise data, and the like) for generating the synthetic data.

More specifically, the computing device may input the input data to the generative imaging model 5600 and obtain the synthetic data 5610 and an image of data 5620 corresponding to the synthetic data through at least one layer of the generative imaging model 5600.

Here, the image of data 5620 is a feature map representing an intrinsic characteristic of the synthetic data 5610, and the computing device may acquire the image of data 5620 by mapping the synthetic data 5610 to a specific embedding space.

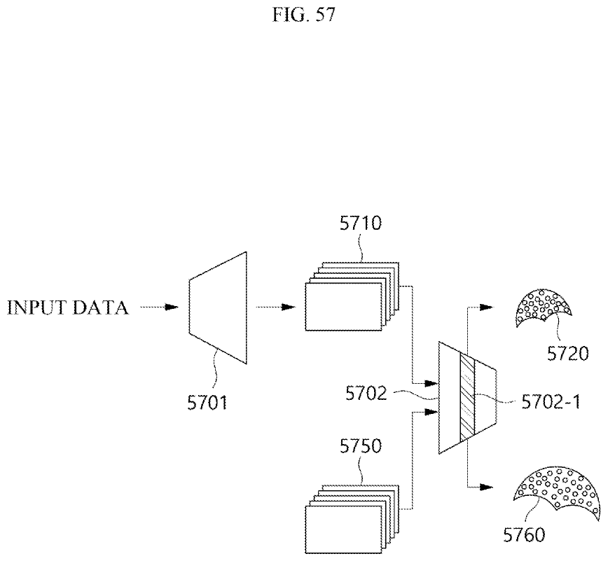

FIG. 57 is a diagram illustrating a framework within a computing device for a generative imaging model, according to various embodiments.

Referring to FIG. 57, the computing device may generate synthetic data 5710 based on input data using a first model 5701. In this case, the first model 5701 may include at least one generative module (e.g., a generator, etc.) but is not limited thereto.

In addition, the computing device may input the generated synthetic data 5710 and an actual data 5750 to a second model 5702. In this case, the second model 5702 may include at least one discriminator module (e.g., a discriminator, etc.), or at least one encoding module (e.g., an encoder, etc.), but is not limited thereto.

In addition, the computing device may identify a first manifold 5720 based on the synthetic data 5710 using the second model 5702. In addition, the computing device may identify a second manifold 5760 based on the actual data 5750 using the second model 5702.

Here, the first manifold 5720 may include a plurality of embedding vectors obtained by mapping the synthetic data 5710 to a specific embedding space. The first manifold 5720 may be data reflecting intrinsic characteristics (e.g., density, distribution, etc., of the synthetic data 5710).

In this case, the computing device may output the first manifold 5720 and the second manifold 5760 using at least one layer 5702-1 of the second model. For example, the at least one layer 5702-1 of the second model may include at least one embedding layer, but is not limited thereto.

In this case, the computing device may construct a generative imaging model by learning the first model 5701 and the second model 5702 based on the characteristics of the manifold corresponding to the synthetic data and the characteristics of the manifold corresponding to the actual data. In addition, the computing device may be configured to distinguish the synthetic data 5710 from the actual data 5720 using the second model 5702. In this case, the computing device may learn the second model 5702 so that the second model 5702 does not distinguish the synthetic data 5710 from the actual data 5750.

The computing device may train the first model 5701 and the second model 5702 to generate synthetic data indicating embedding similar to the actual data.

The computing device may train the first model 5701 to generate synthetic data having similar geometrical characteristics to the actual data. In addition, the computing device may train the second model 5702 so that the shapes of the first manifold 5720 and the second manifold 5760 become similar. For example, the computing device may train the first model 5701 and/or the second model 5702 so that the geometrical shape formed by the data points located at the boundary of the first manifold 5720 corresponds to the geometrical shape formed by the data points located at the boundary of the second manifold 5760.

More specifically, the computing device may optimize parameters of the first model 5701 and/or the second model 5702 by adjusting a distance relationship between at least one data point included in the first manifold 5720 and at least one data point included in the second manifold 5760.

For example, the computing device may adjust the distance relationship so that the distance between the data points is constant over the boundary of the second manifold 5760 corresponding to the actual data and the boundary of the first manifold 5720 corresponding to the synthetic data. Specifically, the computing device may adjust the model parameter such that a distance between at least two data points represented at positions corresponding to each other on the first manifold 5720 and the second manifold 5760 is constant over a boundary of the manifold. As a specific example, in order to generate synthetic data corresponding to outlier data of the actual data, the synthetic data may be generated such that a distance between the outlier data and the specific synthetic data satisfies a predetermined condition. In addition, the computing device may optimize parameters of the first model 5701 and/or the second model 5702 by applying the above-described average hausdorff distance-based learning condition to each of the data points on the manifold.

In addition, the computing device may train the first model 5701 to generate synthetic data having similar positional characteristics to the actual data. In addition, the computing device may train the second model 5702 such that positions on the embedding of the first manifold 5720 and the second manifold 5760 become similar. For example, the computing device may train the first model 5701 and/or the second model 5702 to generate synthetic data 5710 such that a center of the first manifold 5720 corresponds to a center of the second manifold 5760.

More specifically, the computing device may optimize parameters of the first model 5701 and/or the second model 5702 by adjusting a geometric relationship between at least one data point included in the first manifold 5720 and at least one data point included in the second manifold 5760.

For example, the computing device may select at least two sample data (e.g., anchor data point, positive data point) in the second manifold 5760 corresponding to the actual data and select at least one sample data (e.g., negative data point) in the first manifold 5720. In addition, the computing device may generate synthetic data such that an angle between at least two sample data in the second manifold 5760 and at least one sample data in the first manifold 5720 is narrowed. In addition, the computing device may optimize parameters of the first model 5701 and/or the second model 5702 by applying the above-described angle adjustment-based learning condition (e.g., cosine similarity loss) to each of the data points on the manifold.

Through the above-described method of constructing the generative imaging model, the computing device may train the generative imaging model to generate data that is not present in the actual data while having embedding similar to the actual data.

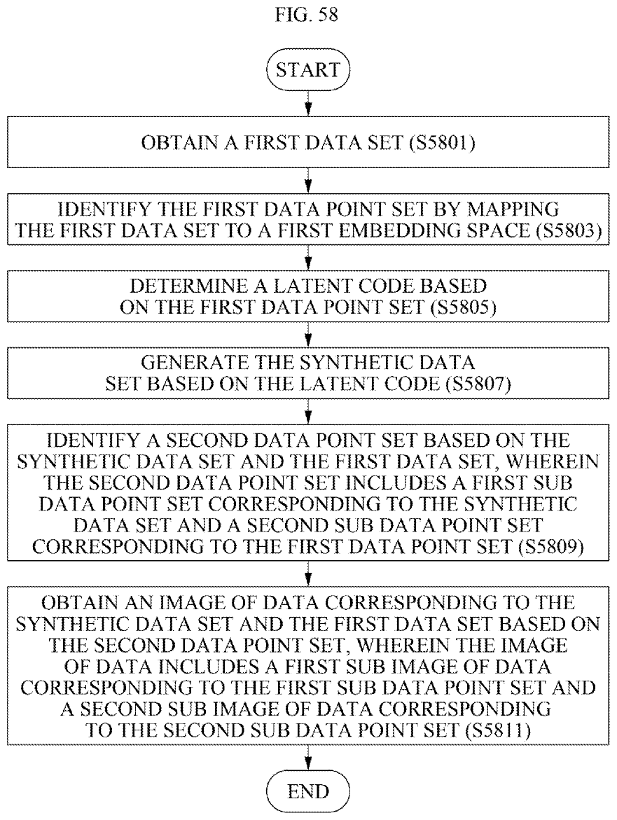

FIG. 58 is a flowchart illustrating a method by which a computing device processes data using a generative imaging model, according to various embodiments.

Referring to FIG. 58, the computing device may obtain a first data set (55801). In addition, the computing device may identify the first data point set by mapping the first data set to a first embedding space (S5803).

In addition, the computing device may determine a latent code based on the first data point set (55805). In this case, the latent code (or a latent vector or a latent variable) is a term indicating a potential feature of data and may mean at least one vector (or a variable, a parameter, or the like) potentially representing in the embedding space (or the latent space or a feature map).

Specifically, the computing device may determine a latent code by determining a variable corresponding to at least one region where data is required to be generated in the first embedding space based on the first data point set. The computing device may determine the latent code according to whether at least one characteristic (e.g., density) meets a predetermined condition based on the first data point set. For example, the computing device may predict the latent code of a region in which data is insufficient on the first data point set based on the density of the data. Specifically, the computing device may calculate the latent code corresponding to at least one region in which the density of the data is equal to or less than a predetermined threshold value based on the first data point set, but is not limited thereto.

In addition, the computing device may generate the synthetic data set based on the latent code (55807). For example, the computing device may generate the synthetic data set based on the latent code using a generator.

In addition, the computing device may identify a second data point set based on the synthetic data set and the first data set, wherein the second data point set includes a first sub data point set corresponding to the synthetic data set and a second sub data point set corresponding to the first data point set (S5809). Specifically, the computing device may identify the first sub data point set by mapping the synthetic data set to the first embedding space. In addition, the computing device may identify the second sub data point set by mapping the first data set to the first embedding space. In this case, the second sub data point set may correspond to the first data point set. In addition, the computing device may identify the second data point set in the first embedding space by identifying the first sub data point set and the second sub data point set.

In addition, the computing device may obtain an image of data corresponding to the synthetic data set and the first data set based on the second data point set, wherein the image of data includes a first sub image of data corresponding to the first sub data point set and a second sub image of data corresponding to the second sub data point set (S5811). Specifically, the computing device may obtain the image of data by representing the second data point set in the imaging space. In this case, the imaging space may correspond to the first embedding space. Alternatively, the imaging space may be a space for visualizing data.

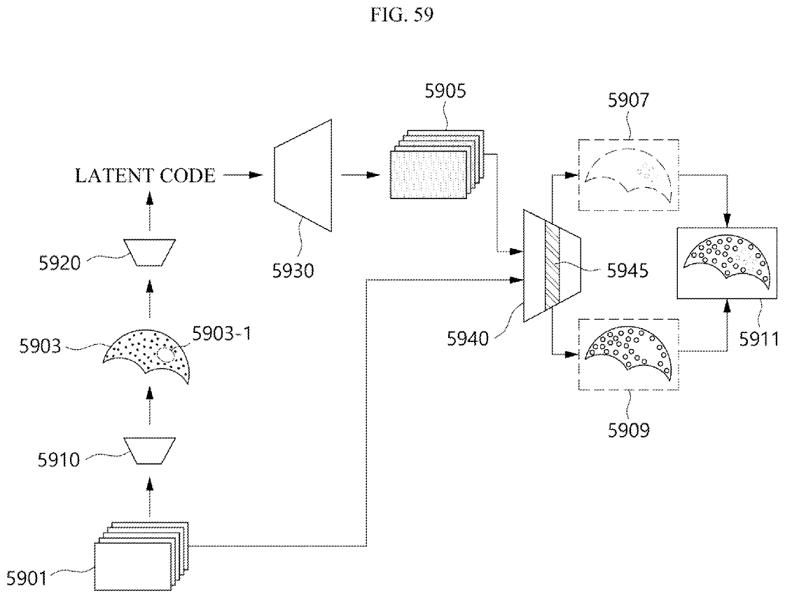

FIG. 59 is a diagram illustrating an example of a computing device processing data using a generative imaging model, according to various embodiments.

Referring to FIG. 59, the computing device may generate synthetic data using a generative imaging model including at least one (pre-trained) artificial intelligence model and may visualize the data (or obtain an image of data).

The computing device may input a first data set 5901 to the first pre-trained model 5910. The computing device may identify a first data point set 5903 by mapping the first data set 5901 to a first embedding space using the first pre-trained model 5910.

The computing device may determine a latent code based on the first data point set 5903 using at least one calculation device 5920. Specifically, the computing device may determine the latent code by deriving at least one feature value for making the distribution of the first data point set 5903 uniform. For example, the computing device may calculate, based on the first data point set 5903, the latent code corresponding to at least one area 5903-1 (e.g., a region having a relatively low density on the first embedding space) causing the non-uniformity of data.

The computing device may input the latent code to a second pre-trained model 5930. The computing device may generate a synthetic data set 5905 based on the latent code using the second pre-trained model 5930. In this case, a second synthetic data set 5905 may be associated with a domain corresponding to the first data set 5901.

The computing device may input the first data set 5901 and the synthetic data set 5905 to a third pre-trained model 5940. The computing device may identify a first sub-data point set 5907 (or a first sub-image of data) based on the synthetic data set 5905 using at least one layer 5945 of the third pre-trained model 5940. In addition, the computing device may identify a second sub-data point set 5909 (or a second sub-image of data) based on the first data set 5901 using at least one layer 5945 of the third pre-trained model 5940.

In this case, the computing device may optimize parameters of the second pre-trained model 5930 and the third pre-trained model 5940 based on the first sub-data point set 5907 and the second sub-data point set 5909. Specifically, the computing device may optimize parameters of the second pre-trained model 5930 and the third pre-trained model 5940 such that characteristics of the first sub-data point set 5907 and characteristics of the second sub-data point set 5909 become similar. That is, the computing device may generate the synthetic data set 5905 corresponding to at least one area where data is needed 5903-1 of the first data point set 5903.

In addition, the computing device may obtain an image of data based on the second data point set 5911 including the first sub-data point set 5907 and the second sub-data point set 5909.

Accordingly, the computing device may provide a generative imaging model for generating synthetic data corresponding to the generative imaging model by identifying a region requiring data on the data set, and may provide a generative model for generating high-quality data while controlling the latent code.

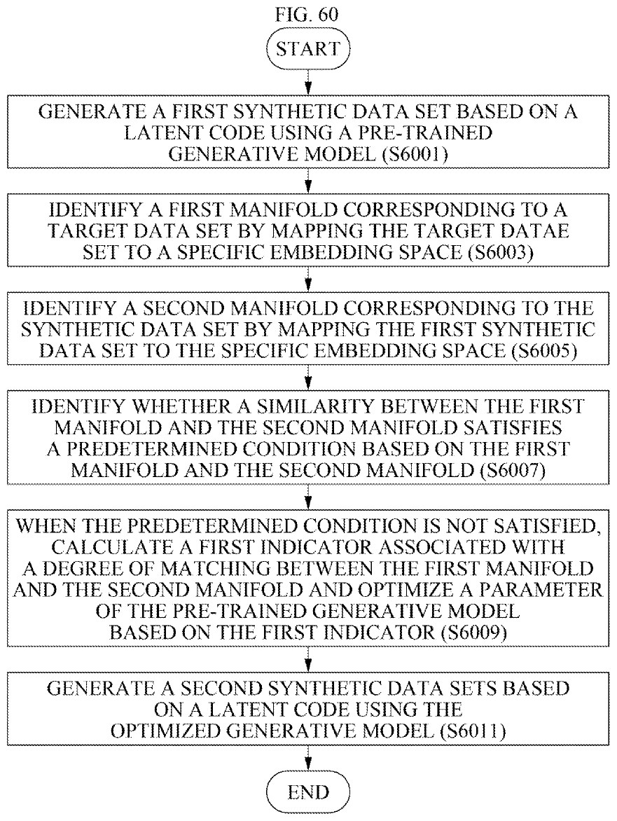

FIG. 60 is a flowchart illustrating a method by which a computing device generates data by optimizing a generative imaging model, according to various embodiments.

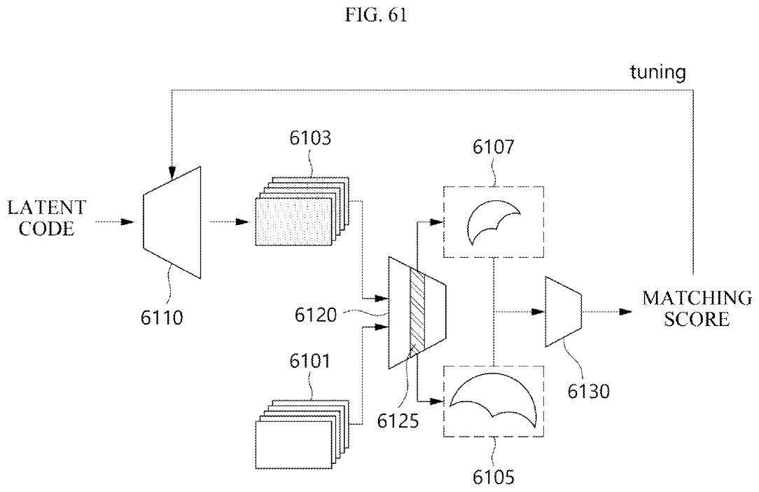

FIG. 61 is a diagram illustrating an example in which a computing device generates data by optimizing a generative imaging model, according to various embodiments.

Referring to FIG. 60, the computing device may generate a first synthetic data set based on a latent code using a pre-trained generative model (S6001). In this case, the latent code may be arbitrarily set, but the present disclosure is not limited thereto.

For example, referring to FIG. 61, the computing device may generate a first synthetic data set 6103 based on a latent code using a first model 6110.

Referring back to FIG. 60, the computing device may identify a first manifold corresponding to a target data set by mapping the target data set to a specific embedding space (S6003). Here, the target data may be data that the model wants to generate similarly. The target data may be actual data, but is not limited thereto. A pre-trained model can be trained to generate synthetic data similar to target data. In addition, the computing device may identify a second manifold corresponding to the synthetic data set by mapping the first synthetic data set to the specific embedding space (S6005).

For example, referring to FIG. 61, the computing device may input a target data set 6101 and a first synthetic data set 6103 to a second model 6120. The computing device may identify a first manifold 6105 corresponding to the target data set 6101 and a second manifold 6107 corresponding to the first synthetic data set 6103 using at least one layer 6125 of the second model 6120.

Referring back to FIG. 60, the computing device may identify whether a similarity between the first manifold and the second manifold satisfies a predetermined condition based on the first manifold and the second manifold (S6007). In this case, when the predetermined condition is not satisfied, the computing device may calculate a first index associated with a degree of matching between the first manifold and the second manifold and optimize a parameter of the pre-trained generative model based on the first index (S6009). In addition, the computing device may generate a second synthetic data sets based on a latent code using the optimized generative model (S6011).

For example, referring to FIG. 61, the computing device may calculate a similarity between the first manifold 6105 and the second manifold 6107 using at least one calculator 6130. For example, the computing device may derive a first indicator (e.g., a matching score) associated with a degree of matching between the first manifold 6105 and the second manifold 6107 based on a geometric association between at least one data point included in the first manifold 6105 and at least one data point included in the second manifold 6107, but is not limited thereto.

In this case, the computing device may optimize a parameter of the first model 6110 based on the derived first indicator. Specifically, the computing device may obtain the optimized generative model by adjusting the parameter of the first model 6110 so that the first manifold 6105 and the second manifold 6107 show a similarity equal to or greater than a predetermined criterion.

The computing device may generate synthetic data for improving a quality of data by optimizing a parameter of a generative imaging model according to the above-described process.

According to an embodiment of the present disclosure, a computing device may provide various data treatment algorithms (e.g., data generation, data removal, data correction, and the like) for improving artificial intelligence training data quality. The computing device may selectively apply a treatment algorithm suitable for improving a quality of data among various data treatment algorithms by accurately diagnosing characteristics of data.

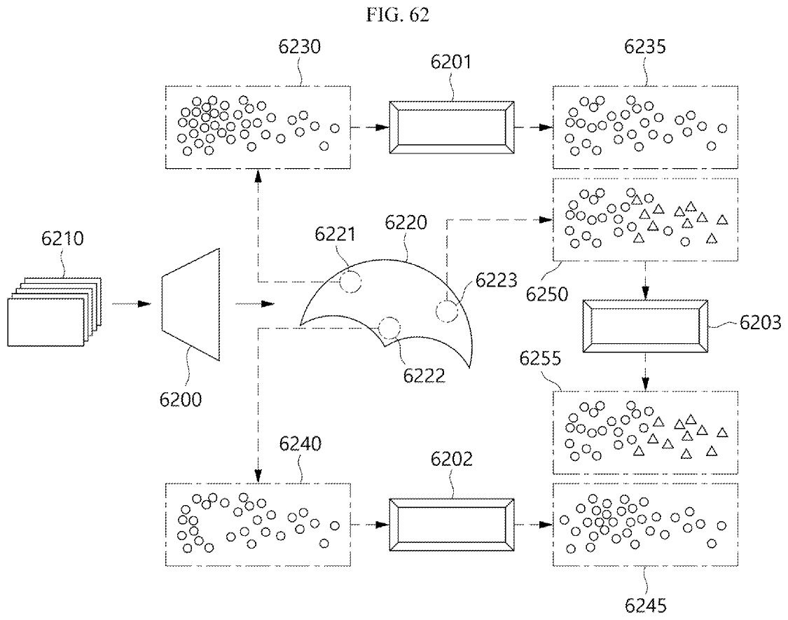

FIG. 62 is a diagram illustrating an example of a computing device improving the quality of a data set using at least one data processing model, according to various embodiments.

Referring to FIG. 62, the computing device may identify a first data point set 6220 or a first manifold based on a data set 6210 using a first model 6200.

In this case, the computing device may determine at least one property of data included in the data set 6210 based on the first data point set 6220, and may determine a data processing algorithm based on the determined at least one property. Specifically, the computing device may generate data, decimate data, or correct data in order to improve a quality of a data set by improving properties of the data set.

For example, the computing device may input a first sub-data point set 6230 included in a first sub-space 6221 among embedding spaces in which the first sub-data point set 6220 appears to a first model 6201 (e.g., a data diet model). In this case, the first sub-space 6221 may be a space in which at least one data point having a relatively high first property (e.g., density) appears. That is, the computing device may identify the first sub-space 6221 by extracting at least one sub-space having a relatively high density on the first data point set 6220.

The computing device may obtain a first modified sub-data point set 6235 based on the first sub-data point set 6230 using the first model 6201. Specifically, the computing device may obtain the first modified sub-data point set 6235 by removing at least a portion of a plurality of data points included in the first sub-data set 6230.

In addition, for example, the computing device may input a second sub-data point set 6240 included in a second sub-space 6222 among the embedding spaces in which the first data point set 6220 appears to the second model 6202 (e.g., the data generative model). In this case, the second sub-space 6222 may be a space in which at least one data point having a relatively low first property (e.g., density) appears. That is, the computing device may identify the second sub-space 6222 by extracting at least one sub-space having a relatively low density on the first data point set 6220.

The computing device may obtain a second modified sub-data point set 6245 based on the second sub-data point set 6240 using the second model 6202. Specifically, the computing device may obtain the modified second sub-data point set 6245 by generating data based on a latent code corresponding to an arbitrary region on the second sub-space 6222.

In addition, for example, the computing device may input a third sub-data point set 6250 included in a third sub-space 6223 among the embedding spaces in which the first data point set 6220 appears to a third model 6203 (e.g., the data adjustment model). In this case, the third sub-space 6223 may be a space in which a data point located at a boundary between data groups (e.g., labeling data, clusters, and the like) having different second properties (e.g., classes). That is, the computing device may identify the third sub-space 6223 by extracting at least one sub-space in which data points having different classes are located on the first data point set 6220.

The computing device may obtain a third modified sub-data point set 6255 based on the third sub-data point set 6250 using the third model 6203. Specifically, the computing device may obtain the modified third sub-data point set 6255 by adjusting a feature value of at least one data point among a plurality of data points included in the third sub-space 6223.

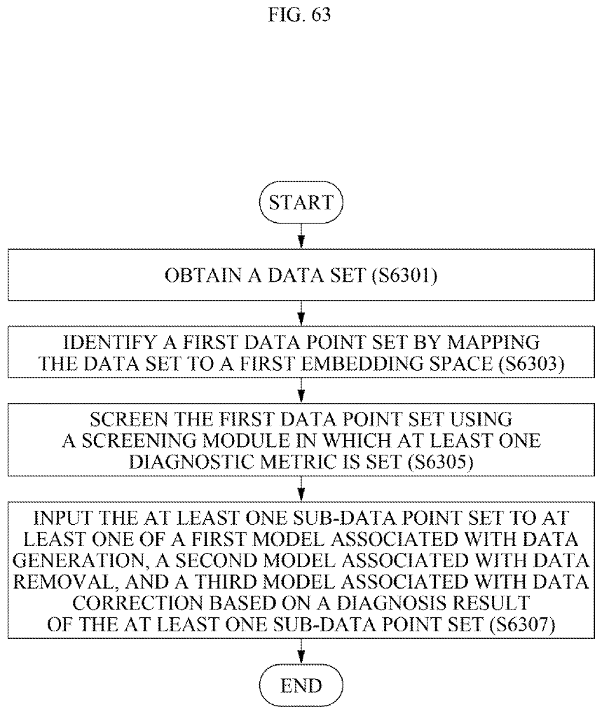

FIG. 63 is a diagram illustrating a pipeline through which a computing device inputs data into at least one data processing model based on properties of a data set, according to various embodiments.

Referring to FIG. 63, the computing device may obtain a data set (S6301). In addition, the computing device may identify a first data point set by mapping the data set to a first embedding space (S6303).

In addition, the computing device may screen the first data point set using a screening module in which at least one diagnostic metric is set (S6305). Specifically, the computing device may apply the screening module in which at least one diagnostic metric for calculating at least one property value of data is set to the first data point set. Accordingly, the computing device may determine at least one property of data included in the first data point set.

The computing device may input the at least one sub-data point set to at least one of a first model associated with data generation, a second model associated with data removal, and a third model associated with data correction based on a diagnosis result of the at least one sub-data point set (S6307).

[Integration Data Clinic Model and Large Language Model]

A machine learning model for natural language processing (NLP) includes a natural language understanding model aimed at inferring information from natural language and a natural language generation model aimed at generating natural language based on some inputs. The training examples for the natural language understanding model may be directed to specific tasks. For example, to train the natural language understanding model to understand a user utterance requesting a trip to various destinations, a per-task corpus configured with a training example in which a label is designated may be used. The corpus may include various examples of user utterances with a label tagged by a person, and the label may include intent labels (e.g., a flight reservation, a public transportation search, and the like) and slot labels (e.g., a starting place and a destination). For the purposes of this disclosure, it is noted that the term “utterance” or “natural language input” includes not only words spoken by a user or a machine, but also words delivered using text, signs, and the like.

In many cases, insufficient human labeling training examples may be readily used to train a task-adaptive language understanding model. In other words, a model trained using only available examples is likely to have a performance degradation when used in a corresponding task. The disclosed implementation provides an approach for generating a per-task training example that may be used instead of or in addition to a training example made by an actual user using a generative model. In this disclosure, the term “synthetic” means that at least partially machine-generated. As described in this disclosure, generating training data for a natural language understanding model using a generative model may provide large amounts of appropriate learning data at a relatively low cost because a human user does not need to label a synthetic training example.

Existing techniques for training a generative model do not necessarily generate a generative model that is particularly useful for generating a per-task training example. For example, one method of performing unsupervised learning of a generative model is to train a model to predict a next word in a sequence given a previous word from which the model already seen. However, if the training data used in the generative model is a general-purpose corpus (e.g., Wikipedia articles, books, web articles, and the like), the trained generative model learns how to generate text similar to that of the general-purpose corpus. This approach may be used to obtain a generative model that generates a reasonable utterance, but such a model may not have utility for a specific natural language scenario.

For example, a “conversation action” has many utility for a user-facing application such as an interactive bot or a digital assistant. The automated application may interpret the received user utterance using the natural language understanding model, and may infer intent and slot values from, for example, words spoken or entered by a user. In addition, the automated application may generate a responsive utterance to the user using the generative model.

However, the generative model trained on the general-purpose corpus (e.g., Wikipedia article) may not be particularly familiar with generating a synthetic utterance suitable for a conversation action in a user facing scenario. Moreover, the synthetic data (e.g., the synthetic utterance) generated by the model may not be very similar to a user request for a conversation-based system, and thus may not be particularly useful as synthetic training data of a natural language understanding model to be used to understand a user conversation.

The computing device according to an embodiment of the present disclosure may provide synthetic data for improving a quality of training data using the above-described natural language processing model (e.g., a natural language understanding model or a generative model).

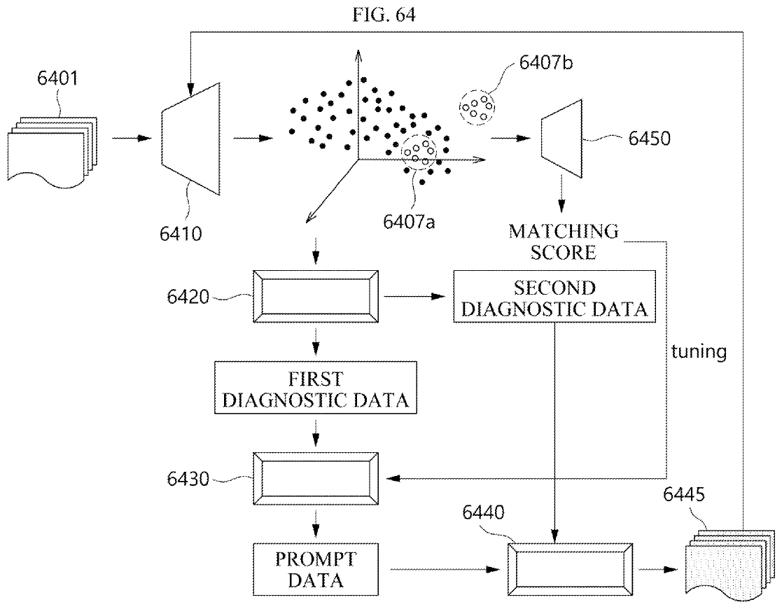

FIG. 64 is a diagram illustrating a method by which a computing device generates synthetic data based on data diagnostic data, according to various embodiments.

Referring to FIG. 64, the computing device may identify a first data point set 6405 based on a data set 6401 using a first model 6410. Here, the first model 6410 may be a data imaging model for indicating a distribution of data included in the first data set 6401.

In addition, the computing device may obtain a first diagnostic data based on the first data point set 6405 using an operator 6420 in which a diagnostic metric is set. In this case, the first diagnostic data may include utterance data indicating properties of the first data set 6401. Alternatively, the first diagnostic data may include utterance data indicating a quality of the first data set 6401. Alternatively, the first diagnostic data may include utterance data indicating a need for treatment (e.g., generation, removal, correction, or the like) of the first data set 6401. For example, the first diagnostic data may include utterance data indicating a diagnosis result for a quality of a data set such as “lack of data having a class A,” “need to generate data of a class A,” “with excessively many classes of data B,” “need to remove data of a class B,” “border between data of a class C and data of a class D is ambiguous,” or “need to distinguish data of a class C and data of a class D”.

In addition, the computing device may obtain prompt data based on the first diagnostic data using a natural language processing (NLP) model 6430. Here, the prompt data may mean input data configured to obtain a result using a machine learning model. For example, the prompt data may mean an instruction set input to generate a response from a data generative model based on a large language model. As a specific example, in the natural language processing model, the prompt data is a term collectively referred to as a sequence template, a label, and a word.

The computing device may be configured to generate a prompt data suitable for a type (e.g., domain, modality, class, or the like) of data to be generated, using the natural language processing model 6430. The computing device may determine a type of data to be generated based on the first diagnostic data and may generate the prompt data according to the determined type of data. In addition, the computing device may input the generated prompt data to a generative model 6440. Accordingly, the computing device may generate the synthetic data set 6445 based on the prompt data using the generative model 6440.

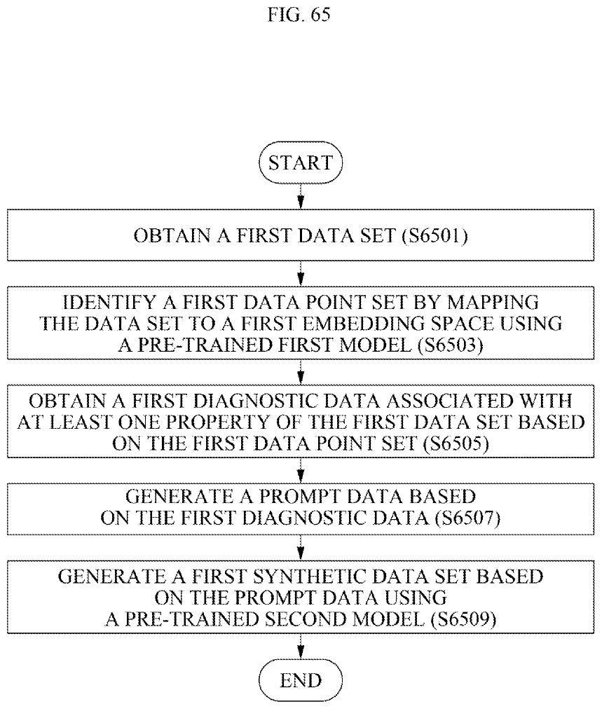

FIG. 65 is a flowchart illustrating a method in which a computing device generates synthetic data using a pre-trained artificial intelligence model, according to various embodiments.

Referring to FIG. 65, the computing device may obtain a first data set (S6501). In addition, the computing device may identify a first data point set by mapping the data set to a first embedding space using a pre-trained first model (S6503). In addition, the computing device may obtain a first diagnostic data associated with at least one property of the first data set based on the first data point set (S6505). In addition, the computing device may generate a prompt data based on the first diagnostic data (S6507). In addition, the computing device may generate a first synthetic data set based on the prompt data using a pre-trained second model (S6509).

Referring back to FIG. 64, the computing device may verify whether appropriate data is generated according to a diagnosis result of the data set 6410. Specifically, the computing device may verify whether the generated synthetic data set 6445 satisfies a predetermined criterion. For example, the computing device may perform the verification by identifying whether the generated synthetic data set 6445 corresponds to a result according to the first diagnostic data.

As an example, the computing device may verify whether data requested to be generated is generated by imaging the synthetic data set 6445 using a data imaging model 6410.

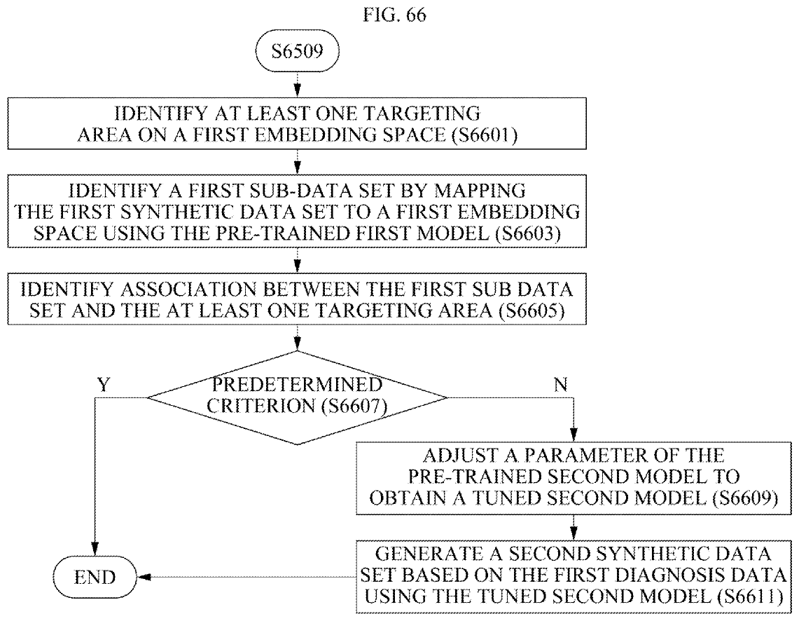

FIG. 66 is a flowchart illustrating an example of a method for a computing device to verify the suitability of a synthetic data set, according to various embodiments.

Referring to FIG. 66, the computing device may generate a synthetic data set according to operation S6509 of FIG. 65.

In addition, the computing device may identify at least one targeting area on a first embedding space (S6601). Specifically, the computing device may identify a targeting area by identifying at least one area requiring data generation on the first embedding space based on the first diagnostic data.

For example, referring to FIG. 64, the computing device may identify a first area 6407a on the embedding space as a targeting area based on the first diagnostic data corresponding to the first data point set 6405. Specifically, the computing device may determine properties of data that need to be generated based on the first diagnostic data and identify a targeting area by specifying at least one area corresponding to the determined properties.

Referring back to FIG. 66, the computing device may identify a first sub-data set by mapping the first synthetic data set to a first embedding space using the pre-trained first model (S6603). In addition, the computing device may identify association between the first sub data set and the at least one targeting area (S6605).

In this case, the computing device may identify whether the association between the first sub data set and the at least one targeting area satisfies a predetermined criterion (S6607). For example, the computing device may set a predetermined criterion based on a degree to which the first sub data set corresponds to the targeting area. Alternatively, the computing device may set a predetermined criterion based on a degree that an area occupied in the first embedding space and the targeting area overlap.

When the predetermined criterion is satisfied, the computing device may determine that the appropriate synthetic data is generated and terminate the verification algorithm.

When the predetermined criterion is not satisfied, the computing device may adjust a parameter of the pre-trained second model to obtain a tuned second model (S6609). Alternatively, the computing device may determine that there is an error in the prompt data, and in this case, the parameter of the natural language processing model may be adjusted. In addition, the computing device may generate a second synthetic data set based on the first diagnosis data using the tuned second model (S6611).

For example, referring to FIG. 64, the computing device may identify that the sub data point set corresponding to the synthetic data set 6445 appears in a second area 6407b in the first embedding space. The computing device may determine that the second area 6407b occupied by the sub data point set is not associated with the first area 6407a that is the targeting area. In this case, it is determined that the predetermined criteria are not satisfied, the model may be optimized by adjusting at least one parameter of the natural language processing model 6430 or the generative model 6440.

Alternatively, the computing device may derive an index (or indicator) (e.g., a matching score) regarding an association between the generated synthetic data set 6445 and the first data set 6401 using a calculator 6450. The computing device may adjust at least one parameter of the natural language processing model 6430 or the generative model 6440 based on the index regarding the association to optimize the model.

As another example, the computing device may determine properties of the data set including the generated synthetic data set 6445 to verify whether quality is improved.

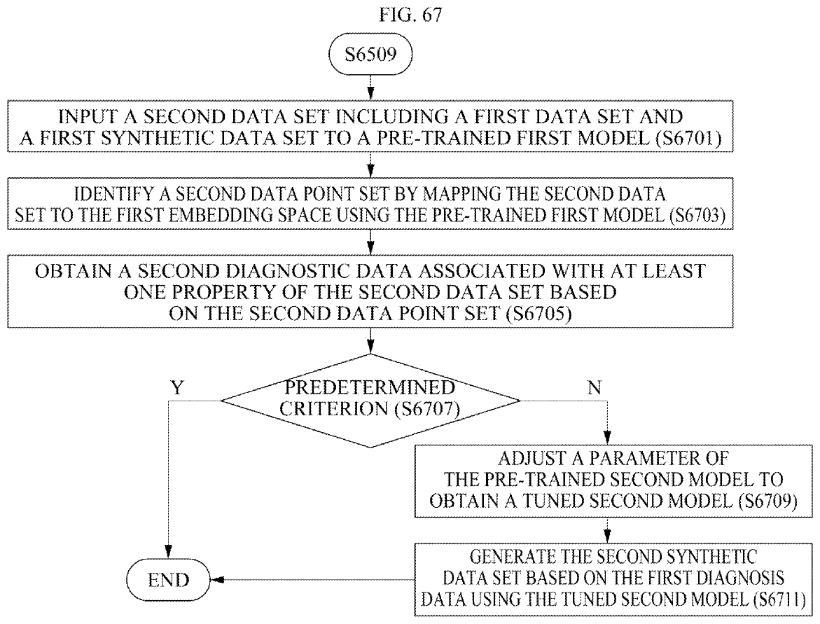

FIG. 67 is a flowchart illustrating another example of a method for a computing device to verify the suitability of a synthetic data set, according to various embodiments.

Referring to FIG. 67, the computing device may input a second data set including a first data set and a first synthetic data set to a pre-trained first model (S6701). In addition, the computing device may identify a second data point set by mapping the second data set to the first embedding space using the pre-trained first model (S6703). In addition, the computing device may obtain a second diagnostic data associated with at least one property of the second data set based on the second data point set (S6705). In addition, the computing device may determine whether a predetermined criterion is satisfied based on the second diagnostic data (S6707).

When the predetermined criterion is satisfied, the computing device may determine that the appropriate synthetic data is generated and terminate the verification algorithm.

When the predetermined criterion is not satisfied, the computing device may adjust a parameter of the pre-trained second model to obtain a tuned second model (S6709). Alternatively, the computing device may determine that there is an error in the prompt data, and in this case, the parameter of the natural language processing model may be adjusted. In addition, the computing device may generate the second synthetic data set based on the first diagnosis data using the tuned second model (S6711).

For example, referring to FIG. 64, the computing device may obtain the second diagnostic data based on a second data set including the first data set 6401 and the generated synthetic data set 6445.

The computing device may determine whether the generated synthetic data set 6445 satisfies a predetermined criterion (e.g., a generation constraint) by analyzing the second diagnostic data. Specifically, the computing device may compare the first diagnostic data and the second diagnostic data to determine whether the quality of the data is improved. For example, the computing device may compare information associated with the quality of the data included in the first diagnostic data and information associated with the quality of the data included in the second diagnostic data. In this case, when the quality of the data determined based on the second diagnostic data is higher than the quality of the data determined based on the first diagnostic data, the computing device may determine that the predetermined criterion is satisfied.

When the computing device determines that the synthetic data set 6445 does not satisfy the predetermined criterion, the model may be optimized by adjusting at least one parameter of the natural language processing model 6430 or the generative model 6440 based on the determined parameter.

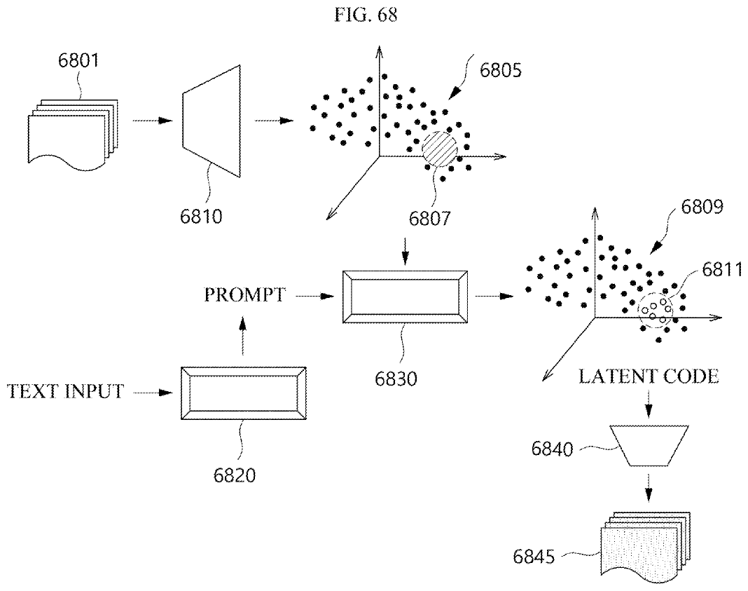

FIG. 68 is a diagram illustrating a method for a computing device to generate synthetic data by modifying an image of data based on language input, according to various embodiments.

Referring to FIG. 68, the computing device may obtain a first image of data 6805 by representing the first data set 6801 in an imaging space using a data imaging model 6810. In this case, the first image of data 6805 may be obtained to reflect an intrinsic property of the first data set 6801.

The computing device may receive a utterance input (e.g., a text input) and a user input for the first image of data 6805 from a user device. In this case, the user input for the first image of data 6805 may be a user input associated with a region where data is required to be generated on the first image of data 6805. For example, the computing device may obtain an image of data in which at least a partial region 6807 of the first image of data 6805 is masked.

In this case, the computing device may generate a prompt based on the input utterance data using the natural language processing model 6820. In this case, the prompt may be associated with generation of data corresponding to at least a partial region 6807 on the first image of data. Specifically, the computing device may generate prompt data associated with characteristics (or types) of data to be generated in at least a partial region 6807 of the first image of data 6805 based on the input utterance data. For example, the computing device may obtain a prompt to “[generate] [X pieces] of [food image data] representing [ramen]” from a user input, but is not limited thereto.

In addition, the computing device may input the prompt and the first image of data in which the at least a partial region 6807 is masked to a first generative model 6830.

The computing device may generate, using the first generative model 6830, a second image of data 6809 based on the prompt and the first image of data in which the at least a partial region 6807 is masked. In this case, the second image of data 6809 may include a specific region 6811 corresponding to virtual instances.

Specifically, the computing device may obtain the second image of data 6809 including the specific region 6811 by generating at least one virtual instance (or data point, feature vector, or the like) in at least a partial region 6807 of the first image of data. For example, the computing device may generate virtual instances based on feature values of data corresponding to at least partial region 6807 of the first image of data 6805 and identify a specific region 6811 by displaying a location of the virtual instances on an embedding space.

In this case, the computing device may identify a latent code corresponding to virtual instances corresponding to the specific region 6811 of the second image of data 6809. Specifically, the computing device may identify the latent code by generating at least one feature value corresponding to the specific region 6811 in a specific embedding space, but is not limited thereto.

In addition, the computing device may input the identified latent code to a second pre-trained generative model 6840. The computing device may obtain the synthetic data set 6845 based on the latent code using the second generative model 6840.

Accordingly, the computing device may accurately identify the intent of the user based on the input on the image of data visually confirming the distribution of the data as well as the natural language input and generate synthetic data corresponding to the intent.

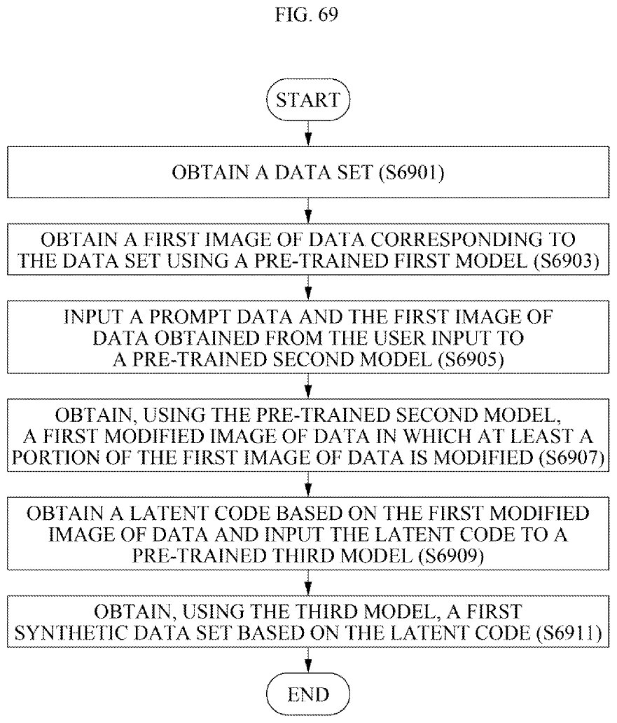

FIG. 69 is a flowchart illustrating a method for a computing device to generate synthetic data by modifying an image of data based on language input, according to various embodiments.

Referring to FIG. 69, the computing device may obtain a data set (S6901). In addition, the computing device may obtain a first image of data corresponding to the data set using a pre-trained first model (S6903).

In addition, the computing device may input a prompt data and the first image of data obtained from the user input to a pre-trained second model (S6905). In this case, at least a portion of the first image of data may be masked. Specifically, the computing device may input the first image of data having at least a partially masked region from the user input to the second model together with the prompt data.

In addition, the computing device may obtain, using the pre-trained second model, a first modified image of data in which at least a portion of the first image of data is modified (S6907).

In addition, the computing device may obtain a latent code based on the first modified image of data and input the latent code to a pre-trained third model (S6909). In addition, the computing device may obtain, using the third model, a first synthetic data set based on the latent code (S6911).

The computing device according to an embodiment of the disclosure may include at least one AI model for generating data based on a natural language input of a user. In this case, the computing device may evaluate and improve a quality of synthetic data generated based on a language by utilizing a data clinic model (e.g., imaging model) as an auxiliary network.

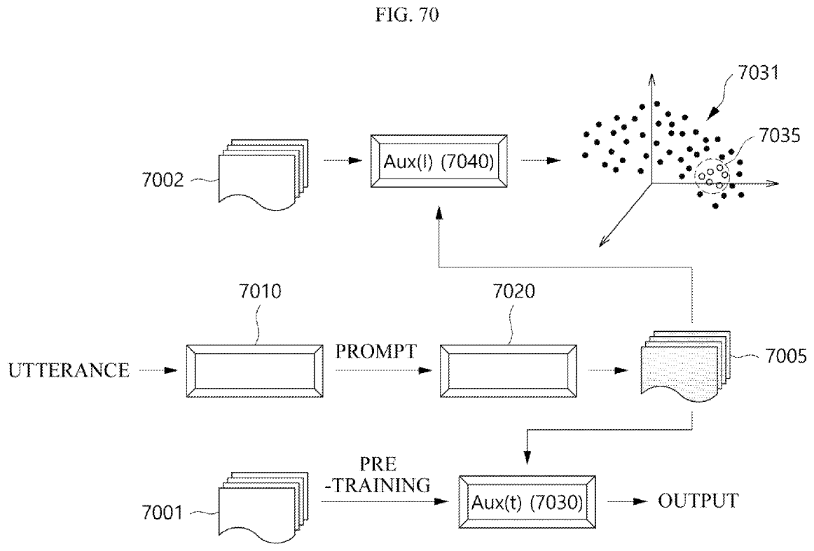

FIG. 70 is a diagram illustrating a method for a computing device to generate synthetic data based on utterance data, according to various embodiments.

Referring to FIG. 70, the computing device may generate a prompt data based on utterance data using a natural language processing model 7010. In this case, the computing device may identify an intent based on the utterance data and determine characteristics (e.g., a modality, a domain, or the like) of the synthetic data to be generated. Specifically, the computing device may identify the intent of the utterance based on at least one entity included in the utterance data and generate prompt data for generating the synthetic data based on the identified intent.

In addition, the computing device may generate a synthetic data set 7005 based on the prompt data using a generative model 7020.

In this case, the computing device may evaluate a quality of the synthetic data set 7005 using the at least one auxiliary network 7030 and 7040.

For example, the computing device may evaluate the quality of the synthetic data set 7005 using the first auxiliary network 7030 Aux(t) for performing a task. In this case, the first auxiliary network 7030 may be implemented to correspond to a AI model to be trained using the synthetic data set 7005. For example, the computing device may load (or implemented by a method such as transition learning) the AI model designed to perform a specific task, thereby storing the first auxiliary network 7030. Alternatively, the computing device may receive the pre-trained AI model together with the utterance data, and may obtain the first auxiliary network 7030 based on the received model.

The first auxiliary network 7030 may be a AI model pre-trained using the pre-trained data set 7001.

The computing device may input the generated synthetic data set 7005 to the first auxiliary network 7030. The computing device may perform a task based on the synthetic data set 7005 using the first auxiliary network 7030 and output a result value based on the task.

In this case, the computing device may evaluate the quality of the synthetic data set 7005 based on the result value. For example, when the result of performing the task does not meet a preset condition, the computing device may determine that the quality of the synthetic data set 7005 is poor, and may adjust parameters of the at least one model 7010 and 7020.

Alternatively, the computing device may estimate (or verify) a pre-trained first auxiliary network 7030 using the synthetic data set 7005. In this case, the computing device may determine whether to additionally train the pre-trained first auxiliary network 7030 based on the evaluation result. For example, when the result of performing the task does not meet the preset condition, the computing device may determine that the training of the first auxiliary network 7030 is insufficient, and may additionally train the first auxiliary network 7030 using the synthetic data set 7005.

As another example, the computing device may evaluate the quality of the synthetic data set 7005 using a second auxiliary network 7040 Aux(I) for data imaging. In this case, the second auxiliary network 7040 may be implemented to correspond to the data imaging model of the present disclosure.

The computing device may provide comparison information indicating a correlation between the synthetic data set 7005 and target data (e.g., data corresponding to generation intent) using the second auxiliary network 7040.

Specifically, the computing device may input the generated synthetic data set 7005 and a target data set 7002 to the second auxiliary network 7040. In this case, the target data set 7002 may include data received from the user device together with the utterance data or pre-trained data (e.g., 7001) of the AI model to be trained using the synthetic data set.

The computing device may be configured to identify the correlation between the target data set 7002 and the synthetic data set 7005 by representing the target data set 7002 and the synthetic data set 7005 in a common space.

The computing device may map the target data set 7002 and the synthetic data set 7005 to a specific embedding space using the second auxiliary network 7040.

Specifically, the computing device may identify a first data point set 7031 reflecting a property of the target data set 7002 by mapping the target data set 7002 to a specific embedding space.

In addition, the computing device may identify a second data point set 7035 reflecting a property of the synthetic data set 7005 by mapping the synthetic data set 7005 to the specific embedding space.

The computing device may provide comparison information between the target data set 7002 and the synthetic data set 7005 by representing the first data point set 7031 and the second data point set 7035 in a common space.

In addition, the computing device may obtain at least one property of the target data set 7002 based on the first data point set 7031 and obtain at least one property of the synthetic data set 7005 based on the second data point set 7035 to provide property comparison information between the target data set 7002 and the synthetic data set 7005.

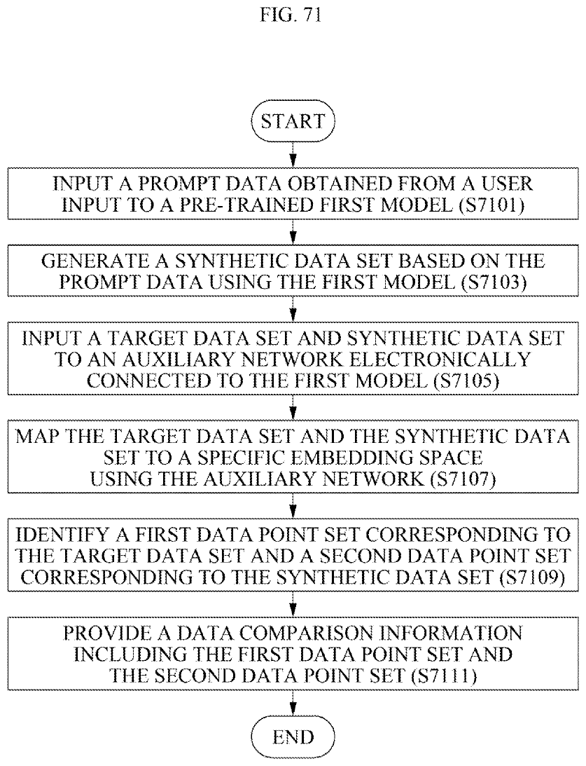

FIG. 71 is a flowchart illustrating a method for a computing device to generate synthetic data based on utterance data and provide comparison information, according to various embodiments.

Referring to FIG. 71, the computing device may input a prompt data obtained from a user input to a pre-trained first model (S7101). In addition, the computing device may generate a synthetic data set based on the prompt data using the first model (S7103).

In addition, the computing device may input a target data set and synthetic data set to an auxiliary network electronically connected to the first model (S7105). In addition, the computing device may map the target data set and the synthetic data set to a specific embedding space using the auxiliary network (S7107).

In addition, the computing device may identify a first data point set corresponding to the target data set and a second data point set corresponding to the synthetic data set (S7109). In addition, the computing device may provide a data comparison information including the first data point set and the second data point set (S7111).

The computing device according to the present disclosure may improve learning efficiency of a AI model and develop task performance capability of a AI model by accurately providing information on quality of data generated to a user who wants to generate training data based on a generative model (e.g., Large Language Model, LLM).

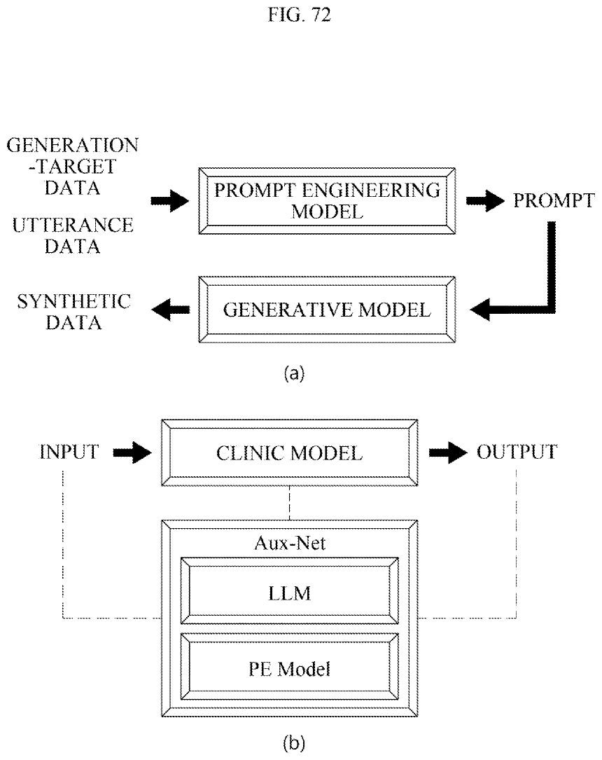

FIG. 72 is a diagram illustrating a language-based generative model and a clinic model included in a computing device, according to various embodiments.

In order for the computing device according to the present disclosure to generate synthetic data with high quality, it is important to accurately identify the intent of the input utterance data and generate an appropriate prompt.

In order to automatically perform prompt engineering configuring an appropriate prompt to obtain a high-level result from the AI model, it is necessary to determine required properties of data based on an input utterance and generate synthetic data reflecting the properties.

Referring to FIG. 72(a), the computing device may include a prompt engineering model for configuring an appropriate prompt based on utterance data and a generative model for generating synthetic data based on the prompt.

The computing device may train the prompt engineering model based on the utterance data and the generation-target data. Specifically, the computing device may be implemented to configure a prompt corresponding to properties of data by training a prompt engineering model using data to be generated according to the utterance data, wherein the properties are associated with utterance data.

In order for the computing device to configure the prompt for generating synthetic data corresponding to the intention of the uttered, it is necessary to derive minimum information associated with data to be generated based on the utterance data. For example, the generative model may determine at least one property of the data based on the input prompt in order to fill slots corresponding to properties required for generation of the synthetic data. In this case, the number of slots required for generation of the synthetic data may be predetermined, but the present invention is not limited thereto.

Referring to FIG. 72(b), the computing device according to the present disclosure may enhance language-based model (e.g., generative model, a large language model, a prompt engineering model) based on the input and output data of a Clinic Model. Specifically, the computing device may train into an auxiliary network composed of the language-based models based on the input and output data of a Clinic Model.

Specifically, in order to interwork the data Clinic Model with the pre-trained language-based models, the computing device may additionally train (e.g., fine tuning) the language-based models based on data acquired on the data Clinic process.

For example, as in the embodiment shown in FIG. 64, in order for the computing device to generate the synthetic data based on the diagnostic data, the computing device may additionally train the language-based models using at least one corpus included in the diagnostic data and data corresponding thereto.

In addition, for example, as in the embodiment shown in FIG. 68, in order for the computing device to generate the synthetic data and the modified image of data based on the image of data, the computing device may additionally train the language-based models using the image of data and at least one corpus associated with the image of data.

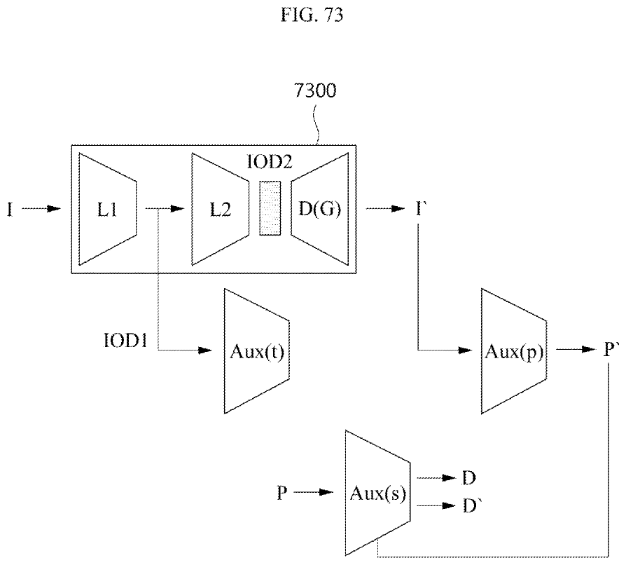

FIG. 73 is a diagram illustrating an example of a computing device using a data clinic model and a language-based model, according to various embodiments.

Referring to FIG. 73, the computing device may include a Clinic Model 7300. The Clinic Model 7300 may include at least one imaging model L1, L2 and at least one generative model (e.g., decoder or generator).

In addition, the computing device may include at least one auxiliary network (Aux(t) or Aux(p)) communicating with the Clinic Model 7300.

The computing device may perform a task using at least one auxiliary network, generate a prompt for generating synthetic data, or generate synthetic data based on the prompt.

The computing device may obtain, using at least one data imaging model, a first image of data IOD1 based on the input data I. In addition, the computing device may perform, using the first auxiliary network Aux(t) for performing the task, the task based on the first image of data. Alternatively, the computing device may further obtain, using at least one data imaging model, a second image of data IOD2.

In addition, the computing device may generate, using at least one generative model, the synthetic data I′ based on the input data. In addition, the computing device may generate, using the second auxiliary network Aux(p) for generating the prompt, the synthetic prompt P′ based on the synthetic data.

In this case, the computing device may train the second auxiliary network based on the generated synthetic prompt P′ and the correct answer prompt P. Specifically, the computing device may optimize a parameter of the second auxiliary network such that the synthetic prompt is similar to the correct answer prompt.

In addition, the computing device may generate synthetic data based on the prompt by using a third auxiliary network Aux(s) for generating data based on the prompt. Specifically, the computing device may input the synthetic prompt P′ to the third auxiliary network and generate the first synthetic data D′. In addition, the computing device may input the correct answer prompt P to the third auxiliary network and generate the second synthetic data D.

The computing device may train at least one of the third auxiliary network or the second auxiliary network based on the first synthetic data D′ and the second synthetic data D. Specifically, the computing device may train the second auxiliary network such that the third auxiliary network generates a prompt for the first synthetic data D′ to become similar to the second synthetic data D. Alternatively, the computing device may train the third auxiliary network such that the first synthetic data D′ is similar to the second synthetic data D.

The computing device according to the present disclosure provides a data clinic model for accurately diagnosing properties of artificial intelligence learning data and improving quality of the learning data. In addition, the natural language input is accurately understood by using a language-based model connected to the data clinic model, the data clinic service is provided.

The method according to an embodiment may be implemented in the form of program instructions executable by a variety of computer means and may be recorded on a computer-readable medium. The computer-readable medium may include program instructions, data files, data structures, and the like alone or in combination. The program instructions recorded on the medium may be designed and configured specifically for an embodiment or may be publicly known and usable by those who are skilled in the field of computer software. Examples of the computer-readable medium include a magnetic medium, such as a hard disk, a floppy disk, and a magnetic tape, an optical medium, such as a compact disc read-only memory (CD-ROM), a digital versatile disc (DVD), etc., a magneto-optical medium such as a floptical disk, and a hardware device specially configured to store and perform program instructions, for example, a read-only memory (ROM), a random access memory (RAM), a flash memory, etc. Examples of the computer instructions include not only machine language code generated by a compiler, but also high-level language code executable by a computer using an interpreter or the like. The hardware device may be configured to operate as one or more software modules in order to perform the operations of an embodiment, and vice versa.

According to the present disclosure, it is possible to preserve the intrinsic properties of data using a data processing method that considers a distribution of data points.

In addition, according to the present disclosure, it is possible to efficiently output various pieces of information on data using a data visualization method that considers the actual properties of data.

Effects of the present invention are not limited to the above-described effects, and effects not mentioned will be clearly understood by those of ordinary skill in the art to which the present invention belongs from the present specification and accompanying drawings.

Although the present disclosure has been described with reference to specific embodiments and drawings, it will be appreciated that various modifications and changes can be made from the disclosure by those skilled in the art. For example, suitable results may be achieved if the described techniques are performed in a different order and/or if components in a described system, architecture, device, or circuit are combined in a different manner and/or replaced or supplemented by other components or their equivalents.

Therefore, other implementations, embodiments, and equivalents are within the scope of the following claims.

What is claimed is:

1. A computer-implemented method, comprising:
obtaining, by one or more processors, a first data set;
identifying, by one or more processors, a first data point set by determining at least one feature of the first data set from at least one layer of a first trained model, wherein the first data point set corresponding to the first data set is associated with a first embedding space of a first dimension;
obtaining, by one or more processors, a first diagnostic data corresponding to the first data set based on the first data point set by analyzing at least one property of the first data set; and
generating, by one or more processors, a first set of synthetic data, wherein the generating the first set of synthetic data comprises:
inputting a prompt data associated with the at least one property of the first data set into a second trained model; and
obtaining the first set of synthetic data from at least one layer of the second trained model.

2. The computer-implemented method of claim 1, wherein at least one property of the first data set includes an intrinsic property associated with a distribution on the first embedding space of the first data point set.

3. The computer-implemented method of claim 1, wherein at least one property of the first data set includes a task-dependent property.

4. The computer-implemented method of claim 1, wherein the first diagnostic data includes an utterance data, and the prompt data is obtained based on the utterance data.

5. The computer-implemented method of claim 1, wherein the first diagnostic data set includes an utterance data associated with a quality of the first data set.

6. The computer-implemented method of claim 1, wherein the prompt data is obtained by deriving a property of data that needs to be generated based on the first diagnostic data.

7. The computer-implemented method of claim 1, further comprising:
verifying, by one or more processors, the first set of synthetic data, wherein the verifying the first set of synthetic data comprising:
identifying at least one targeting area on the first embedding space, wherein the at least one targeting area corresponds to an area for which data generation is requested by the prompt data;
identifying a second data point set on the first embedding space by determining at least one feature of the first set of synthetic data data set from at least one layer of a first trained model; and
verifying the first set of synthetic data based on an association between the second data point set and the at least one targeting area.

8. The computer-implemented method of claim 1, further comprising:
verifying, by one or more processors, the first set of synthetic data based on a predetermined condition; and
adjusting at least one parameter of the second model trained model based on a determination that the first set of synthetic data does not satisfy the predetermined condition.

9. The computer-implemented method of claim 1, further comprising:
verifying, by one or more processors, the first set of synthetic data, wherein the verifying the first set of synthetic data comprising:
obtaining a second diagnostic data associated with at least one property of a third data set including the first set of synthetic data and the first data set; and
verifying the first set of synthetic data based on the second diagnostic data.

10. A computing device, comprising:
a memory; and
one or more processors electronically connected to the memory;
wherein the one or more processors is configured to:
obtain a first data set;
identify a first data point set by determining at least one feature of the first data set from at least one layer of a first trained model, wherein the first data point set corresponding to the first data set is associated with a first embedding space of a first dimension;
obtain a first diagnostic data corresponding to the first data set based on the first data point set by analyzing at least one property of the first data set; and
generate a first set of synthetic data, wherein the generating the first set of synthetic data comprises:
inputting a prompt data associated with the at least one property of the first data set into a second trained model; and
obtaining the first set of synthetic data from at least one layer of the second trained model.

11. The computing device of claim 10, wherein at least one property of the first data set includes an intrinsic property associated with a distribution on the first embedding space of the first data point set.

12. The computing device of claim 10, wherein at least one property of the first data set includes a task-dependent property.

13. The computing device of claim 10, wherein the first diagnostic data includes an utterance data, and the prompt data is obtained based on the utterance data.

14. The computing device of claim 10, wherein the first diagnostic data set includes an utterance data associated with a quality of the first data set.

15. The computing device of claim 10, wherein the prompt data is obtained by deriving a property of data that needs to be generated based on the first diagnostic data.

16. The computing device of claim 10, wherein the one or more processors is further configured to:
verify the first set of synthetic data, wherein the verifying the first set of synthetic data comprising:
identifying at least one targeting area on the first embedding space, wherein the at least one targeting area corresponds to an area for which data generation is requested by the prompt data;
identifying a second data point set on the first embedding space by determining at least one feature of the first set of synthetic data data set from at least one layer of a first trained model; and
verifying the first set of synthetic data based on an association between the second data point set and the at least one targeting area.

17. The computing device of claim 10, wherein the one or more processors is further configured to:
verify the first set of synthetic data based on a predetermined condition; and
adjust at least one parameter of the second model trained model based on a determination that the first set of synthetic data does not satisfy the predetermined condition.

18. A non-transitory computer-readable storage medium, storing program instructions computer-executable on a computer to perform operations comprising:
obtaining, by one or more processors, a first data set;
identifying, by one or more processors, a first data point set by determining at least one feature of the first data set from at least one layer of a first trained model, wherein the first data point set corresponding to the first data set is associated with a first embedding space of a first dimension;
obtaining, by one or more processors, a first diagnostic data corresponding to the first data set based on the first data point set by analyzing at least one property of the first data set; and
generating, by one or more processors, a first set of synthetic data, wherein the generating the first set of synthetic data comprises:
inputting a prompt data associated with the at least one property of the first data set into a second trained model; and
obtaining the first set of synthetic data from at least one layer of the second trained model.
